(19) United States
(12) Patent Application Publication
(10) Pub. No.: US 2024/0246225 A1
(43) Pub. Date: Jul. 25, 2024

(54) ROBOT FOR ASSISTING LIMBS

(71) Applicant: INDUSTRY-ACADEMIC COOPERATION FOUNDATION, CHOSUN UNIVERSITY, Gwangju (KR)

(72) Inventor: Chang Hyun CHO, Gwangju (KR)

(73) Assignee: INDUSTRY-ACADEMIC COOPERATION FOUNDATION, CHOSUN UNIVERSITY, Gwangju (KR)

(21) Appl. No.: 18/619,132

(22) Filed: Mar. 27, 2024

Related U.S. Application Data
(63) Continuation of application No. PCT/KR2022/015477, filed on Oct. 13, 2022.

(30) Foreign Application Priority Data
Oct. 14, 2021 (KR) 10-2021-0136951
Apr. 12, 2023 (KR) 10-2023-0047884

(51) Int. Cl. B25J 9/00; B25J 9/10; B25J 9/16

(52) U.S. Cl. CPC B25J 9/0006; B25J 9/0078; B25J 9/1065; B25J 9/1633

(57) ABSTRACT

The present invention provides a robot configured to assist movements of limbs of a user. The upper limb assist robot, as the limb assist robot, comprises: a first link extending from a shoulder of an upper limb toward an elbow and including a first joint pivotably connected to a predetermined accessory; a second link including a second joint pivotably connected to the first link, the second link being configured to support an upper arm of the upper limb along with the first link by extending from the first link to the elbow of the upper limb; a first actuator including a first coupler connected to the first link, and configured to apply a predetermined magnitude of a force to the first joint via the first coupler; a second actuator including a second coupler connected to the second link, and configured to apply a predetermined magnitude of a force to the second joint via the second coupler; and an adjustment module including third and fourth couplers connected to the first and second actuators, respectively, the adjustment module being configured to change directions of the forces applied to the first and second joints by the first and second actuators to generate a force in an intended direction while canceling an applied gravitational force.

### CROSS-REFERENCE TO RELATED APPLICATIONS

This application claims the benefit under 35 U.S.C. § 120 and § 365(c) to a prior PCT International Application No. PCT/KR2022/015477, filed on Oct. 13, 2022, which claims the benefits of Korean Patent Application No. 10-2021-0136951, filed on Oct. 14, 2021, and this application also claims priority to Korean Patent Applications No. 10-2023-0047884, filed Apr. 12, 2023, the entire contents of which are incorporated herein for all purposes by this reference.

### BACKGROUND OF THE INVENTION

### Field of the Invention

The present invention relates to a robot that assists a movement of a human body, and more particularly to a robot configured to assist movements of an upper limb and a lower limb of the human body.

### Description of the Related Art

By common definition, a robot is a mechanical device that has a human-like appearance and function, or a mechanical device that can operate using a computer program and perform a series of complex tasks automatically. However, in the most intuitive sense, robots are usually perceived as mechanical devices that have an ability to assist humans or perform prescribed tasks on behalf of humans.

Among such robots, an assist robot is classified as a mechanical device configured to assist the human in controlling a posture and a movement of his or her body, and in this respect, the assist robot can be considered to be most in line with the aforementioned conventional and intuitive definition of the robot. Currently, in one example, the assist robots are being applied in the field of nursing and rehabilitation on people with physical deficiencies to replace the physical efforts of traditional therapists. the assist robots are also being utilized to increase physical capabilities of normal humans by assisting normal human activities using their basic configuration. Due to these advantages, the assist robots are being applied in various fields such as military and industrial fields, not just for rehabilitation purposes, and the technological development and policy support for the assist robots have been increasing.

Among various parts of the human body, since legs and arms perform the most of movements, the assistive robots can be broadly categorized into lower limb assist robots that support the posture and movement of legs and upper limb assist robots that support the posture and movement of arms. Since the arms and legs play an indispensable role in human life, not only the upper limb assist robots but also the lower limb assist robots are currently being actively researched and developed.

Currently, the commercialized upper limb assist robots and lower limb assist robots consist of motorized or electric-powered exoskeleton-type devices. More specifically, in these motorized assist robots for the limbs, main joints of the robot are equipped with actuators that include motors and gears, and torque for movement is directly applied to the main joints by the actuators. However, these electric-powered actuators are not only expensive, but also heavy. Therefore, it is difficult for electric-powered or motorized assistive robots to be lightweight while having a low price.

Further, the upper limb assist robots and lower limb assist robots need to react in real time to the movements according to the user's intentional so as to assist such movements. However, in electric-powered actuators, a follow-up control of the user's movements is difficult to implement due to the inevitable delay caused by the operation of the motor as well as the gear train that transmits the power of the motor. Further, due to these control difficulties, the electric-powered assist robots for the limbs are always subject to systematic instability, in both structural and operational aspects. Therefore, the electric-powered limb assist robots have not yet been developed to assist the user's movements in real time, and users experience inconvenience when using such assist robots in practice.

### SUMMARY OF THE INVENTION

The present invention is contemplated to solve problems in the prior art mentioned above. Thus, an object of the present invention is to provide a limb assist robot configured to assist movements of a user in real-time according to the user's intent.

Another object of the present invention is to provide an inexpensive and lightweight limb assist robot.

To solve the above problems, according to a first aspect of the invention, the present invention may provide an upper limb assist robot comprising: a first link extending from a shoulder of an upper limb toward an elbow and including a first joint pivotably connected to a predetermined accessory; a second link including a second joint pivotably connected to the first link, the second link being configured to support an upper arm of the upper limb along with the first link by extending from the first link to the elbow of the upper limb; a first actuator including a first coupler connected to the first link, and configured to apply a predetermined magnitude of a force to the first joint via the first coupler; a second actuator including a second coupler connected to the second link, and configured to apply a predetermined magnitude of a force to the second joint via the second coupler; and an adjustment module including third and fourth couplers connected to the first and second actuators, respectively, the adjustment module being configured to change directions of the forces applied to the first and second joints by the first and second actuators to generate a force in an intended direction while canceling an applied gravitational force.

The adjustment module may be configured to change positions of the third and fourth couplers in order to change the directions of the forces applied to the first and second joints by the first and second actuators. The adjustment module may be configured to offset or space the third and fourth couplers by a predetermined distance apart from a vertical axis extending in a direction of gravity through the first joint in order to change the positions of the third and fourth couplers, such that a component force acting opposed to the direction of gravity and a component force acting in the intended direction are generated from the forces of the first and second actuators applied to the first and second joints. Further, the adjustment module may be configured to move the third and fourth couplers in a horizontal direction to offset the third and fourth couplers from the vertical axis.

The adjustment module may be further configured to change the magnitudes of the forces applied to the first and second joints by the first and second actuators. The adjustment module may be configured to change a first distance between the first and third couplers and a second distance between the second and fourth couplers in order to change the magnitudes of the forces applied to the first and third joints. Further, the adjustment module may be configured to move the third and fourth couplers in a vertical direction to change the first and second distances.

The adjustment module may include: a housing configured to accommodate components of the first and second actuators; a first driver provided to the housing and configured to move the housing in a horizontal direction; and a second driver provided to the housing and configured to move the housing in a vertical direction.

Further, according to a second aspect of the invention, the present invention may provide an upper limb assist robot comprising: a first link extending from a shoulder of an upper limb toward an elbow and including a first joint pivotably connected to a predetermined accessory; a second link including a second joint pivotably connected to the first link, the second link being configured to support an upper arm of the upper limb along with the first link by extending from the first link to the elbow of the upper limb; a first actuator including a first coupler pivotably connected to the first joint and a second coupler pivotably connected to a body of the first link, the first actuator being configured to apply a predetermined magnitude of a force to the first coupler; a second actuator including a third coupler pivotably connected to the second joint and a fourth coupler pivotably connected to a body of the second link, the second actuator being configured to apply a predetermined magnitude of a force to the third coupler; and a first adjustment module configured to be connected to the first and second actuators, the first adjustment module being configured to change directions of the forces applied to the first and third couplers by the first and second actuators to generate a force in an intended direction while canceling an applied gravitational force.

The first adjustment module may be configured to change positions of the first and third couplers in order to change the directions of the forces applied by the first and second actuators. The first adjustment module may be configured to offset or space the first and third couplers apart from vertical axes passing through the first and second joints, respectively in order to change the positions of the first and third couplers, such that a component force acting opposed to the direction of gravity and a component force acting in the intended direction are generated from the forces of the first and second actuators. Further, the first adjustment module may be configured to revolve the first and third couplers around the first and second joints, respectively to offset the first and third couplers from the vertical axes.

The first adjustment module may include: a first pulley configured to be rotatably installed at the first joint and pivotably coupled to the first coupler of the first actuator; a second pulley configured to be rotatably installed at the second joint, and pivotably coupled to the third coupler of the second actuator; and a first driver configured to provide power to the first and second pulleys to revolve the first and third couplers by rotating the first and second pulleys. The first adjustment module may further include a first synchronizer configured to move the first and third couplers simultaneously in the same direction and by the same distance.

Moreover, according to a third aspect of the invention, the present invention may provide a lower limb assist robot comprising: a first link configured to support a lower leg of a lower limb; a second link configured to support an upper leg of the lower limb, the second link including a first joint pivotably coupled to the first link and a second joint disposed opposite to the first joint; a first actuator including a first coupler pivotably connected to the first joint and a second coupler pivotably connected to a body of the first link, the first actuator being configured to apply a predetermined magnitude of a force to the first coupler; a second actuator including a third coupler pivotably connected to the second joint and a fourth coupler pivotably connected to a body of the second link, the second actuator being configured to apply a predetermined magnitude of a force to the third coupler; and a first adjustment module configured to be connected to the first and second actuators, the first adjustment module being configured to change directions of the forces applied to the first and third couplers by the first and second actuators to generate a force in an intended direction while canceling an applied gravitational force.

The first adjustment module may be configured to change positions of the first and third couplers in order to change the directions of the forces applied by the first and second actuators. The first adjustment module may be configured to revolve the first and third couplers around the first and second joints, respectively to generate a component force acting opposed to the direction of gravity and a component force acting in the intended direction from the forces of the first and second actuators.

The first adjustment module may include: a first pulley configured to be rotatably installed at the first joint and pivotably coupled to the first coupler of the first actuator; a second pulley configured to be rotatably installed at the second joint, and pivotably coupled to the third coupler of the second actuator; and a first driver configured to provide power to the first and second pulleys to revolve the first and third couplers by rotating the first and second pulleys. The first adjustment module may further include a first synchronizer configured to move the first and third couplers simultaneously in the same direction and by the same distance.

Meanwhile, the lower limb assist robot may further comprises a second adjustment module configured to selectively engage with the first and second actuators and change the magnitudes of the forces applied to the first and third couplers by the first and second actuators.

Details of examples or implementations will be described in the following with reference to the accompanying drawings. Other features will be apparent from the description and drawings, and from the claims.

### BRIEF DESCRIPTION OF THE DRAWINGS

The present invention will become more fully understood from the detailed description given herein below and the accompanying drawings, which are given by illustration only, and thus are not intended to limit the scope of the present Invention, wherein:

FIG. 1 is a side view illustrating a first embodiment of an upper limb assist robot according to the present invention;

FIG. 2 is a schematic view illustrating a detailed configuration of actuators and an adjustment module of the upper limb assist robot according to the first embodiment;

FIGS. 3A and 3B are conceptual diagrams illustrating models of dynamics related to thrust generation in the upper limb assist robot according to the first embodiment;

FIGS. 4A and 4B are conceptual diagrams illustrating dynamics models related to generation of increased force in the upper limb assist robot, according to the first embodiment;

FIGS. 5A and 5B are schematic diagrams illustrating configurations related to an arrangement of an adjustment module in the upper limb assist robot according to the first embodiment;

FIGS. 6-8 are side views illustrating operating modes of the upper limb assist robot according to the first embodiment;

FIG. 9 is a side view illustrating a second embodiment of the upper limb assist robot according to the present invention;

FIG. 10 is a side view illustrating an assembly for assisting an upper arm in the upper limb assist robot according to the second embodiment;

FIG. 11 is a front view illustrating the assembly of FIG. 10;

FIGS. 12A and 12B are conceptual diagrams illustrating dynamics models related to thrust generation in the upper limb assist robot according to the second embodiment;

FIGS. 13A and 13B are side views illustrating modes of operation of the assembly of FIG. 10;

FIG. 14 is a side view illustrating a modification of the assembly for assisting the upper arm in the upper limb assist robot according to the second embodiment;

FIG. 15 is a front view illustrating the assembly of FIG. 14;

FIGS. 16A and 16B are conceptual diagrams illustrating dynamics models related to generation of increased force in the upper limb assist robot according to the second embodiment;

FIGS. 17A and 17B are side views illustrating modes of operation of the assembly of FIG. 14;

FIG. 18 is a side view illustrating a further modification of the assembly for assisting the upper arm in the upper limb assist robot according to the second embodiment;

FIG. 19 is a front view illustrating the assembly of FIG. 18;

FIG. 20 is a side view illustrating a modification of the upper limb assist robot according to the first embodiment;

FIG. 21 is a side view illustrating a lower limb assist robot according to the present invention;

FIG. 22 is a front view illustrating the lower limb assist robot of FIG. 21;

FIGS. 23A and 23B are conceptual diagrams illustrating dynamics models of the lower limb assist robot of FIG. 21;

FIGS. 24A-24C are side views illustrating operation modes of the lower limb assist robot of FIG. 21;

FIG. 25 is a side view illustrating a modification of the lower limb assist robot according to the present invention;

FIG. 26 is a front view illustrating the lower limb assist robot of FIG. 25;

FIG. 27 is conceptual views illustrating dynamics model of the lower limb assist robot of FIG. 25;

FIGS. 28A-28C are side views illustrating operation modes of the lower limb assist robot of FIG. 25;

FIG. 29 is a side view illustrating a further modification of the lower limb assist robot according to the present invention;

FIG. 30 is a front view illustrating the lower limb assist robot of FIG. 29; and

FIGS. 31A and 31B are side views illustrating operation modes of the lower limb assist robot of FIG. 29.

### DETAILED DESCRIPTION OF THE PREFERRED EMBODIMENT

Description for a robot for assisting limbs will now be given in detail according to examples disclosed herein, with reference to the accompanying drawings.

For the sake of brief description with reference to the drawings, the same or equivalent components may be provided with the same reference numbers, and description thereof will not be repeated. In the following, any conventional art which is well-known to one of ordinary skill in the relevant art has generally been omitted for the sake of brevity. The accompanying drawings are used to help easily understand various technical features and it should be understood that the examples presented herein are not limited by the accompanying drawings. As such, the present invention should be construed to extend to any alterations, equivalents, and substitutes in addition to those which are particularly set out in the accompanying drawings.

A singular representation may include a plural representation unless it represents a definitely different meaning from the context.

It will be understood that although the terms “first,” “second,” etc., may be used herein to describe various components, these components should not be limited by these terms. These terms are only used to distinguish one component from another component.

It should be understood that when a component is referred to as being “connected to” or “coupled to” another component, this component may be directly connected to or coupled to another component, or any intervening components may be present between the components. In contrast, when a component is referred to as being “directly connected to” or “directly coupled to” another component, there are no intervening components present.

Terms such as “comprise”, “include” or “have” are used herein and should be understood that they are intended to indicate an existence of several components, functions or steps, disclosed in the specification, and it is also understood that greater or fewer components, functions, or steps may likewise be utilized. Moreover, due to the same reasons, it is also understood that the present invention includes any combinations of features, numerals, steps, operations, components, parts and the like partially omitted from the related or involved features, numerals, steps, operations, components, and parts described using the aforementioned terms unless deviating from the intentions of the original disclosure.

The limb assist robots according to the present invention are categorized into an upper limb assist robot and a lower limb assist robot according to a body part to which these robots are applied, and the upper and lower limbs assist robots may be configured to perform unique configurations and operations due to the characteristics of the applied body part, which is the upper limb and the lower limb. Accordingly, in the following, such upper limb assist robot and lower limb assist robot will be described separately from each other with reference to the corresponding drawings.

### [Upper Limb Assist Robot]

In the following, the present invention includes as an example a robot that assists the upper limb, i.e., the arm of the body, but the described examples of the robot may be applied to robots that assist the movement of the lower limb, i.e., the leg and other parts of the body, without substantial modifications to their principles and configurations.

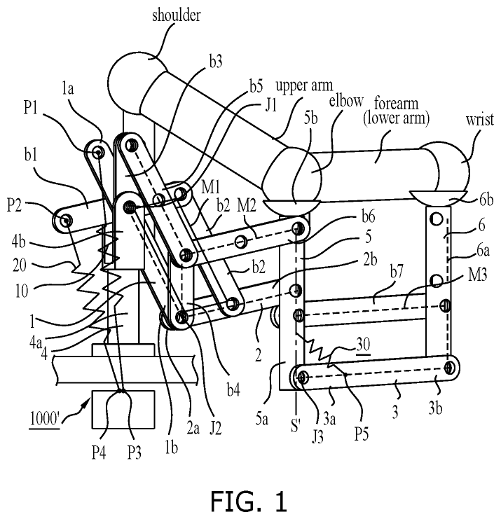

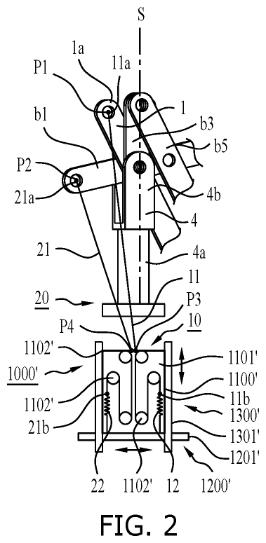

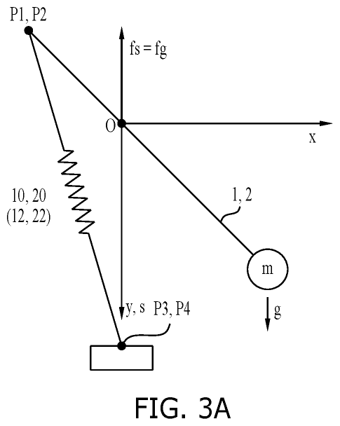

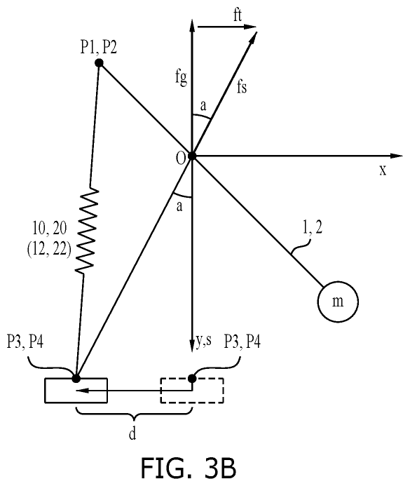

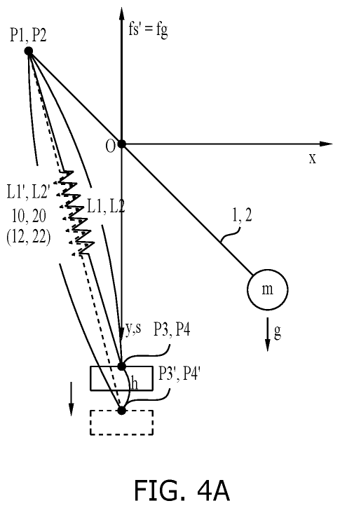

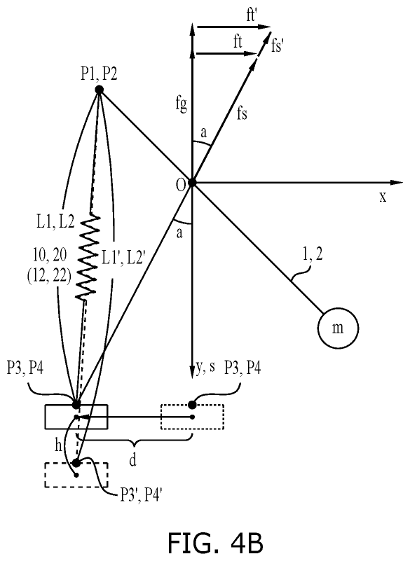

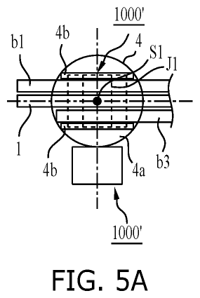

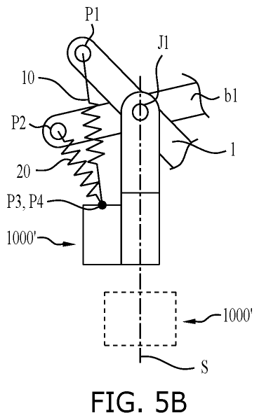

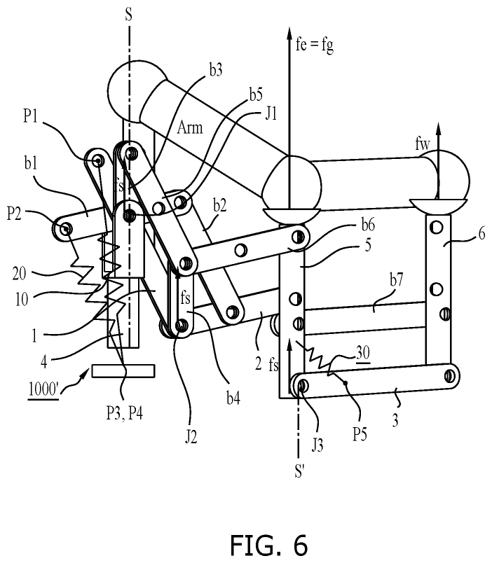

FIG. 1 is a side view illustrating a first embodiment of an upper limb assist robot according to the present invention, and FIG. 2 is a schematic view illustrating a detailed configuration of actuators and an adjustment module of the upper limb assist robot according to the first embodiment. Further, FIGS. 3A and 3B are conceptual diagrams illustrating models of dynamics related to thrust generation in the upper limb assist robot according to the first embodiment, and FIGS. 4A and 4B are conceptual diagrams illustrating dynamics models related to generation of increased force in the upper limb assist robot, according to the first embodiment. Finally, FIGS. 5A and 5B are schematic diagrams illustrating configurations related to an arrangement of an adjustment module in the upper limb assist robot according to the first embodiment, and FIGS. 6-8 are side views illustrating operating modes of the upper limb assist robot according to the first embodiment. With reference to these figures, the configuration of the first embodiment of the upper limb assist robot according to the present invention will be described in the following.

Referring to FIG. 1, the upper limb assist robot according to the first embodiment may comprise a link assembly 1, 2 including links 1, 2 which are configured to provide overall support for an upper arm of a user, and rotatably or pivotably connected relative to each other. Further, the upper limb assist robot may comprise actuators 10,20 that apply forces to the link assembly 1, 2 to assist in the movement of the user's arm, more specifically, the upper arm. Furthermore, as will be described in more detail later, an accessory, namely an adjustment module 1000′, may be installed on the upper limb assist robot that interacts with the actuators 10, 20 to assist the arm movement. The adjustment module 1000′ may control the force exerted by the actuators 10, 20 to move the link assembly 1, 2 in accordance with the user's intention, thereby appropriately assisting the movement of the user's arm. In the user's upper limb, i.e., arm, the upper arm performs a dominant role in the movement of the arm, while moving relative to both the shoulder and the forearm (or lower arm). Thus, by utilizing these devices 1, 2, 10, 20, 1000′ to assist the movement of the upper arm, the upper limb assist robot may substantially achieve assistance in the movement of the upper limb, i.e., the entire arm.

Further, in addition to the above-described devices 1, 2, 10, 20, 1000′, the upper limb assist robot may further include a third link 3 connected to the link assembly 1, 2 supporting the upper arm and configured to support the forearm, and a third actuator 30 configured to apply a force to the third link 3 to assist the movement of the forearm. Therefore, the upper limb assist robot may further utilize these devices 3, 30 to assist the movement of the forearm, thus perform the actual overall arm support and exercise assistance. Furthermore, the upper limb assist robot may further include a mount 4 and supporters 5, 6 as support members, whereby a more stable support of the upper limb assist robot and the upper limb is enabled by these support members 4-6.

Meanwhile, FIGS. 1-8 illustrate, as an example, a right unit of the first embodiment of the upper limb assist robot provided on a right arm of a user, and the configurations of such a right unit are described below for convenience of description. However, the upper limb assist robot according to the first embodiment of the present invention may include a left unit that is configured identically to the illustrated right unit for supporting balanced movement of the user's arm. In one example, such a left unit and the illustrated right unit may be provided on the left and right arms of the user, respectively. Accordingly, without further specific mention in the following, the upper limb assist robot according to the first embodiment of the present invention may further comprise the left unit configured identically to the illustrated right unit, and the descriptions relating to the right unit provided with reference to FIGS. 1-8 below are equally applicable to such a left unit. Under these premises, the individual components or elements of the upper limb assist robot according to the first embodiment of the present invention will be described in more detail in the following.

First, the lower limb assist robot may include as the link assembly, a first link 1, which is configured to support the upper arm of the user's upper limb (i.e., arm). The first link 1 may comprise a body extending along the upper arm, as shown in FIG. 1 and FIGS. 6-8, and may be provided at an outer portion of the upper arm. More specifically, the first link 1 may extend a predetermined length from the shoulder of the user towards the elbow of the user and may thereby have a first end 1a adjacent to the shoulder and a second end 1b opposite the first end 1a.

Such a first link 1 may be pivotably (or rotatably) connected to a predetermined appendage or accessory configured to support the first link 1 in order to allow its own rotational movement for assisting the movement of the upper arm. That is, the first link 1 may have a first joint J1 pivotably connected to the predetermined appendage (or accessory). For example, the first link 1 may have the first joint J1 rotatably connected to a mount 4 configured to be installed in a predetermined plane or floor to support components of the upper limb assist robot and configured to permit such rotation, as will be described later. Further, the first link 1 may have the first joint J1 that allows a rotatable connection to any accessory, i.e., support member, which supports the first link 1, in addition to the mount 4. For example, if the upper limb assist robot is mounted directly on the arm of the user without a support structure such as the mount 4, the first link 1 may have a first joint J1 that is rotatably connected to a predetermined mounting unit installed on the arm of the user. By such a first joint J1, the first link 1 may assist the movement of the upper arm while performing a rotational movement.

More specifically, in one example, the first joint J1 may comprise a portion of the first link 1, a portion of a predetermined appendage (or accessory), and a pivot shaft or pin (or a hinge shaft or pin) rotatably coupling the first link 1 and the portion of the accessory. On the one hand, the hinge pin or shaft that rotatably couples such first link 1 and the accessory may itself be the first joint J1. On the other hand, only the portions of such first link 1 and appendage connecting the first link 1 and appendage may be defined as the first joint J1. Such a first joint J1 may be disposed at any portion of the first link 1. For example, as shown in FIG. 1 and FIGS. 6-8, the first joint J1 may be disposed between the first and second ends 1a, 1b of the first link 1, more precisely adjacent to the first end 1a.

Further, the upper limb assist robot may include, as the link assembly, a second link 2 configured to support the upper arm of the user, like the first link 1. The second link 2 may have a body extending along the upper arm, as shown in FIGS. 1 and 6-8, and may be provided at the outer portion of the upper arm in conjunction with the first link 1. More specifically, the second link 2 may extend a predetermined length from the elbow of the user towards the shoulder, and may join the first link 1 for connection with the first link 1. In other words, the second link 2 may also be described as extending from the first link 1 to the elbow of the user, and may thereby be configured to essentially support the upper arm together with the first link 1. Such a second link 2 may comprise a third end 2a adjacent to the second end 1b of the first link 1 and a fourth end 2b opposite the third end 2a and adjacent to the elbow.

Further, the second link 2 may be rotatably or pivotably connected to the first link 1 in order to assist the movement of the upper arm together with the first link 1. That is, the second link 2 may have a second joint J2 rotatably or pivotably connected to the first link 1. By such a second joint J2, the first and second links 1, 2 may rotate or pivot relative to each other, and this rotational motion may reliably assist the movement of the upper arm. Since the second joint J2 is shared by the first and second links 1, 2 to enable the relative rotational movement of the first and second links 1, 2, it may be described that the first link 1 comprises not only the first joint J1 described above, but also the second joint J2.

More specifically, the second joint J2 may comprise a portion of the first link 1, a portion of the second link 2, and a pivot shaft or pin (or a hinge shaft or pin) rotatably or pivotably coupling these portions of the first and second links 1, 2. On the one hand, the hinge pin or shaft rotatably coupling these first link 1 and second link 2 may itself be the second joint J2. On the other hand, only portions of these first and second links 1, 2 connecting the first link 1 and the second link 2 may be defined as the second joint J2. Such a second joint J2 may be disposed at any portions of the first and second links 1, 2. For example, as shown in FIG. 1 and FIGS. 6-8, the second joint J2 may be disposed at a second end 1b of the first link 1 and a third end 2a of the second link 2 that overlap each other. In other words, the second joint J2 may comprise the second and third ends 1b, 2a and a hinge shaft joining the ends 1b, 2a, or may comprise only a hinge shaft rotatably connecting these ends 1b, 2a.

Such first and second joints J1, J2 may enable relative rotational movement of the link assembly 1, 2 supporting the upper arm, and thus allow the upper arm to be moved as the link assembly 1, 2 moves.

In the arm of the user, the upper arm is movably connected to the body via the shoulder, and the forearm is movably connected to the upper arm by the elbow. That is, in order to reliably assist the movement of the upper arm, the upper limb assist robot needs to be configured to reliably support a free end of the upper arm, i.e., the elbow, while applying a force to the elbow. For example, a portion of the second link 2 adjacent to the elbow in the upper limb assist robot, namely the fourth end 2b, may be configured to directly support the user's elbow for such purpose. Nevertheless, the upper limb assist robot according to the first embodiment of the present invention may comprise a separate support member configured to support the elbow, and may include a first supporter 5 as such a support member.

As shown in FIGS. 1 and 6-8, the first supporter 5 may have a body oriented in the substantially vertical direction. Further, a portion of the body of the first supporter 5, such as an end thereof, may be in direct contact with the elbow to support the elbow. Therefore, the first supporter 5 may stably support the elbow. Further, the first supporter 5 may be connected or coupled to the second link 2, thereby transmitting the force or motion of the link assembly 1, 2 to the elbow to assist the movement of the upper arm. Moreover, for a smoother transfer of force or motion of the link assembly 1, 2, the first supporter 5 may be rotatably or pivotably connected to the second link 2. In one example, as shown in FIG. 1, the first supporter 5 may be rotatably or pivotably connected to the fourth end 2b of the second link 2.

More specifically, the first supporter 5 may have a first column 5a that is oriented and extends in the substantially vertical direction. In the first supporter 5, the first column 5a may be rotatably or pivotably connected to the fourth end 2b of the second link 2, as shown. Further, the first supporter 5 may comprise a holder or tray 5b disposed on a top of the first column 5a. The holder 5b may be in direct contact with the elbow, as shown, and may be configured to wrap or enclose around and to grip the elbow for stable support. By directly contacting and supporting the elbow, the first supporter 5 may more reliably support and apply force to the elbow.

In addition to the assembly of the first and second links 1, 2 configured to support the upper limb, the upper limb assist robot may further include a third link 3 connected to the assembly of the first and second links 1, 2 and configured to support the forearm.

The third link 3 may have a body extending along the forearm, as shown in FIGS. 1 and 6-8, and may be provided at an outer portion of the forearm. More specifically, the third link 3 may extend from the elbow to the wrist, in order to stably support the forearm, and may meet or join the second link 2, in order to connect with the link assembly 1, 2, more precisely the second link 2. That is, the third link 3 may be defined as extending from the second link 2 to the wrist. Such a third link 3 may therefore comprise a fifth end 3a adjacent to the fourth end 2b of the second link 2 and a sixth end 3b opposite the fifth end 3a and adjacent to the wrist.

Further, the third link 3 may be rotatably or pivotably connected to the link assembly 1, 2, precisely to the second link 2, in order to assist the movement of the forearm in association with the link assembly 1, 2. That is, the third link 3 may have a third joint J3 rotatably or pivotably connected to the second link 2. As previously described, when the second link 2 is configured to directly support the elbow without the first supporter 5, the third link 3 may be rotatably or pivotably connected directly to the second link 2, and accordingly, may have the third joint J3 provided or connected directly to the second link 2. Meanwhile, as shown in FIGS. 1 and 6-8, when the first supporter 5 is provided to the upper limb assist robot, the third link 3 may have an indirect rotatable connection to the second link 2 via the first supporter 5, and may include a third joint J3 enabling such connection. More specifically, as shown in the related figures, the third link 3 may be rotatably or pivotably connected to the first supporter 5, namely the first column 5a rotatably or pivotably connected to the second link 2, and may thus be rotatably or pivotably connected to the second link 2 by means of such an interposed first supporter 5. In other words, the third link 3 may be defined as having the third joint J3 pivotably connected directly to the first supporter 5, and such a third joint J3 may be likewise pivotably connected to the second link 2, which is pivotably connected to the first supporter 5. By such a third joint J3, the third link 3 may be rotated relative to the assembly of the first and second links 1, 2 supporting the upper arm, and by such rotational movement, the movement of the forearm may be reliably assisted.

More specifically, the third joint J3 may comprise a portion of the first supporter 5, a portion of the third link 3, and a pivot shaft or pin (or a hinge shaft or pin) rotatably coupling these portions of the first supporter and third link 5, 3. On the one hand, the hinge pin or shaft rotatably coupling the first supporter 5 and the third link 3 (or the second link 2) may itself be the third joint J3. On the other hand, only the portions of these first supporter 5 and third link 3 connecting the first supporters 5 and third link 3 may be defined as the third joint J3. Such a third joint J3 may be disposed at any portions of the first supporter 5 and third link 3. For example, as shown in FIGS. 1 and 6-8, the third joint J3 may be disposed at a portion (e.g., a lower portion) of the first supporter 5 and a fifth end 3a of the third link 3 that overlap each other. In other words, the third joint J3 may comprise the lower portion of the first supporter 5, the fifth end 3a of the third link 3, and a hinge shaft joining them, or may comprise only a hinge shaft rotatably or pivotably connecting the lower portion and the end 3a. Alternatively, if the second link 2 is configured to directly support the elbow without the first supporter 5, the third joint J3 may instead comprise the fourth end 2b of the second link 2, the fifth end 3a of the third link 2, and a hinge shaft connecting them, or may comprise a hinge shaft rotatably connecting the fourth end 2b of the second link 2 and the fifth end 3a of the third link 2.

Such a third joint J3 may allow the rotational movement of the forearm-supporting third link 3, thereby allowing the forearm to be moved as the third link 3 moves.

Similarly to the case of the upper arm as described above, in order to reliably assist the movement of the forearm, the upper limb assist robot may be configured to reliably support a free end of the forearm, i.e., the wrist, while applying a force to the wrist. For example, a portion of the third link 3 in the upper limb assist robot, namely the sixth end 3b adjacent the wrist, may be configured to directly support the user's wrist for such a purpose. Nevertheless, the upper limb assist robot according to the first embodiment of the present invention may comprise a separate support member configured to support the wrist, and may include a second supporter 6 as such a support member.

As shown in FIGS. 1 and 6-8, the second supporter 6 may have a body oriented in the substantially vertical direction. Further, a portion of the body of the second supporter 6, such as an upper end or a top thereof, may be in direct contact with the wrist to support the wrist. Accordingly, the second supporter 6 may stably support the wrist. Further, the second supporter 6 may be connected or coupled to the third link 3, thereby transmitting the force or motion of the third link 3 to the wrist to assist in the movement of the forearm. Moreover, the second supporter 6 may be rotatably or pivotably connected to the third link 3 for more smooth transmission of the force or motion of the third link 3. In one example, as shown in FIG. 1, the second supporter 6 may be rotatably or pivotably connected to a sixth end 3b of the third link 3.

More specifically, the second supporter 6 may have a second column 6a that is oriented and extends in the substantially vertical direction. In the second supporter 6, the second column 6a may be rotatably or pivotably connected to a sixth end 3b of the third link 3, as shown. Further, the second supporter 6 may comprise a holder or tray 6b disposed on top of the second column 6a. The holder 6b may be in direct contact with the wrist, as shown, and may be configured to wrap or enclose around and to grip the wrist for stable support. By directly contacting and supporting the wrist, the second supporter 6 may provide more stable support and apply force to the wrist.

As described above, the upper limb assist robot according to the first embodiment may comprise an assembly of members rotatably or pivotably connected relative to each other, namely the links 1, 2, 3 and the supporters 5, 6. Accordingly, in order to more reliably assist the movement of the upper limb, the upper limb assist robot may further comprise an auxiliary mechanism configured to assist the smooth mutual movement of a plurality of such members.

As such an auxiliary mechanism, the assist robot may firstly include a first parallelogram mechanism M1 provided on the first and second links 1, 2. The first parallelogram mechanism M1 may include a first bar member b1 rotatably or pivotably connected to the first link 1, and a second bar member b2 rotatably or pivotably connected to the first bar member b1 and the second link 2, as shown by solid lines in FIG. 1. The first bar member b1 may be configured to rotate or pivot about the first joint J1 of the first link 1, as shown. That is, the first bar member b1 may be configured to share the first joint J1 with the first link 1 for its own relative rotational movement, and thus may enable the rotational movement while achieving structural simplification and stability. Such a first joint J1 may be disposed at any portion of the first bar member b1, and as one example, may be disposed between two ends of the first bar member b1, as shown in FIG. 1. Further, in one example, one end of the second bar member b2 may be rotatably or pivotably connected to one of the ends of the first bar member b1, and the other end of the second bar member b2 may be rotatably or pivotably connected to the middle portion of the second link 2, i.e., a portion between the third and fourth ends 2a, 2b thereof. Further, the first parallelogram mechanism M1 may further comprise portions of the first and second links 1, 2, more specifically, a portion of the first link 1 between the first and second joints J1, J2 and a portion of the second link 2 between the second joint J2 and a point (a portion) connecting with the second bar member b2, for interlocking or linking with the first and second bar members b1, b2. In the first parallelogram mechanism M1, all rotatably or pivotably connected portions (or points) may be provided with hinge shafts that allow rotational movement, similar to the first-third joints J1-J3 as described above.

In such a first parallelogram mechanism M1, in addition to the first link 1, the first and second bar members b1, b2 may directly exert a force on the second link 2 to control the movement of the second link 2. Therefore, the second link 2 may be rotated more stably with respect to the first link 1 by the first parallelogram mechanism M1. Additionally, since the first and second bar members b1, b2 are connected to both the first and second links 1, 2, these bar members b1, b2 may restrict or bind the second link 2 to the first link 1. Thus, the first parallelogram mechanism M1 may constantly maintain an orientation of the second link 2 with respect to the first link 1. That is, the second link 2 may be constrained to rotate in the same plane as the first link 1.

Moreover, since the first supporter 5 supports the elbow, it may be necessary for stable support to maintain a vertical orientation at all times. For these reasons, the upper limb assist robot may comprise a second parallelogram mechanism M2 provided on the first and second links 1, 2 and the first supporter 5. As indicated by the dotted lines in FIG. 1, the second parallelogram mechanism M2 may comprise a third bar member b3 rotatably or pivotably connected to the first link 1, a fourth bar member b4 rotatably or pivotably connected to the second link 2, a fifth bar member b5 rotatably or pivotably connected to the third and fourth bar members b3, b4, respectively, and a sixth bar member B6 rotatably or pivotably connected to the fourth bar member b4 and the first supporter 5, respectively.

The third bar member b3 may be configured to rotate or pivot about the first joint J1 of the first link 1, as shown, and the fourth bar member b4 may be configured to rotate or pivot about the second joint J2 of the second link 2, as shown. In other words, the third and fourth bar members b3, b4 may be configured to share the first and second joints J1, J2 with the first link 1 and the second link 2 for their own relative rotational movement, thereby enabling rotational movement while achieving structural simplification and stability. The first and second joints J1, J2 may be disposed at any portions of the third and fourth bar members b3, b4, and as one example, may be disposed at ends of the third and fourth bar members b3, b4, respectively, as shown in FIG. 1. Further, in one example, one end of the fifth bar member b5 may be rotatably or pivotably connected to the other end of the third bar member b3, and the other end of the fifth bar member b5 may be rotatably or pivotably connected to the other end of the fourth bar member b4. Further, in one example, one end of the sixth bar member b6 may be rotatably or pivotably connected to the other end of the fourth bar member b4, together with the other end of the fifth bar member b5, and the other end of the sixth bar member b6 may be rotatably or pivotably connected to the first supporter 5. Further, for interlocking or linking with the third to sixth bar members b3-b6, portions of the first supporter 5 and the first and second links 1,2 may be included in the second parallelogram mechanism M2. More specifically, the second parallelogram mechanism M2 may include a portion of the first link 1 between the first and second joints J1, J2 which are the connecting portions or points with the third and fourth bar members b3, b4, a portion of the second link 2 between the second joint J2 in connection with the fourth bar member b4 and the fourth end 2b in connection with the first supporter 5, and a portion of the first supporter 5 between a point (or a portion) in connection with the sixth bar member b6 and a point (or a portion) in connection with the second link 2 (i.e., the fourth end 2b). In the second parallelogram mechanism M2, all rotatably or pivotably connected portions may be provided with hinge shafts that allow the rotational movement, similar to the first to third joints J1-J3 as described above.

In such a second parallelogram mechanism M2, the third to sixth bar members b3-b6 may be connected to the first and second links 1, 2 and may be connected to the first supporter 5 at the same time. Therefore, the first supporter 5 may be constrained by the first and second links 1, 2. For this reason, the second parallelogram mechanism M2 may keep the orientation of the first supporter 5 constant. That is, the second parallelogram mechanism M2 may align the first supporter 5 in the vertical direction, and thus the elbow may always be reliably supported by such a first supporter 5.

Furthermore, since the second supporter 6 supports the wrist, it may be desirable for stable support to maintain an upright or vertical orientation of the second supporter 6 at all times, like the first supporter 5. For this reason, the upper limb assist robot may comprise a third parallelogram mechanism M3 provided on the third link 3 and the second supporter 6. When the upper limb assist robot further includes the optional first supporter 5, the third parallelogram mechanism M3 may be provided over the third link 3 and the first and second supporters 5, 6. The third parallelogram mechanism M3 may include a seventh bar member b7 connected to the first and second supporters 5, 6, respectively, as shown by the dotted lines in FIG. 1. In one example, one end of the seventh bar member b7 may be rotatably or pivotably connected to the first supporter 5, and the other end of the seventh bar member b7 may be rotatably or pivotably connected to the second supporter 6. Further, for interlocking or cooperating with the seventh bar member b7, portions of the first and second supporters 5,6 may be included in the third parallelogram mechanism M3. That is, the third parallelogram mechanism M3 may further comprise the third link 3 itself, a portion of the first supporter 5 between a point (or a portion) in connection with the third link 3 and a point (or a portion) in connection with the seventh bar member b7, and a portion of the second supporter 6 between a point (or a portion) in connection with the third link 3 and a point (or a portion) in connection with the seventh bar member b7. In the third parallelogram mechanism M3, all rotatably or pivotably connected portions may include the hinge shaft or axes that allow the rotational movement, similar to the first to third joints J1-J3 as described above.

In such a third parallelogram mechanism M3, the third link 3 and the seventh bar member b7 may be coupled to the supporters 5, 6 with transversely extending between the first and second supporters 5, 6. Thus, the first and second supporters 5, 6 may be constrained to each other. For this reason, the third parallelogram mechanism M3 is able to constantly maintain the orientation of the second supporters 6, due to the first supporter 5 maintaining the constant orientation through the second parallelogram mechanism M2. That is, the third parallelogram mechanism M3 may align the second supporter 6 in the vertical direction, whereby the wrist may be always reliably supported by this second supporter 6.

In the upper limb assist robot according to the first embodiment, the links 1, 2, 3, the supporters 5, 6, and the mechanisms M1-M3 may form a chassis, frame, or skeleton of the upper limb assist robot, which supports the upper limb to assist the movement of the upper limb and performs the function of applying force or motion to the upper limb. The frame 1, 2, 3, 5, 6, M1-M3 of the upper limb assist robot, together with the power generation and control devices, namely the actuators 10, 20, 30 and the adjustment module 1000′ described later, may be directly mounted on the upper limb, i.e., the arm of the user, and a predetermined mounting module may be added to the upper limb assist robot for such mounting. Meanwhile, it is common for the user's upper limb to move at a distance from a predetermined plane or floor, unlike the lower limb, which interacts directly with the ground. For example, when the user stands, the user's upper limb moves with being spaced from the ground, and when the user is seated, the user's upper limb moves with being spaced from a nearby table surface, in most cases. Accordingly, the frame and the accessory or device of the upper limb assist robot may be configured to be mounted on a predetermined plane or surface, such as a ground or a table surface, and to move while being supported against such a surface, so as to reliably assist the intended upper limb movement of the user. For these reasons, the upper limb assist robot according to the first embodiment may comprise a mount 4 configured to support the frame and devices thereof against a predetermined plane or surface. The mount 4 may primarily support the frame and devices of the upper limb assist robot against the plane or surface, and the frame may be configured to support the upper limb of the user, as described above. Thus, the mount 4 may be configured to movably support the upper limb of the user with respect to the predetermined plane or surface, more particularly the plane, surface, or floor near the upper limb of the user. Such a mount 4 may be basically configured to support the first and second links 1, 2 on the plane, and thus to support the upper arm and movement thereof. Further, the mount 4 may be configured to support other members 3, 5, 6, M1-M3, and devices 10, 20, 1000′ directly and indirectly connected to the first and second links 1, 2 with respect to a plane, and may be configured to support the entire upper limb and movement thereof.

As shown in FIGS. 1 and 6-8, the mount 4 may have a body having a predetermined length while being oriented in the substantially vertical direction. An upper end of the mount 4 may be rotatably or pivotably connected to the first link 1 to allow the rotational movement of the first link 1. For the same reason, the upper end of the mount 4 may also be rotatably connected with the first and third bar members b1, b3 so as to allow rotational movement of the first bar member b1 and the third bar member b3 rotatably connected to the first link 1. As previously described, for structural simplification and stability, the first link 1 and the first and third bar members b1, b3 may share the first joint J1 and be rotatable relative to each other, and thus the upper end of the mount 4 may also be rotatably coupled to the first joint J1 for the same purpose. Further, the lower end of the mount 4 may be in contact with the surface or plane and thus is able to stably support the first and second links 1, 2 and the other members 3, 5, 6, M1-M3, and devices 10, 20, 30, 1000′ coupled to links 1, 2 against the surface. Further, the mount 4 may be configured to rotate or pivot about an axis S extending perpendicularly to the ground in the direction of gravity. Such a vertical axis S may pass through the center of the mount 4 and the first joint J1, and the mount 4 may rotate or pivot stably about(or on) such a vertical axis S. Accordingly, while rotating or pivoting about the vertical axis S, the mount 4 may rotate or pivot the frames 1, 2, 3, 5, 6, M1-M3 and devices 10, 20, 30, 1000′ coupled thereto, as well as the upper limb itself supported by the frames, on or above the surface or plane.

More specifically, the mount 4 may have a rod 4a oriented vertically and extending by a predetermined length from the supporting plane or surface. Such a rod 4a may contact the plane and stably support the coupled frames 1, 2, 3, 5, 6, M1-M3 and devices 10, 20, 30, 1000′ and the upper limb itself coupled thereto against the plane. Further, the rod 4a may be rotated or pivoted about the vertical axis S extending in the direction of gravity while passing through the first joint J1. For this rotation, devices to guide and support the movement, such as bearings and motion guides, may be installed, for example, at the lower end of the rod 4a. Further, the rod 4a, i.e., the mount 4, may be rotated manually, or alternatively, a driving device may be provided to the mount 4, i.e., the rod 4a, to apply an external force for rotation. For example, the driving device may include a power source, such as a motor, and a transmission mechanism that transmits the generated force to the rod 4a, such as a gear train or pulley/belt. Further, the mount 4 may include a bracket 4b disposed on an upper portion or a top of the rod 4a. Such a bracket 4b may be rotatably or pivotably coupled with the first link 1 and the first and third bar members b1, b3 to basically allow rotational movement of the first link 1 and the first and third bar members b1, b3. More specifically, as shown in FIG. 5A, the bracket 4b may be rotatably or pivotably coupled to the first joint J1 rotatably or pivotably connecting the first link 1 and the first and third bar members b1, b3 to each other. For a more stable engagement, as shown, a pair of brackets 4b may be provided on the upper end or a top of the rod 4a, which may rotatably grip or support the first link 1 and the first and third bar members b1, b3 while engaging with the first joint J1.

To apply a force for movement of the link assemblies 1, 2 as described above, the upper limb assist robot may include actuators 10, 20 as a power system or driving system. In such a power system, the actuators 10, 20 may correspond to a power generator configured to generate the required force. Further, as the same power system, the upper limb assist robot may include an adjustment module 1000′, wherein the adjustment module 1000′ may correspond to a power control unit configured to appropriately adjust the forces generated by the actuators 10, 20.

As previously described, in the upper limb of the user, the upper arm performs a primary role in the movement of the upper limb, with moving relative to both the shoulder and the elbow. Accordingly, the actuators 10, 20 may be configured to primarily apply the forces to the assembly of the first and second links 1, 2 to assist such upper limb movement. Further, the movement of these first and second links 1, 2 may be achieved by relative rotation of the first and second links 1, 2 about the first and second joints J1, J2, as described above. For this reason, for the movement of the first and second links 1, 2, the upper limb assist robot may comprise first and second actuators 10, 20 configured to apply forces to the first and second joints J1, J2, respectively. As shown in FIGS. 6-8, the forces exerted on the first and second joints J1, J2 by the first and second actuators 10, 20 may act as a combined or resultant force on the elbow of the upper limb via the first and second links 1, 2. Further, as shown in FIG. 1, when the upper limb assist robot includes a support member for the elbow, such as the first supporter 5, the forces applied to the first and second joints J1, J2 may act as a combined or resultant force on the elbow via the first and second links 1, 2 and the first supporter 5. This transmission of forces from the first and second joints J1, J2 to the elbow may be equally applicable to the first embodiment and a second embodiment described later, unless otherwise indicated.

Conventional actuators applied to upper limb assist robots have an electric-powered (or motorized) mechanism that utilizes electricity to generate the required force. In contrast to such conventional actuators, the first and second actuators 10, 20 may be configured to provide the required force to the upper limb assist robot using only mechanical forces generated by the mechanical elements without the aid of electrical forces. For example, as will be described later, the first and second actuators 10, 20 may generate and provide to the first and second links 1, 2, the elastic forces of the mechanical elements, more specifically a tension or elastic force due to the deformation and restoration of the elastic members. Further, the conventional electric-powered actuator is configured to be coupled directly to the axis or shaft of the joint and to apply a torque directly to the axis of the joint. In contrast, as the first and second actuators 10, 20 utilize forces generated from the deformation of the mechanical elements, the actuators 10, 20 may require a space for such deformation, and therefore may not be directly coupled to the axes or shafts of the joints, but spaced apart from the joints.

Due to this structural difference from the conventional electric-powered actuators, the first actuator 10 may include a first coupler P1 connected to the first link J1 to appropriately generate and provide the mechanical force to the first joint J1. Further, to provide support for deformation and restoration of the mechanical element (i.e., the elastic member) included in the first actuator 10, the first actuator 10 may include a third coupler P3 connected to another member or device spaced apart from the first coupler P1, namely the adjustment module 1000′. Alternatively, the adjustment module 1000′ may be described as having the third coupler P3 that connects to the first actuator 10. As will be described later, the adjustment module 1000′ may be configured to control the force applied to the first joint J1 through appropriate manipulation of the third coupler P3.

More specifically, the first coupler P1 may be physically coupled to the first link 1 so that the force of the first actuator 10 may be first applied to the first coupler P1 and then transmitted to the first joint J1 via the body of the first link 1 connected to the first coupler P1. Such a first coupler P1 may be disposed at any portion of the first link 1. For example, as shown in FIG. 1 and FIGS. 6-8, the first coupler P1 may be disposed at an end of the first link 1, i.e., the first end 1a.

Similarly to the first actuator 10, the second actuator 20 may include a second coupler P2 connected to the second link 2 to appropriately generate and provide the mechanical force to the second joint J2. Further, to provide support for deformation and restoration of the mechanical element (i.e., the elastic member) included in the second actuator 20, the second actuator 20 may include a fourth coupler P4 connected to another member or device spaced apart from the second coupler P2, namely the adjustment module 1000′. Alternatively, the adjustment module 1000′ may be described as having the fourth coupler P4 that connects to the second actuator 20. As will be described later, the adjustment module 1000′ may be configured to control the force applied to the second joint J2 through appropriate manipulation of the fourth coupler P4.

More specifically, the second coupler P2 may be directly disposed or coupled to the second link 2 in a manner similar to the first coupler P1. In such a case, the force of the second actuator 20 may be applied to the second coupler P2 first and then transmitted to the second joint J2 via the body of the second link 2 physically connected to the second coupler P2. Meanwhile, in view of the configuration of the upper limb assist robot as shown, if the second actuator 20 is directly connected to the second link 2, there is a possibility that such a second actuator 20 may interfere with other nearby members. As described above, the first parallelogram mechanism M1 may be configured to exert the force on the second link 2 for relative movement of the second link 2 with respect to the first link 1. Accordingly, the second actuator 20 may be connected to the first bar member b1 disposed and exposed on the outermost side of the first parallelogram mechanism M1, and the second coupler P2 may be disposed on such a first bar member b1. The second coupler P2 may be connected to the second link 2 via the second bar member b2 by being coupled to the first bar member b1. In this case, the force of the second actuator 20 may be applied to the second coupler P2 first and then transmitted to the second joint J2 via the first and second bar members b1, b2 and the body of the second link 2. Such a second coupler P2 may be disposed at any portion of the first bar member b1. For example, as shown in FIG. 1 and FIGS. 6-8, the second coupler P2 may be disposed at an end of the first bar member b1.

Meanwhile, since the first and second actuators 10, 20 are connected to the first and second links 1, 2 and the adjustment module 1000′ by the first to fourth couplers P1-P4, it may be required for smooth movement of the links 1, 2 that the first and second actuators 10, 20 are also configured to move relative to the links 1,2. For this reason, in the first and second actuator 10, 20, the first coupler P1 may be configured to be rotatably or pivotably connected to the first link 1, and the second coupler P2 may be configured to be rotatably or pivotably connected to the second link 2, i.e. to the first bar member b1.

Further to these basic configurations, the detailed configuration of the first and second actuators 10, 20 together with the configuration of the associated adjustment module 1000′ will be described in more detail with reference to FIGS. 1 and 2 as follows.

Firstly, as best illustrated in FIG. 2, the first actuator 10 may include a first wire 11 extending from the first link 1 to the adjustment module 1000′. The adjustment module 1000′ may include a housing 1100′ forming an inner space 1101′ of a predetermined size, as shown. The adjustment module 1000′ may accommodate a first spring 12 in the formed inner space 1101′ together with other components of the first actuator 10, and may protect the first spring 12 during operation of the first spring 12, i.e., during deformation and restoration. The first wire 11 may extend from the first link 1 to the inner space 1101′ of the adjustment module 1000′ and connect the first link 1 to the first spring 12, thereby allowing the force generated by the deformation of the first spring 12 to be transmitted to the first link 1, i.e. to the first joint J1, via the first coupler P1.

More specifically, the first wire 11 may comprise a longitudinally elongated body and first and second ends 11a,11b corresponding to two ends of the body. The first end 11a of such a first wire 11 may be coupled to a first link 1, more precisely to the first end 1a thereof, and may be rotatably or pivotably connected to the first end 1a using a predetermined pivoting mechanism, for example a hinge structure or shaft. Due to this configuration, the first end 11a of the first wire 11 (i.e., the hinge shaft thereof) may actually form the first coupler P1 rotatably or pivotably connected to the first link 1 as described above. Meanwhile, the first wire 11 may extend into the interior of the housing 1100′ of the adjustment module 1000′, i.e., into the interior space 1101′, as shown, such that the second end 11b may be disposed in the housing 1100′ and may be connected to the first spring 12. Since the force generated in the deformation and restoration of the first spring 12 are transmitted to the first link 1 via the first wire 11, it may be required for the first wire 11 to be under a suitable tension in order for the generated force to be transmitted without loss. For this reason, pulleys 1102′ may be provided within the housing 1100′ of the adjustment module 1000′, and by winding the first wire 11 on these pulleys 1102′, an appropriate tension may be provided on the first wire 11. Further, while being guided on these pulleys 1102′, the first wire 11 may be configured to be moveable relative to the adjustment module 1000′, more precisely, relative to the housing 1100′ thereof. That is, as the first end 11a of the first wire 11 is firstly constrained to the first link 1, the first wire 11, in particular the second end 11b thereof, may be displaced relative to the housing 1100′ in response to a horizontal or vertical movement of the adjustment module 1000′ (i.e., the housing 1100′), and this displacement may deform or restore the first spring 12 to generate a predetermined force. As such, to deform the first spring 12, the first wire 11 may be supported while being in physical contact with the adjustment module 1000′. Thus, the mutually contacting or supported portions of the adjustment module 1000′ and the first actuator 10 (particularly, the first wire 11) may function as the third coupler P3 of the first actuator 10 and the adjustment module 1000′. For example, referring to FIG. 2, a portion of the housing 1100′ that is in contact with the first wire 11, more specifically, an opening that guides and introduces the first wire 11 into the interior space 1101′, may function as the third coupler P3. Further, various parts of the adjustment module 1000′ in contact with or coupled (or connected) to the first actuator 10, namely the pulley 1102′ and other parts of the housing 1100′, may also function or be defined as such third coupler P3.

The first actuator 10 may also include the first spring 12 housed within the adjustment module 1000′, as previously described. One end of the first spring 12 may be coupled to a portion of the housing 1100′ of the adjustment module 1000′, and the other end thereof may be coupled to the second end 11b of the first wire 11. Therefore, the relative movement of the first wire 11 with regard to the adjustment module 1000′, i.e., the movement of the second end 11b, may cause the first spring 12 to be deformed to generate the intended force. Such a first spring 12 together with the first wire 11 may comprise, for example, a zero-free length spring in order to accurately generate the intended force. Meanwhile, as defined above, any portion of the adjustment module 1000′ (particularly, the housing 1100′) connected to the one end of the first spring 12 may serves as the third coupler P3. As such a one end of the first spring 12 corresponds to an end of the first actuator 10, it may be described that the portion of the adjustment module 1000′ (particularly, the housing 1100′) connected or coupled to the end of the first actuator 10 functions as the third coupler P3. As previously discussed, the third coupler P3 may comprise any portions of the adjustment module 1000′ that connect to the first actuator 10 to cause the mechanical deformation of the first actuator 10, i.e., the elastic member therein like the first spring 12.

The second actuator 20 may also include a configuration similar to the first actuator 10 described above.

First, as well shown in FIG. 2, the second actuator 20 may include a second wire 21 extending from the second link 2 to the adjustment module 1000′. As previously described, the adjustment module 1000′ may accommodate a second spring 22 within the formed inner space 1101′, together with other components of the second actuator 20, and may protect the second spring 22 during operation of the second spring 22, i.e., during deformation and restoration. Further, as previously described, the second actuator 20 may be directly connected to the second link 2, but in the first embodiment as shown, the actuator 20 may be connected to the first bar member b1 of the first parallelogram mechanism M1 to avoid interference with other elements. Therefore, in the first embodiment as shown, the second wire 21 may extend from the first bar member b1 instead of the second link 2, to the inner space 1101′ of the adjustment module 1000′ and may connect the second link 2 and the second spring 22, via the first and second bar members b1, b2, thereby enabling the force generated by the deformation of the second spring 22 to be transmitted to the second link 2, i.e., to the second joint J2, via the second coupler P2 and the first and second bar members b1, b2.

More specifically, the second wire 21 may comprise a longitudinally elongate body and third and fourth ends 21a, 21b corresponding to two ends of the body. As previously described, the third end 21a of such a second wire 21 may, instead of being coupled directly to the second link 2, be coupled to another member, namely the end of the first bar member b1, which is connected to the second link 2, and thus may be substantially connected to the second link 2. Further, the third end 21a of the second wire 21 may be rotatably or pivotably connected to the end of the first bar member b1 using a predetermined pivoting mechanism, for example a hinge structure or shaft, for smooth relative rotation. Due to this configuration, the third end 21a of the second wire 21 (i.e., the hinge shaft thereof) may substantially form the second coupler P2, which is rotatably or pivotably connected to the second link 2 as described above. Meanwhile, the second wire 21 may extend into the interior of the housing 1100′ of the adjustment module 1000′, i.e., into the inner space 1101′, as shown, so that the fourth end 21b may be disposed within the housing 1100′ and may be connected with the second spring 22. Since the force generated in the deformation and restoration of the second spring 22 is transmitted to the second link 2 via the second wire 21, it is required for the second wire 21 to be under the suitable tension in order for the generated force to be transmitted without loss. For this reason, the pulleys 1102′ may be provided within the housing 1100′ of the adjustment module 1000′, and by winding the second wire 21 on these pulleys 1102′, an appropriate tension may be provided on the second wire 21. Further, while being guided on these pulleys 1102′, the second wire 21 may be configured to be moveable relative to the adjustment module 1000′, more precisely, relative to the housing 1100′ thereof. That is, since the third end 21a of the second wire 21 is firstly constrained to the second link 2, precisely to the first bar member b1, the second wire 21, and in particular the fourth end 21b, may be displaced relative to the housing 1100′ in response to a horizontal or vertical movement of the adjustment module 1000′ (i.e., the housing 1100′), and this displacement may deform or restore the second spring 22 to generate a predetermined force. As such, to deform the second spring 22, the second wire 21 may be supported while being in physical contact with the adjustment module 1000′. Thus, the mutually contacting or supported portions of the adjustment module 1000′ and the second wire 21 may function as the fourth coupler P4 of the second actuator 20 and the adjustment module 1000′. For example, referring to FIG. 2, a portion of the housing 1100′ that contacts the second wire 21, more specifically, an opening that guides and introduces the second wire 21 into the inner space 1101′, may function as the fourth coupler P4. Furthermore, various other parts of the adjustment module 1000′ that are in contact with the second wire 21, namely the pulley 1102′ and other parts of the housing 1100′, may also function or be defined as such a fourth coupler P4.

Additionally, the second actuator 20 may include the second spring 22 housed within the adjustment module 1000′, as previously described. One end of the second spring 22 may be coupled to a portion of the housing 1100′ of the adjustment module 1000′, and the other end may be coupled to the fourth end 21b of the second wire 21. Therefore, relative movement of the second wire 21 with regard to the adjustment module 1000′, i.e., movement of the fourth end 21b, may cause the second spring 22 to deform and generate the intended force. Such a second spring 22 together with the second wire 21 may comprise, for example, a zero-free length spring in order to accurately generate the intended force. Meanwhile, as defined above, any portion of the adjustment module 1000′ (particularly, the housing 1100′) connected to the one end of the second spring 22 may serves as the fourth coupler P4. As such a one end of the second spring 22 corresponds to an end of the second actuator 20, it may be described that the portion of the adjustment module 1000′ (particularly, the housing 1100′) connected or coupled to the end of the second actuator 20 functions as the fourth coupler P4. As previously discussed, the fourth coupler P4 may comprise any portions of the adjustment module 1000′ that connect to the second actuator 20 to cause the mechanical deformation of the first actuator 10, i.e., the elastic member therein like the second spring 22.

As described above, the first and second actuators 10, 20 have a simple structure comprising only deformable springs 12, 22 and wires 11, 21 transmitting the forces generated thereby, and may therefore be symbolized as elastic members connecting the first link 1 and the second link 2 (i.e., the first bar member b1) to the adjustment module 1000′, as shown in the other figures except FIG. 2. Further, according to the definition of the connecting portion with the first and second actuators 10, 20, the third and fourth couplers P3, P4 may be symbolized as simple points on the adjustment module 1000′ that are connected to such actuators 10, 20 as symbolized, respectively. Meanwhile, to be consistent with such symbolization, the first and second actuators 10, 20 may comprise elastic members, i.e., springs, which are substantially disposed outside the adjustment module 1000′ and connect the first link 1 and the second link 2 (i.e., the first bar member 1) to the adjustment module 1000′. In such a case, the first and second couplers P1, P2 of the first and second actuators 10, 20 may comprise ends of the spring members (i.e., the actuators 10, 20) connected to the first and second links 1, 2, respectively, and the third and fourth couplers P3, P4 thereof may comprise the other ends of the spring members connected to the adjustment module 1000′.

In order for the upper limb assist robot according to the first embodiment of the present invention as described above, to be optimally designed to move the links 1, 2 using only the forces of the actuators 10, 20, a model of dynamics thereof is needed to be reviewed. Accordingly, the upper limb assist robot (i.e., the link assembly 1, 2 and the actuators 10, 20 thereof) is shown in FIGS. 3A-4B as the dynamics models. First, FIGS. 3A and 3B are a set of conceptual diagrams illustrating dynamics models related to the thrust generation in the upper limb assist robot according to the first embodiment.

Referring to FIGS. 3A and 3B, the link assembly 1, 2 and actuators 10, 20 are shown simplified in a two-dimensional coordinate system comprising an x-axis and a y-axis. The y-axis is set along a direction (or line) of action of gravity, i.e., a direction perpendicular to the ground (a vertical direction), and the x-axis is set along a direction perpendicular to the direction of action of gravity, i.e., a direction parallel to the ground (a horizontal direction). More specifically, for example, the y-axis may be the vertical axis S extending in the direction of gravity through the center of the mount 4 or through the first joint J1, and the x-axis may be a horizontal axis extending perpendicular to such a y-axis.

Within such a coordinate system, the links 1, 2 are shown as simple bar members of a predetermined length, and a gravitational force g is acted on the link assembly 1, 2 by a mass M of the upper limb assist robot and the user. Further, the first and second actuators 10, 20 are shown in the form of first and second springs 12, 22 that substantially generate mechanical forces. Moreover, the first and second couplers P1, P2 of the first and second actuators 10, 20 are shown connected to first and second links 1, 2, as previously described. Further, the third and fourth couplers P3, P4 of the first and second actuators 10, 20 are shown connected to the adjustment module 1000′, as previously described. In FIGS. 3A and 3B, the links 1, 2, the actuators 10, 20 the couplers P1, P2, the couplers P3, P4 and the forces fs, fg, ft are shown as a corresponding single element for simplicity and better understanding.

In such a FIG. 3A, when the third and fourth couplers P3, P4 are aligned on or disposed adjacent to the y-axis, i.e., the vertical axis S, the forces fs of the actuators 10, 20 may all act on the first and second joints J1, J2 as a counteracting, countervailing, counterbalancing, or canceling force fg that acts in a direction opposite to the direction of gravity substantially along the vertical axis (y-axis) S (i.e., in the vertical direction). Accordingly, the gravitational force g acting on the upper limb of the user and the upper limb assist robot, at least the upper arm and the first and second links 1, 2, may be canceled, and the upper limb of the user may be easily moved by any external force acting on the upper limb or the upper limb assist robot.

Meanwhile, as shown in FIG. 3B, when the positions (or locations) of the third and fourth couplers P3, P4 are changed by a distance d in the horizontal direction, the directions of the forces applied to the first and second joints J1, J2 by the first and second actuators 10, 20 may be changed by such changes in positions. Specifically, the position of the third and fourth couplers P3, P4 may be changed by moving or shifting the couplers P3, P4. More specifically, for such movement and repositioning, the third and fourth couplers P3, P4 may be offset or spaced apart by a predetermined distance d in the horizontal direction from the vertical axis S or y-axis. Such movement and position change (i.e., repositioning) may cause the third and fourth couplers P3, P4 to be moved horizontally or to be disposed in different positions, relative to the first and second couplers P1, P2. On the other hand, such a movement and repositioning may correspond to horizontal relative movement and repositioning of the third and fourth couplers P3, P4 with respect to the upper limb assist robot, more specifically with respect to the vertical axis S or y-axis, which is the direction of gravitational action.

As such, when the positions of the couplers P3, P4 are changed, i.e., offset by the distance d in the horizontal direction from the vertical axis S or y-axis, the orientations of the first and second actuators 10, 20 disposed between the first and second couplers P1, P2 and the third and fourth couplers P3, P4 may be changed, and with these changes in orientation, the directions (i.e., the orientations, more specifically, the orientations of lines of action) of the forces applied to the joints J1, J2 by the actuators 10, 20 may also be changed. More specifically, the forces fs of the actuators 10, 20 may be oriented to have a predetermined angle a with respect to the vertical direction, i.e., the vertical axis S or y-axis, and accordingly, vertical component forces fg and horizontal component forces ft may be generated on the first and second joints J1, J2, respectively. Here, each vertical component force fg is an offsetting or counteracting force that acts opposite to the direction of gravity to offset or cancel the gravitational force g exerted on the user's upper limb and the upper limb assist robot (more specifically, the upper arm and the first and second links 1, 2), while the horizontal component force ft acts as an additional force, i.e., a thrust force, on the upper limb of the user and the upper limb assist robot. Further, the forces fs of the actuators 10, 20 may be set such that the vertical component forces fg generated therefrom completely offsets or cancels the gravitational force g. In such a case, the generated horizontal component forces ft may correspond to component forces acting in the direction intended by the design, i.e., a kind of thrust, which may move the upper limb assist robot and the user's upper limb (more specifically, the upper arm and the first and second links 1, 2) without any force being applied by the user. Thus, by changing the directions of the applied forces by changing the positions of the third and fourth couplers P3, P4, the forces of the actuators 10, 20 may be utilized to generate a force in the intended direction while cancelling the applied gravitational force.

Furthermore, when the third and fourth couplers P3, P4 are moved to different positions in the horizontal direction, for example, when the offset distance d from the vertical axis or y-axis is changed, the magnitudes of the vertical and horizontal component forces fg, ft may also be changed. In particular, by the change of the horizontal force ft, the magnitude of the force exerted on the upper limb assist robot may also be adjusted to correspond to the magnitude of the force actually required.

FIGS. 4A and 4B are a set of conceptual diagrams illustrating dynamics models related to the generation of the increased force in the upper limb assist robot according to the first embodiment. More specifically, FIGS. 4A and 4B illustrate the models of dynamics in which the magnitudes of the forces generated by the first and second actuators 10, 20 are adjusted according to an operational situation of the upper limb assist robot. FIG. 4A and FIG. 4B include the same basic dynamics models as described in FIG. 3A and FIG. 3B. Accordingly, since the setup and operation of the basic dynamics models of FIGS. 4A and 4B have already been previously described with reference to FIGS. 3A and 3B, such descriptions related to FIGS. 3A and 3B also apply to the models of FIGS. 4A and 4B and only the descriptions regarding the additional aspects of the dynamics models in FIGS. 4A and 4B are provided below.

Referring to FIG. 4A and FIG. 4B, a first distance L1 may be formed between the first and third couplers P1, P3 of the first actuator 10, and a second distance L2 may be formed between the second and fourth couplers P2, P4 of the second actuator 20. These first and second distances L1, L2 may also be described as a first length and a second length. The first and second distances L1, L2 may represent, in practice, the relative amounts of movements of the first and second wires 11, 21 with respect to the adjustment module 1000′, i.e., the displacement of the second and fourth ends 11b, 21b thereof with respect to the adjustment module 1000′, as described with reference to FIG. 2. Thus, the first and second distances L1, L2 may determine the amount of deformations of the first and second springs 12, 22 connected to the second and fourth end portions 11b, 21b, and accordingly, determine the magnitudes of the forces generated by the first and second actuators 10, 20. If the first and second distances L1, L2 are changed to new first and second distances L1′, L2′, the first and second springs 12, 22 may deform further by the changed length. Further, the magnitudes of the forces fs of the actuators 10, 20 may be also changed to a new magnitudes of the forces fs' according to the changed amount of deformations of the first and second springs 12, 22. Therefore, when the first and second distances L1, L2 are changed, the magnitudes of the forces generated at the actuators 10, 20 may change by the changes in distance, which in turn may change the magnitudes of the forces applied to the first and second joints J1, J2 via the first and second couplers P1, P2.

In one example, the first and second distances L1, L2 may be changed by moving the third and fourth couplers P3, P4 to be disposed at new positions P3′, P4′, as shown in FIG. 4A and FIG. 4B. More specifically, for such movement and position change, the third and fourth couplers P3, P4 may be moved by a predetermined height or distance h in vertical direction. Such movement and repositioning may cause the third and fourth couplers P3, P4 to be moved in the vertical direction or to be disposed in a different position, relative to the first and second couplers P1, P4, which are disposed or stationary at a predetermined position. On the other hand, it may also be described that the third and fourth couplers P3, P4 are moved in the vertical direction relative to the first and second joints J1, J2 instead of the first and second couplers P1, P2 and then are disposed in changed positions.

As such, when the amounts of strains or deformations on the springs 13, 23 are changed by the changes in distances L1, L2, the forces of the actuators 10, 20 may be changed to the new magnitudes of forces fs′. In one example, the magnitudes of the new forces fs' may be increased. In such a case, the offsetting or counteracting force fg acting in a direction opposite to the direction of gravity may also be increased, as shown in FIG. 4A, to more fully or completely cancel the gravitational force g acting on the user's upper limb and the upper limb assist robot (more specifically, the upper arm and the first and second links 1, 2). Further, as shown in FIG. 4B, by the increased forces fs' of the actuators 10, 20, their component forces which are the vertical component forces fg′ and the horizontal component forces ft′, i.e., the counteracting forces and the thrust forces, may also be increased, so as to respond appropriately to changes in the forces required for proper operation of the upper limb assist robot.

Further, when the third and fourth couplers P3, P4 are moved to different positions in the vertical direction, that is, when the vertical movement height h is changed, the distances L1, L2 may also be changed to different values. In this way, by adjusting the distances L1, L2 to different values, the actuators 10, 20 may provide different magnitudes of forces. For example, the forces of the actuators 10, 20 may be increased or decreased in real time by adjusting the distances L1, L2 in accordance with the operating conditions of the upper limb assist robot (e.g., real-time adjustment), and thus the operation of the upper limb assist robot may be performed more smoothly and reliably.

Due to the configuration of the adjustment module 1000′ and the geometric positioning of the third and fourth couplers P3, P4, the movements of the third and fourth couplers P3, P4 have been described with reference to the vertical axis S passing through the first joint J1 in FIGS. 3A-4B. However, the changes in directions and magnitudes of the forces generated by such movements of the third and fourth couplers P3, P4 occur separately in both the vertical axis S passing through the first joint J1 and a vertical axis passing through the second joint J2, which are associated with the first and second actuators 10, 20, respectively, as shown in FIGS. 6-8. That is, by movements of the third and fourth couplers P3, P4, the force exerted by the first actuator 10 may result in the offsetting or cancelling of gravity and the generation and increase of thrust, in the vertical axis S passing through the first joint J1, and the force exerted by the second actuator 10 may result in the offsetting or cancelling of gravity and the generation and increase of thrust, in the vertical axis passing through the second joint J2, separately.

The changes in positions of the third and fourth couplers P3, P4 and the changes in distances L1, L2 described above with reference to FIGS. 3A-4B may be accomplished by various mechanisms. Among these mechanisms, as one example, the upper limb adjustment robot of the present invention may include the adjustment module 1000′ that adopts a translational movement mechanism driven by a predetermined driving device. By utilizing such a translational movement mechanism, the adjustment module 1000′ may manipulate the third and fourth couplers P3, P4 to achieve the changes in the directions and magnitudes of the forces on the actuators 10, 20 as suggested in the dynamics models of FIGS. 3A-4B. That is, the adjustment module 1000′ may cause the third and fourth couplers P3, P4 to translationally move in the horizontal and vertical directions, and as a result of such translational movements, change the positions of the third and fourth couplers P3, P4 and change the distances L1, L2. Thus, the adjustment module 1000′ enables vertical and horizontal translations of the third and fourth couplers P3, P4 and thus enables all the operations based on such vertical and horizontal translations presented in the dynamics models of FIGS. 3A-4B. The adjustment module 1000′ may adopt the translational movement mechanism that utilizes only simple mechanical elements, as will be described in the following, which allows the structure of the upper limb assist robot to be lightweight and compact while performing its intended function. The detailed configuration of such an adjustment module 1000′ will be described in detail below with reference to FIGS. 2, 5A and 5B.

First, the adjustment module 1000′ may include a first driver 1200′ provided to the body of the adjustment module 1000′, i.e., the housing 1100′, as the translational movement mechanism. The first driver 1200′ may be configured to move the housing 1100′ in the horizontal direction. More specifically, the first driver 1200′ may include a first guide device 1201′ that guides and supports horizontal translational movement of the housing 1100′. In one example, the first driver 1200′ may include a linear motion guide as such a first guide device 1201′. The first driver 1200′ may employ any other device that guides and supports horizontal translational movement, such as a rail, as the first guide device 1201′. Further, the housing 1100′, i.e., the adjustment module 1000′, may be manually moved in the horizontal direction under the guidance of the first guide device 1201′. On the other hand, the first driver 1200′ may further comprise a first power unit to apply an external force for horizontal translational movement of the housing 1100′. The first power unit may comprise any device configured to add the external force to the housing 1100′. For example, the first power unit may include a power source, such as a motor, and a transmission mechanism, such as a gear train or pulley/belt, which transmits the generated force to the housing 1100′. As described above, the housing 1100′ of the adjustment module 1000′ may be moved in the horizontal direction by the first driver 1200′, and accordingly, the adjustment module 1000′, i.e., the third and fourth couplers P3, P4 connected or coupled to the housing 1100′, may also be moved in the horizontal direction. Therefore, the adjustment module 1000′ may be configured to move the third and fourth couplers P3, P4 in the horizontal direction by movement of the housing 1100′ using the first driver 1200′. Since the housing 1100′ and the couplers P3, P4 are connected to each other and move together and the housing 1100′ corresponds to the main body comprising the majority of the adjustment module 1000′, it may also be described that the adjustment module 1000′ itself is substantially configured to move horizontally together with the couplers P3, P4 for the horizontal movement of the third and fourth couplers P3, P4. Alternatively, the first driver 1200′ described above may be applied only to the periphery of the third and fourth couplers P3, P4, so that instead of moving the entire housing 1100′, only the periphery of the third and fourth couplers P3, P4 may be moved by such first driver 1200′.

Further, the adjustment module 1000′ may include a second driver 1300′ provided to the body of the adjustment module 1000′, i.e., the housing 1100′, as the translational movement mechanism. The second driver 1300′ may be configured to move the housing 1100′ in the vertical direction. More specifically, the second driver 1300′ may include a second guide device 1301′ that guides and supports the vertical translational movement of the housing 1100′. In one example, the second driver 1300′ may include a linear motion guide as the second guide device 1301′. The second driver 1300′ may employ any other device for guiding and supporting the vertical translation, such as a rail, as the second guide device 1301′. Further, the housing 1100′, i.e., the adjustment module 1000′, may be manually moved in the horizontal direction under the guidance of the second guide device 1201′. Alternatively, the second driver 1300′ may include a second power unit that applies an external force for the vertical translation of the housing 1100′. The second power unit may comprise any device configured to apply the external force to the housing 1100′. For example, the second power unit may include a power source, such as a motor, and a transmission mechanism, such as a gear train or pulley/belt, which transmits the generated force to the housing 1100′. As described above, the housing 1100′ of the adjustment module 1000′ may be moved in the vertical direction by the second driver 1300′, and accordingly, the adjustment module 1000′, i.e., the third and fourth couplers P3, P4 connected to the housing 1100′, may also be moved in the vertical direction. Thus, the adjustment module 1000′ may be configured to move the third and fourth couplers P3, P4 in the vertical direction by movement of the housing 1100′ using the third driver 1300′. Since the housing 1100′ and the couplers P3, P4 are connected to each other and move together and the housing 1100′ corresponds to the main body comprising the majority of the adjustment module 1000′, it may also be described that the adjustment module 1000′ itself is substantially configured to move in the vertical direction together with the couplers P3, P4 for the movement of the third and fourth couplers P3, P4 in the vertical direction. On the other hand, the second driver 1300′ described above may be applied only to the periphery of the third and fourth couplers P3, P4, so that instead of moving the entire housing 1100′, only the periphery of the third and fourth couplers P3, P4 may be moved by such a second driver 1300′.

In such an adjustment module 1000′, when the first driver 1200′ moves the housing 1100′ in the horizontal direction, the housing 1100′, i.e., the third and fourth couplers P3, P4 connected to the adjustment module 1000′, may also be moved in the horizontal direction by a predetermined distance. As a result of this movement, the third and fourth couplers P3, P4 may be offset horizontally with respect to the vertical axis S and their positions are changed, and the directions of the forces applied to the couplers P1, P2 (i.e., the joints J1, J2) by the actuators 10, 20 may also be changed. For example, if the forces fs are oriented to have a predetermined angle a with respect to the vertical axis S by the changed direction, the vertical component forces fg for offsetting or cancelling gravity and the horizontal component forces ft available for movement of the robot may be generated, as shown in FIG. 3B. Further, when the travel distance of the housing 1100′ by the first driver 1200′, i.e., the horizontal translational distance of the couplers P3, P4, is changed, the vertical and horizontal component forces fg, ft may also be appropriately changed. Accordingly, the adjustment module 1000′ may be configured to change the directions of the forces applied to the first and second couplers P1, P2 (i.e., the first and second joints J1, J2) by the first and second actuators 10, 20, thereby convert each force of the actuators 10, 20 into a force that offsets or cancel the gravitational force exerted on the upper limb assist robot (i.e., the vertical component force fg) and a force that acts in the direction intended for the movement of the robot, i.e., the first and second links 1, 2 (i.e., the horizontal component force ft). In other words, the adjustment module 100 may control the actuators 10, 20 to provide the forces in both the anti-gravity direction and the intended direction.

Further, when the second driver 1300′ moves the housing 1100′ in the vertical direction, the third and fourth couplers P3, P4 connected to the housing 1100′, i.e., the adjustment module 1000′, may also be moved in the vertical direction by a predetermined distance, and the first and second distances L1, L2 may be varied. By such changes in the distances L1, L2, the first and second wires 11, 21 may be moved relative to the adjustment module 1000′, and the relative displacement of the ends 11b, 21 b connected to the springs 12, 22 of the wires 11, 21 may thereby be generated. Thus, the springs 12, 22 may be further deformed by this relative movement and displacement, with applying the forces of changed magnitudes to the first and second couplers P1, P2, i.e., the first and second joints J1, J2 through the wires 11, 21. Thus, the adjustment module 1000′ may be configured to change the magnitudes of the forces applied to the first and second couplers P1, P2 (i.e., the first and second joints J1, J2) by the first and second actuators 10, 20, and the operation of the upper limb assist robot may be performed reliably based on the changed magnitude of the force. In other words, the adjustment module 1000′ may further adjust the forces generated by the actuators 10, 20 in accordance with the forces required by the upper limb assist robot depending on the operating environment.

As previously described, in particular for adjusting the directions of the forces of the actuators 10, 20, the adjustment module 1000′ may be configured to control the relative movement and position of the third and fourth couplers P3, P4 with respect to the vertical axis S. Therefore, to facilitate alignment of the couplers P3, P4 with respect to the vertical axis S, the adjustment module 1000′ may be configured to be disposed below the mount 4 including the first joint J1 through which the vertical axis S passes, as shown by the dotted lines in FIG. 5B. In such a case, the adjustment module 1000′ may be disposed underneath or below a table on which the mount 4 is installed. Alternatively, the adjustment module 1000′ may be disposed on a side portion of the mount 4, as shown by the solid line in FIG. 5B. In such a case, the adjustment module 1000′ may be slightly spaced from the vertical axis S, and the actuators 10, 20 connected thereto may also be oriented at a slight angle to the vertical axis S, so that the component forces of the forces generated by the first and second actuators 10, 20 may basically act on the joints J1, J2, and the changes in direction and magnitude as previously described may be performed for these component forces by the adjustment module 1000′. The adjustment module 100 disposed on the side of the mount 4 as such may be placed on or above the table or the ground along with the mount 4.

The adjustment module 1000′ disposed under the mount 4 or on the side portion of the mount 4 may be installed with the first and second drivers 1200′, 1300′ as shown in FIG. 2. Further, for the adjustment module 1000′ disposed under or on the side portion of the mount 4, the third and fourth couplers P3, P4 may be disposed adjacent to each other on the adjustment module 1000′, preferably on or adjacent to the vertical center axis of the adjustment module 1000′, for easy alignment and relative movement about the vertical axis S.

In view of the configuration of the adjustment module 1000′ as described above, the adjustment module 1000′ is an independent driving system that is configured to drive the actuators 10, 20, particularly the couplers P3, P4 thereof, independently of the links 1, 2. Actually, the couplers P3, P4 are movably coupled only to the adjustment module 1000′ with not being constrained to the links 1, 2. Therefore, the adjustment module 1000′ is configured to adjust or change the directions and the magnitudes of the forces provided by the actuators 10, 20, independent of the orientations of the links 1, 2. More specifically, for the adjustment or change of the directions and magnitudes, the adjustment module 1000′ is configured to change the positions of the couplers P3, P4, independent of the positions of the links 1, 2, and for such repositioning, to move the couplers P3, P4, independent of the movements of the links 1, 2.

Further, as both of the couplers P3, P4 are coupled and thus bound to the adjustment module 1000′, these couplers P3, P4 are configured to simultaneously move by the adjustment module 1000′. Accordingly, the adjustment module 1000′ is configured to simultaneously move the couplers P3, P4 in the same direction by the same distance and thereby to dispose the couplers P3, P4 in the same position. For this reason, the adjustment module 1000′ is configured to simultaneously change the directions of the forces in the same direction by the same amount. For the same reasons, the adjustment module 1000′ is configured to simultaneously change the magnitudes of the forces by the same amount.

Consequently, in view of the all these functionalities, the adjustment module 1000′ is configured to simultaneously change the directions and magnitudes of the forces, independent of the links 1, 2. That is, the adjustment module 1000′ is configured to simultaneously adjust the directions and magnitudes of the forces in an active and independent manner to be responsive to the user's intention for movement.

The actuators 10, 20 and adjustment modules 1000′ as described above may implement various modes of the upper limb assist robot configured to properly perform the movement in accordance with the user's intentions. These modes will be described in detail below with reference to FIGS. 6-8.

First, FIG. 6 illustrates a gravity compensation mode of the upper limb assist robot. In such a gravity compensation mode, the adjustment module 1000′ may position the third and fourth couplers P3, P4 on the vertical axis S passing through the first joint J1. By such positioning of the third and fourth couplers P3, P4, as previously described with reference to FIG. 3A, the forces fs of the actuators 10, 20 acts as a countervailing force fg that is oriented substantially along the vertical axis S, y-axis (i.e., in the vertical direction) and in the direction opposite to the direction of gravity, at each of the first and second joints J1, J2. In addition, the forces fs acting on the joints J1, J2 respectively may act on the user's elbow via the first supporter 5 as a combined or resultant force fe, and such resultant force fe may act as the resultant countervailing force fg. As described above, the forces fs of the actuators 10, 20 may be set in advance to be greater than the gravitational force g acting on the upper limb and the upper limb assist robot (at least, the upper arm and the first and second links 1, 2 supporting the upper arm), so that the gravitational force g is completely canceled out by this orientation of couplers P3, P4, and at least the upper limb and the links 1, 2 are not subject to any gravitational force. Thus, the user may move the upper limb assist robot, and more specifically the link assemblies 1, 2 by applying only a small amount of his or her own force, and may stably move the upper limb while being supported by the robot.

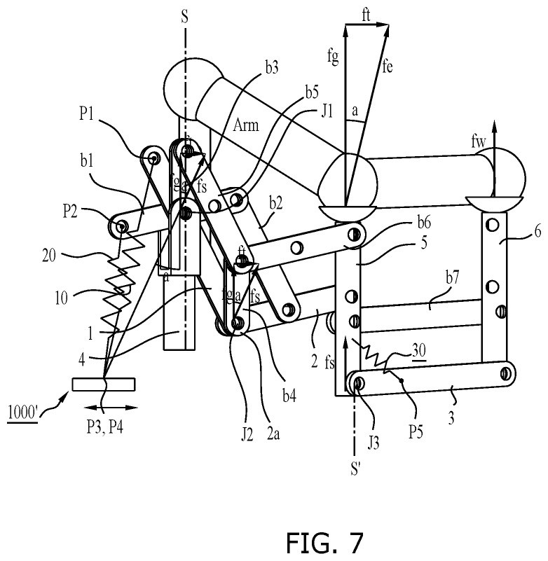

Further, FIG. 7 illustrates a thrust mode of the upper limb assist robot. In such a thrust mode, the adjustment module 1000′ may translate the third and fourth couplers P3, P4 in the horizontal direction to offset these couplers P3, P4 from the vertical axis S. Due to the positioning of these couplers P3, P3, as previously described with reference to FIG. 3B, the directions of the forces fs of the actuators 10, 20 may change such that they are oriented to have the predetermined angle a with respect to the vertical axis S for the joint J1 and the vertical axis for the joint J2, respectively. Thus, at each of the first and second joints J1, J2, the force fs with the changed direction or orientation may generate the vertical component force fg and the horizontal component force ft. In addition, the forces fs acting on the joints J1, J2 may act on the user's elbow through the first supporter 5 as a resultant force fe, and this resultant force fe may likewise generate the vertical component force fg and the horizontal component force ft, corresponding to the sum of the vertical component forces fg and the horizontal component forces ft generated at the joints J1, J2, respectively. Such a summed or combined vertical component forces, i.e., vertical resultant force fg may completely offset or cancel the gravitational force g acting on the upper limb and the upper limb assist robot, more specifically, the upper arm and the links 1, 2, as described above. Furthermore, the summed or combined horizontal component forces, i.e., horizontal resultant force ft may be generated and oriented in a forward direction, as shown. Thus, the upper limb assist robot, more precisely, the link assemblies 1, 2 and other members and devices connected thereto, may be moved forward by such a horizontal resultant force ft, and the user may move the upper limb forward with no use of his or her own strength due to the movement of such assemblies 1, 2.

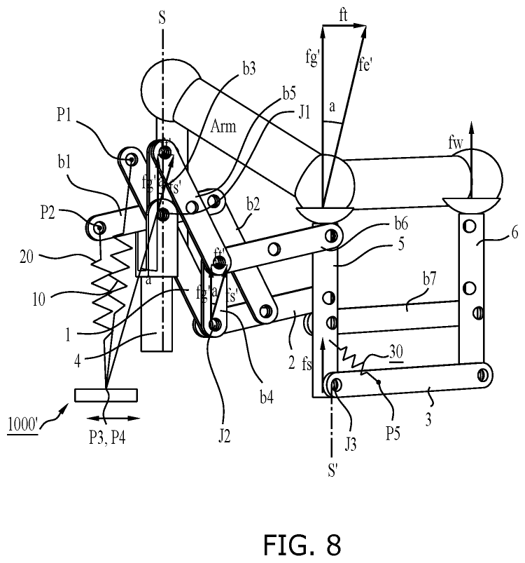

Moreover, FIG. 8 illustrates a thrust enhancement mode. The thrust enhancement mode is a mode for enhancing the thrust generated by the thrust mode described with reference to FIG. 7, and thus essentially includes the operation of the adjustment module 100 and the changes in the directions of the forces accordingly as described in FIG. 7. In such a thrust enhancement mode, the adjustment module 1000′ may change the first and second distances L1, L2 by translating the third and fourth couplers P3, P4 in the vertical direction. As described with reference to FIG. 4B, the actuators 10, 20 may be oriented at a predetermined angle a at the respective joints J1, J2, and generate the increased force fs' by the changed distances L1, L2 and further deformations of the springs 13, 23. Further, similar to the dynamics model of FIG. 7, the increased force fs' acting on the joints J1, J2 may act on the user's elbow via the first supporter 5 as an increased resultant force fe′, and this increased resultant force fe′ may generate an increased vertical resultant force fg′ and an increased horizontal resultant force ft′ for the same reason. This increased horizontal resultant force ft′ may also acts forward, and the increased magnitude of the force ft′ enables the user to smoothly move the upper limb forward even when the operating conditions change. Further, the gravitational force g applied to the upper limb and the upper limb assist robot may be more completely cancelled by the increased vertical resultant force fg′.

Meanwhile, the upper limb of the user includes an upper arm and a forearm connected thereto, and such a forearm also has a substantial size. Accordingly, although movement of the entire upper limb of the user may be substantially accomplished by assisting the movement of the upper arm, it may be desirable to assist the movement of the forearm as well in order to more smoothly move the upper limb. Therefore, in addition to the first and second actuators 10, 20 for assisting the movement of the upper limb described above, as shown in FIGS. 1 and 6-8, the upper limb assist robot may further include a third actuator 30 as a power system or driving system.

As described above, since the third link 3 in the upper limb assist robot is configured to support the forearm and to assist the movement thereof, the third actuator 30 may be configured to exert a force on the third link 3. Further, the movement of the third link 3 may be achieved by a relative rotation of the third link 3 with respect to the third joint J3. For this reason, in order to assist the movement of the third link 3 and thereby assist the movement of the forearm, the third actuator 30 may be configured to apply the force to the third joint J3. As shown in FIGS. 6-8, the force applied on the third joint J3 by the third actuator 30 may ultimately act on the wrist of the upper limb via the third link 3 (and further via the second supporter 6).

Instead of a conventional actuator having a motorized or electric-powered mechanism, the third actuator 30 may be configured to provide the third link 3 with the mechanical force generated by the mechanical element, i.e., the elastic force generated by the deformation and restoration of the elastic member, similar to the first and second actuators 10, 20. In order to appropriately generate and provide the mechanical force to the third joint J3, the third actuator 30 may include a fifth coupler P5 connected to the third link 3. More specifically, the fifth coupler P5 may be physically coupled to the third link 3, so that the force of the third actuator 30 may be applied to the fifth coupler P5 and then transmitted to the third joint J3 via the body of the third link 3 connected to the fifth coupler P5. Such a fifth coupler P5 may be disposed at any portion of the third link 3. For example, as shown in FIGS. 1 and 6-8, the fifth coupler P5 may be disposed adjacent to the third joint J3, i.e., at the fifth end 3a of the third link 3. Further, in order for the third link 3 to move smoothly without being constrained or restricted by the third actuator 30, the third actuator 30 may also be configured to move relative to the third link 3. For this reason, in the third actuator 30, the fifth coupler P5 may be configured to be rotatably or pivotably connected to the third link 3, similar to the first and second couplers P1, P2.

In addition to this basic configuration, as the third actuator 30 is configured to utilize the mechanical force in the same manner as the first and second actuators 10, 20, the actuator 30 may include similar detailed configurations as the first and second actuators 10, 20. For example, similar to the first and second actuators 10, 20 as shown in FIG. 2, the third actuator 30 may include a wire extending from the third link 3 and a spring deformably connected to the wire. More specifically, one end of the wire may be pivotably or rotatably connected to the third link 30, forming the fifth coupler P5. Further, the other end of the wire may be connected to the spring. Such a portion of the wire and the spring may be disposed in a housing of a separate receiving module similar to the previously described adjustment module 1000′. That is, the wire may be coupled to the spring in the receiving module by extending from the third link 3 into the housing of the receiving module, and may transmit the elastic force generated by the deformation of the spring to the third link 3, i.e., to the third joint J3. Further, like the adjustment module 1000′, the receiving module may comprise a pulley configured to maintain a tension of the wire therein. In view of its configuration and function, such a third actuator 30 may be symbolized as a simple elastic member, as illustrated in FIGS. 1 and 6-8. Alternatively, to be consistent with such a symbolization, the third actuator 30 may also comprise only an elastic member, i.e., a spring, which is connected to the third link 3 and also connected to another member providing support for deformation, e.g., the first supporter 5 as shown.

Such a third actuator 30 may be configured to apply the force along a vertical axis S′ passing through the third joint J3 (and thus through the centerline of the first supporter 5) and extending in the direction of gravity. For example, if the third actuator 30 simply comprises only the spring member that extends between the first supporter 5 and the third link 3 while being deformed, as shown, or if the receiving module of the third actuator 30 is aligned with the vertical axis S′ so as to position its coupler coupled to the wire on the vertical axis S′, the force of the third actuator 30 may be exerted along the vertical axis S′. In such a case, the force fs exerted on the third joint J3 by the third actuator 30 may ultimately act as a counteracting force fw on the wrist of the upper limb via the third link 3 (and further via the second supporter 6), as shown in FIGS. 6 to 8. By this counteracting force fw, the gravitational force acting on the forearm and the third link 3 may be completely canceled out, and the user's upper limb and the upper limb assist robot as a whole become completely gravity-free state. Thus, in the gravity compensation mode of FIG. 6, the user may move the upper limb assist robot and the upper limb as a whole more smoothly with only a small amount of effort. Further, in the thrust mode and the thrust compensation mode of FIGS. 7 and 8, by the horizontal resultant force ft and the increased horizontal resultant force ft′, the user may move the upper limb forward without using his/her own force more smoothly while being completely excluded from the influence of gravity.

Meanwhile, when the receiving module of the third actuator 30 is configured to move in the vertical and horizontal directions similarly to the adjustment module 1000′ described above, the direction and magnitude of the force fs of the third actuator 30 may be varied, and the compensation of gravity and the provision of thrust may be performed. The same descriptions of the configuration of the adjustment module 1000′ in FIG. 2, the dynamics model in FIGS. 3A-4B, and the operating modes in FIGS. 6-8 are applied to such a series of operations of the receiving module of the third actuator 30, and no further description will be given hereinafter.

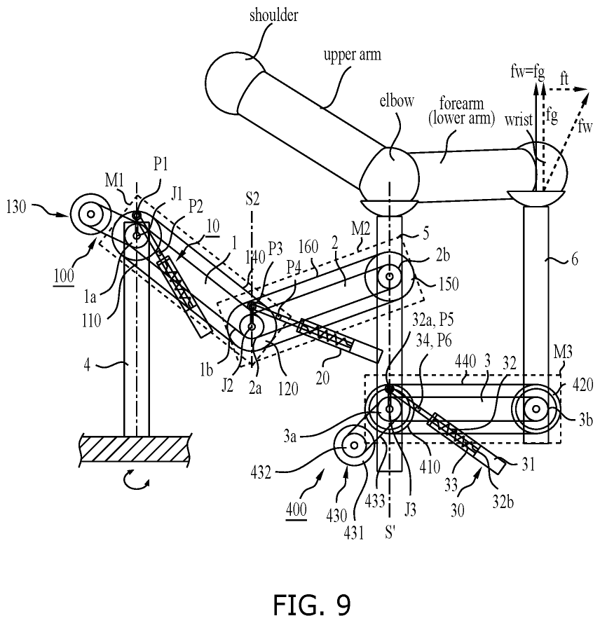

In addition to the first embodiment described above with reference to FIGS. 1-8, the present invention may further include an upper limb assist robot according to a second embodiment, which is a further embodiment configured to assist a user in movement the upper limb, i.e., configured to perform substantially the same operations as the first embodiment. The upper limb assist robot according to the second embodiment may utilize the same technical concepts as the first embodiment for effective and efficient assisting of upper limb movements, but include a different structural configuration than the first embodiment. The upper limb assist robot according to such a second embodiment will be described hereinafter with reference to FIGS. 9-19.

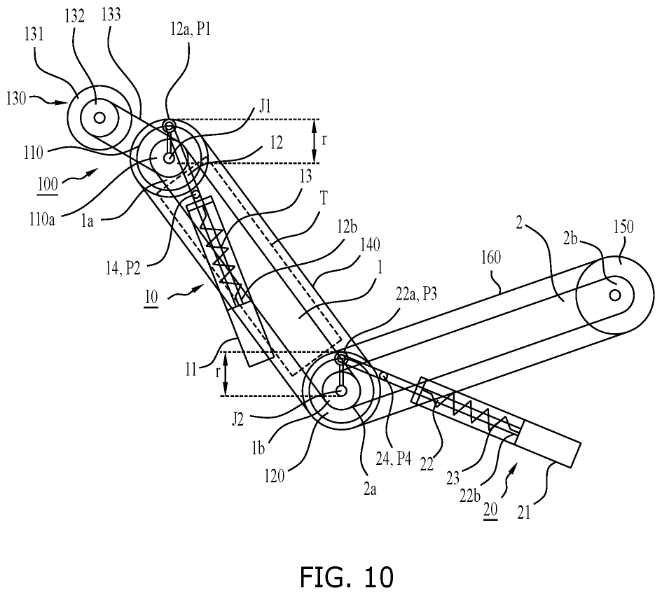

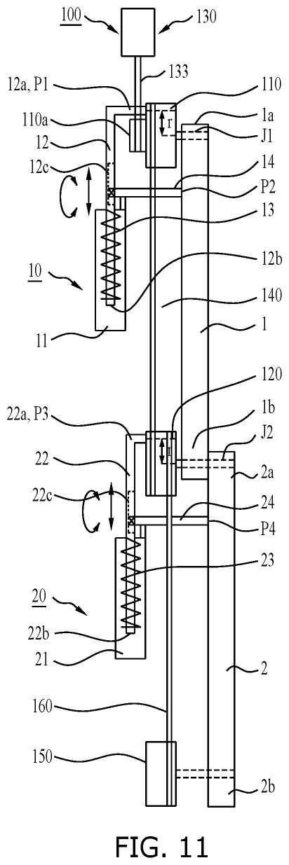

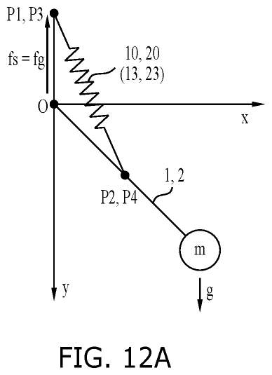

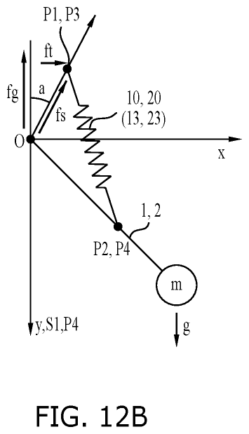

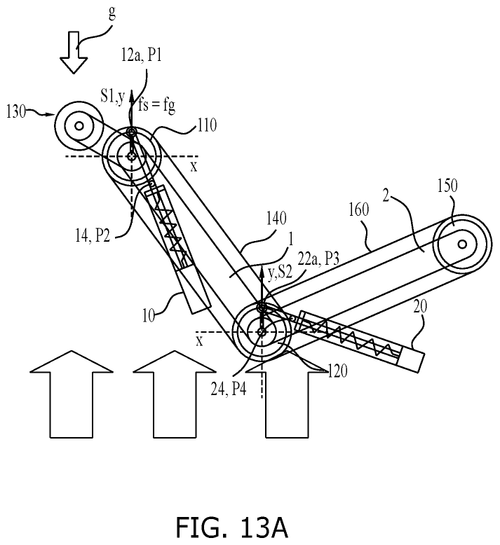

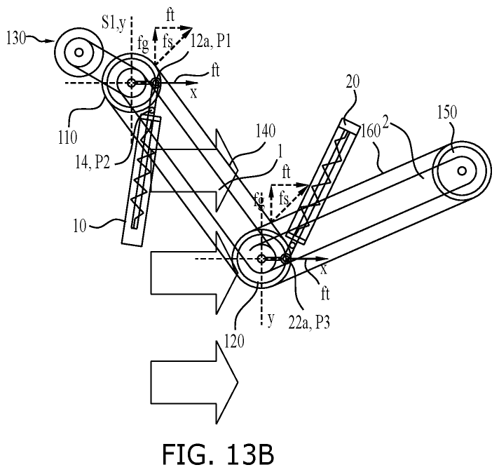

FIG. 9 is a side view illustrating a second embodiment of the upper limb assist robot according to the present invention. FIG. 10 is a side view illustrating an assembly for assisting an upper arm in the upper limb assist robot according to the second embodiment, and FIG. 11 is a front view illustrating the assembly of FIG. 10. Further, FIGS. 12A and 12B are conceptual diagrams illustrating dynamics models related to thrust generation in the upper limb assist robot according to the second embodiment, and FIGS. 13A and 13B are side views illustrating modes of operation of the assembly of FIG. 10. In these drawings, FIG. 9 illustrates a general configuration of the second embodiment of the upper limb assist robot, and FIGS. 10-13B illustrate in detail the configuration and operation of the assembly (i.e., the first and second links 1,2, the first and second actuators 10, 20, and the first adjustment module 100, which will be described later) for assisting the upper arm in the upper limb assist robot according to the second embodiment. Accordingly, with regard to the upper limb assist robot according to the second embodiment, the general overall configuration thereof and the assembly 1, 2, 10, 20, 100 for assisting the upper arm, which is the main part of the upper limb, will be first described in the following with reference to FIG. 9 and FIGS. 10-13B.

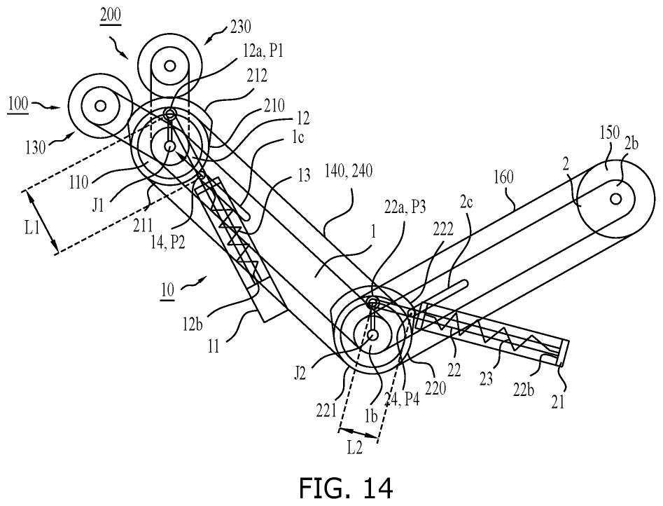

Referring to FIG. 9 first, the upper limb assist robot according to the second embodiment may include a link assembly of links 1, 2 that are configured to provide overall support for the upper arm of the user's arm and are connected to each other to be relatively rotatable or pivotable. Further, the upper limb assist robot may comprise actuators 10, 20 that apply forces to the link assembly 1, 2 to assist the movement of the user's arm, more specifically, the upper arm. Further, as will be described in more detail later, an accessory, i.e., an adjustment module 100, may be installed on the upper limb assist robot to interlock, cooperate, or interact with the actuators 10, 20 for the assistance of the arm movement, and other adjustment modules 200, 300 may also be installed thereto, as shown in FIGS. 14-19. The adjustment modules 100-300 may control the force exerted by the actuators 10, 20 to move the link assembly 1, 2 in accordance with the user's intent, thereby appropriately assisting the movement of the user's arm. In the upper limb, i.e., the arm of a user, the upper arm plays a main role in the movement of the arm, with relatively moving with regard to both the shoulder and the forearm (or lower arm). Thus, by assisting the movement of the upper arm using these devices 1, 2, 10, 20, 100-300, the upper limb assist robot may substantially achieve the assistance of the movement of the upper limb, i.e., the entire arm.

In addition to the above described devices 1, 2, 10, 20, 100-300, the upper limb assist robot may further comprise a third link 3 connected to the link assembly 1, 2 supporting the upper arm and configured to support the forearm, and a third actuator 30 configured to apply a force on the third link 3 to assist the movement of the forearm. Further, the upper limb assist robot may include an auxiliary adjustment module 400 configured to control the force exerted by the third actuator 30 to move the third link 3 in accordance with the user's intent. Thus, the upper limb assist robot may assist the movement of the forearm by further using these devices 3, 30, 400, thereby performing substantial full or overall arm support and movement assistance. Further, the upper limb assist robot may further include a mount 4 and supporters 5, 6 as support members, whereby the more stable support of the upper limb and the upper limb assist robot may be enabled by these support members 4-6.

FIGS. 9-13B illustrate, by way of example, a right unit of the second embodiment of the upper limb assist robot provided on a right arm of the user, and for convenience of description, the configurations of such a right unit will be described below. More specifically, FIG. 9 illustrates the overall configuration of the right unit of the upper limb assist robot, and FIGS. 10-13B illustrate in detail the assembly of such a right unit configured to assist the movement of the upper arm of the right arm. However, the upper limb assist robot according to the second embodiment of the present invention may include a left unit configured identically to the illustrated right unit for assisting the balanced movement of the user's arms. In one example, such left and right units may be provided on the left and right arms of the user, respectively. Thus, though not particularly described in the followings, the upper limb assist robot according to the second embodiment of the present invention may further comprise the left unit configured identically to the illustrated right unit, and the descriptions relating to the right unit provided with reference to FIGS. 9-13B hereinafter are equally applicable to such a left unit. Likewise, although the examples of FIGS. 14-19 herein all relate to the right unit of the upper limb assist robot, and more particularly to the upper arm assist assembly of the right unit, the upper limb assist robot of the present invention may further comprise the left unit including the assembly configured identically to these examples, and the descriptions of these examples equally apply to such a left unit. With this premise, the individual components of the upper limb assist robot according to the second embodiment of the present invention will be described in more detail in the following.

Firstly, as shown in FIG. 9, the upper limb assist robot according to the second embodiment, similar to the first embodiment described above, may include links 1-3, a mount 4, and first and second supporters 5,6 as a basic chassis, frame, or skeleton for supporting the upper arm. The chassis 1-6 of the upper limb assist robot of the second embodiment is substantially the same as the members 1-6 previously described with respect to the first embodiment referring to FIGS. 1-8, and accordingly, the same descriptions for such members given in the first embodiment applies to the second embodiment and further descriptions are omitted herein.

To exert the force for movement of the link assembly 1, 2 supporting the upper arms in the chassis of the upper limb assist robot described above, the upper limb assist robot of the second embodiment may include actuators 10, 20 as a power system or driving system. In such a power system, the actuators 10, 20 correspond to a power generator configured to generate the required force. Further, as the same power system, the upper limb assist robot may include a first adjustment module 100. The first adjustment module 100 corresponds to a power control unit configured to properly adjust the force generated by the actuators 10, 20, which will be described in more detail later following the actuators 10, 20.

As previously described, in the upper limb of a user, the upper arm performs a main function in the movement of the upper limb, while moving relative to both the shoulder and the elbow. Accordingly, the actuators 10, 20 may be configured to apply the forces to the assembly of the first and second links 1, 2 to assist such upper limb movement. Further, the movement of these links 1, 2 is achieved by relative rotation or pivot of the first and second links 1, 2 about the first and second joints J1, J2, as previously described. For this reason, for the movement of the first and second links 1, 2, the upper limb assist robot may comprise first and second actuators 10, 20 configured to apply forces to the first and second joints J1, J2, respectively. As shown in FIGS. 6-8 with respect to the first embodiment, the forces applied to the first and second joints J1, J2 by the first and second actuators 10, 20 act as the combined or resultant force on the elbow of the upper limb via the first and second links 1, 2.

Conventional actuators applied to upper limb assist robots have a motorized or electric-powered mechanism that utilizes electricity to generate the required force. In contrast to such conventional actuators, like the first embodiment, the first and second actuators 10, 20 of the second embodiment are configured to provide the required forces to the upper limb assist robot using only mechanical forces generated by the mechanical elements without the aid of electricity. For example, as will be described later, the first and second actuators 10, 20 may generate and provide to the first and second links 1,2, the elastic force of the mechanical element, more specifically, the tension or elastic force due to the deformation and restoration of the elastic member. Further, the conventional electric actuator is configured to be coupled directly to the axis or shaft of the joint and to exert the torque directly to the axis or shaft of the joint. In contrast, as the first and second actuators 10, 20 utilize forces generated from the deformation of the mechanical element, these actuators 10, 20 require a space for such deformation, and may therefore not be directly coupled to the axis of joint but may be spaced apart from the joint.

As a result of this structural difference from conventional electric actuators, the first actuator 10 may include a first coupler or connector P1 connected to the first joint J1 to appropriately generate and provide the mechanical force to the first joint J1. Further, to provide support for the deformation and restoration of the mechanical element (i.e., the elastic member), the first actuator 10 may include a second coupler P2 connected to any other members or devices spaced apart from the first coupler P1, e.g., the first link 1. More specifically, the first coupler P1 may be connected to the first joint J1 by being coupled to any intermediate member provided to the first joint J1 (e.g., a first pulley 110 of the first adjustment module 100) instead of being directly coupled to the first joint J1, as will be described later. The first actuator 10 may, as will be described later, first apply the force generated directly to the first coupler P1, and then the applied force may be transmitted to the first joint J1 via the intermediate member (e.g., the first pulley 110). Further, the second coupler P2 may be connected to the second link 2 and any other members instead of the first link 1, provided that support for deformation of the mechanical element is allowed.

Similarly to such a first actuator 10, the second actuator 20 may comprise a third coupler P3 connected to the second joint J2. Further, to provide support for the deformation and restoration of the mechanical element (i.e., the elastic member), the second actuator 20 may include a fourth coupler P4 connected to any other members or devices spaced apart from the third coupler P3, e.g., the second link 2. More specifically, instead of being coupled directly to the second joint J2, the third coupler P3 may be coupled to the second joint J2 by being coupled to any intermediate member provided to the second joint J2, such as a second pulley 120 of the first adjustment module 100, as will be described later. The second actuator 20 may first apply the generated force directly to the third coupler P3, as will be described later, and then the applied force may be transmitted to the second joint J2 via the intermediate member (e.g., the second pulley 120). Further, the fourth coupler P4 may be connected to any other adjacent members instead of the second link 2, provided that support for the deformation of the mechanical element is available.

Meanwhile, since the first and second actuators 10, 20 are connected to the first and second links 1, 2 by the first to fourth couplers P1-P4, for smooth movement of the links 1, 2, it may be required that the first and second actuators 10, 20 are also configured to move relative to the links 1, 2. For this reason, in the first actuator 10, the first coupler P1 may be rotatably or pivotably connected to the first joint J1 and the second coupler P2 may be configured to be rotatably or pivotably connected to the first link 1. Likewise, in the second actuator 20, the third coupler P3 may be configured to be rotatably or pivotably connected to the second joint J2, and the fourth coupler P4 may be rotatably or pivotably connected to the second link 2.

In addition to these basic configurations, detailed configurations of the first and second actuators 10, 20 will be described in more detail with reference to FIGS. 10 and 11.

Firstly, the first actuator 10 may include a first cylinder 11 provided on the first link 1. The first cylinder 11 may form an inner space with a predetermined size. The first cylinder 11 may receive a first spring 13 within the inner space, and may protect the first spring 13 during operation of first spring 13, i.e., during the deformation and restoration.

Further, the first actuator 10 may include a first connecting rod 12 extending from the first cylinder 11 to the first joint J1. The first connecting rod 12 may connect a first spring 13 and the first cylinder 11 receiving the first spring 12 with the first joint J1, and may thereby serve to transmit force generated by the deformation of the first spring 13 to the first coupler P1, i.e., to the first joint J1. In more detail, the first connecting rod 12 may include a body elongating in the longitudinal direction and first and second ends 12a, 12b corresponding to two ends of the body. The first end 12a of such a connecting rod 12 is disposed adjacent to the first joint J1 and is rotatably or pivotably connected to the first joint J1, for example by the hinge structure or shaft. As will be described later, instead of being directly coupled to the first joint J1, the first end 12a is rotatably or pivotably coupled to the intermediate member provided at the first joint J1 (e.g., the first pulley 110 of the first adjustment module 100), and may thereby be substantially rotatably or pivotably coupled to the first joint J1 as well. Due to this configuration, the first end 12a (i.e., the hinge shaft thereof) may substantially form the first coupler P1 rotatably or pivotably connected to the first joint J1 as described above. Such a first coupler P1 may be configured to revolve or turn about or around the first joint J1 or a center thereof, as will be described later. Meanwhile, the first connecting rod 12 may extend into the first cylinder 11, as shown, such that the second end 12b may be disposed within the first cylinder 11. Further, the first connecting rod 12 may be configured to be movable relative to the first cylinder 11 with being coupled to the first spring 13. In particular, linear motion or movement of the first connecting rod 12 may cause the second end 12b to move within the first cylinder 11 and deform the first spring 13.

Further, the first actuator 10 may include the first spring 13 accommodated within the first cylinder 11, as previously described. One end of the first spring 13 may be coupled to a portion of the cylinder 11, and the other end may be coupled to a second end 12b of the first connecting rod 12. Thus, the movement of the first connecting rod 12 relative to the first cylinder 11, i.e., movement of the second end 12b, may cause the first spring 13 to deform and generate the force intended to move the first link 1. Such a first spring 13 may comprise, for example, a zero-free length spring so as to exactly generate the intended force. Such a first spring 13 of the zero-free length spring may be configured to be deformable using a wire instead of the first connecting rod 12.

Moreover, the first actuator 10 may include a first hinge shaft 14 that is installed on the first link 1 and is coupled to the first connecting rod 12. More specifically, the first hinge shaft 14 may extend from the first link 1 and engage at a predetermined location of a middle portion of the first connecting rod 12. As described above, the first connecting rod 12 is configured to perform a linear reciprocating motion with respect to the first cylinder 11 in order to deform the first spring 12. At the same time, since the first connecting rod 12 is constrained or bound to the first link 1 by the first end 12a and the first hinge shaft 14, the rod 12 is required to rotate likewise so as not to interfere with the relative rotation of the first and second links 1, 2. For these reasons, the first hinge shaft 14 may be configured to permit both rotational and linear motion of the first connecting rod 12. For example, the first connecting rod 12 may comprise a rail 12c extending along a longitudinal direction thereof, and the first hinge shaft 14, precisely the end engaging with the first connecting rod 12, may include a bracket guided by the rail 12c to guide the linear motion. Further, the end of the first hinge shaft 14 that engages with the first connecting rod 12 may comprise a bearing that enables and supports rotational movement thereof within the rail 12c. Thus, the first connecting rod 12 may perform linear and rotational movements with respect to the first hinge shaft 14 and/or the first link 1, and may perform its intended operation while not interfering with the movement of the first and second links 1, 2. Further, since the first hinge shaft 14 is also coupled to the first link 1, the first hinge shaft 14 may be configured to be rotatable with respect to the first link 1, instead of being immovably fixed to the first link 1, so as not to interfere with the rotational movement of the first link 1 at least. In such a case, even though the first hinge shaft 14 and the first connecting rod 12 are configured not to be rotatable with respect to each other, these members 12, 14 may be rotatable or pivotable with respect to the first and second links 1, 2, and may also be rotatable together with the first and second links 1, 2. Therefore, in view of this configuration of the first hinge shaft 14, the first hinge shaft 14 may substantially function as the second coupler P2 that rotatably or pivotably couples the first actuator 10 to the first link 1. Further, as well shown in FIG. 11, the first cylinder 11 may be coupled to the first hinge shaft 14 coupled to the first link 1, and thus, the first cylinder 11 and on end of the first spring 13 secured thereto may maintain a fixed position on the first link 1 relative to the moving first connecting rod 12. Accordingly, the first spring 13 may be deformed by the second end 12b of the moving first connecting rod 12, while being fixed on the first link 1 by the first cylinder 11 and the first hinge shaft 14.

In such a first actuator 10, when the first connecting rod 12 is linearly moved relative to the first cylinder 11 by a separate drive mechanism (e.g., the first pulley 110 of the first adjustment module 100 as described later), such movement may be reliably guided by the first hinge shaft 14 as described above. Further, the movement of the first connecting rod 12 causes the second end 12b of the first connecting rod 12 to move within the cylinder 11 together with the other end of the first spring 13, and the deformation may occur in the first spring 13 relative to the one end of the first spring 13 fixed to the first cylinder 11. This deformation generates the mechanical force, which may be applied to the first coupler P1 via the first connecting rod 12. Subsequently, the force applied to the first coupler P1 may be transmitted to the first joint J1 connected thereto. Further, by adjusting the amount of movement of the first connecting rod 12, i.e., the second end 12b, the amount of deformation of the first spring 13 and the magnitude of the generated force may also be adjusted. Therefore, when the force of the first actuator 10 is transmitted to the first joint J1 as such, the first link 1 may be moved by the transmitted force, and the direction of the transmitted force may determine the direction of movement of the second link 1.

Further, the second actuator 20 may include a similar configuration to the first actuator 10 described above. Firstly, the second actuator 20 may include a second cylinder 21 provided on the second link 2. The second cylinder 21 may include a predetermined sized space formed therein. The second cylinder 21 may receive a second spring 23 within the formed inner space, and may protect the second spring 23 during operation of the second spring 23, i.e., during the deformation and restoration.

Further, the second actuator 20 may include a second connecting rod 22 extending from the second cylinder 21 to the second joint J2. The second connecting rod 22 may connect the second spring 23 and the second cylinder 21 housing the second spring 23 to the second joint J2, and may thereby serve to transmit the force generated by the deformation of the second spring 23 to the third coupler P3, i.e., to the second joint J2. In more detail, the second connecting rod 22 may include a body elongating in the longitudinal direction and third and fourth ends 22a, 22b corresponding to two ends of the body. The third end 22a of such a second connecting rod 22 may be disposed adjacent to the second joint J2 and may rotatably or pivotably connected to the second joint J2, for example by a hinge structure or shaft. As will be described later, instead of being directly coupled to the second joint J2, the third end 22a may be rotatably or pivotably coupled to any intermediate member provided at the second joint J2 (e.g., the second pulley 120 of the first adjustment module 100), and may thereby be substantially rotatably or pivotably coupled to the second joint J2 as well. Due to this configuration, the third end 22a (i.e., the hinge shaft thereof) may substantially form the third coupler P3 rotatably or pivotably connected to the second joint J2 as described above. Such a third coupler P3 may be configured to revolve or turn about or around the second joint J2 or a center thereof, as will be described later. Meanwhile, the second connecting rod 22 may extend into the second cylinder 21, as shown, such that the fourth end 22b may be disposed within the second cylinder 21. Further, the second connecting rod 22 may be configured to be movable relative to the second cylinder 21 with being coupled to the second spring 23. In particular, linear motion of the second connecting rod 22 may cause the fourth end 22b to move within the second cylinder 21 and to deform the second spring 23.

Further, the second actuator 20 may include the second spring 23 accommodated within the second cylinder 21, as previously described. One end of the second spring 23 may be coupled to a portion of the cylinder 21, and the other end thereof may be coupled to the fourth end 22b of the second connecting rod 22. Thus, the movement of the second connecting rod 22 relative to the second cylinder 21, i.e., movement of the fourth end 22b, may cause the second spring 23 to deform and generate the intended force to move the second link 2. Such a second spring 23 may comprise, for example, a zero-free length spring so as to exactly generate the intended force. Such a second spring 23 of the zero-free length spring may be configured to be deformable using a wire instead of the second connecting rod 22.

Moreover, the second actuator 20 may include a second hinge shaft 24 that is installed on the second link 2 and engages with the second connecting rod 22. More specifically, the second hinge shaft 24 may extend from the second link 2 and engage with a predetermined location at a middle portion of the second connecting rod 22. As described above, the second connecting rod 22 is configured to perform the linear reciprocating motion with respect to the second cylinder 21 in order to deform the second spring 23. At the same time, since the second connecting rod 22 is constrained or bound to the second link 2 by the third end 22a and the second hinge shaft 24, the rod 22 is required to rotate or pivot likewise for the smooth rotation or pivot of the second link 2. For these reasons, the second hinge shaft 24 may be configured to permit both rotational and linear motion of the second connecting rod 22. For example, the second connecting rod 22 may include a rail 22c extending along a longitudinal direction thereof, and the second hinge shaft 24, precisely the end that engages with the second connecting rod 22, may comprise a bracket guided by the rail 22c to guide the linear motion. Furthermore, the end of the second hinge shaft 24 that engages with the second connecting rod 22 may comprise a bearing that enables and supports rotational movement thereof within the rail 22c. Thus, the second connecting rod 22 may perform the linear and rotational motions with respect to the second hinge shaft 24 and/or the second link 2, and may perform its intended operation while not interfering with the movement of the first and second links 1,2. Further, since the second hinge shaft 24 is also coupled to the second link 2, the second hinge shaft 24 may also be configured to be rotatable or pivotable with respect to the second link 2 instead of being immovably fixed to the second link 2, in order not to interfere with the rotational movement of the second link 2, at least. In such a case, even if the second hinge shaft 24 and the second connecting rod 22 are configured to be not rotatable or pivotable with respect to each other, these members 22, 24 may be rotatable or pivotable with respect to the first and second link 1, 2 and may also rotate or pivot smoothly together with the first and second links 1, 2. Thus, in view of this configuration of the second hinge shaft 24, the second hinge shaft 24 may substantially function as the fourth coupler P4 that couples the second actuator 20 rotatably or pivotably to the second link 2. Further, as well shown in FIG. 11, the second cylinder 21 may be coupled to the second hinge shaft 24 coupled to the second link 2, and thus the second cylinder 21 and one end of the second spring 23 secured thereto may maintain a fixed position on the second link 2 relative to the moving second connecting rod 22. Therefore, the second spring 23 may be deformed by the fourth end 22b of the moving second connecting rod 22, while being fixed on the second link 2 by the second cylinder 21 and the second hinge shaft 24.

In such a second actuator 20, when the second connecting rod 22 is linearly moved relative to the second cylinder 21 by a separate drive mechanism (e.g., the second pulley 120 of the first adjustment module 100, which will be described later), such movement may be reliably guided by the second hinge shaft 24 as described above. Further, the movement of the second connecting rod 22 causes the fourth end 22b of the second connecting rod 12 to move within the cylinder 21 together with the other end of the second spring 23 connected thereto, and the deformation may occur in the second spring 23 relative to the one end of the second spring 23 fixed to the second cylinder 21. This deformation generates the mechanical force, which may be applied firstly to the third coupler P3 via the second connecting rod 22. Subsequently, the force applied to the third coupler P3 may be transmitted to the second joint J2 connected thereto. Further, by adjusting the amount of movement of the second connecting rod 22, i.e., the fourth end 22b, the amount of deformation of the second spring 23 and the magnitude of the generated force may also be adjusted. Accordingly, when the force of the second actuator 10 is transmitted to the second joint J2 in this manner, the second link 2 may be moved by the transmitted force, and the direction of the transmitted force may determine the direction of movement of the second link 2.

In order for the upper limb assist robot according to the second embodiment of the present invention as described above, to be optimally designed to move the links 1, 2 using only the force of the actuators 10, 20, it is required to review the model of dynamics. Accordingly, the upper limb assist robot, namely the link assemblies 1, 2 and the actuators 10,20 thereof, is shown in FIGS. 12A and 12B as the dynamics models.

Referring to FIGS. 12A and 12B, the link assembly 1, 2 and the actuators 10, 20 are shown simplified in a two-dimensional coordinate system comprising an x-axis and a y-axis. The y-axis is set along the direction of gravity, i.e., the direction perpendicular to the ground (the vertical direction), and the x-axis is set along the direction perpendicular to the direction of gravity, i.e., the direction parallel to the ground (the horizontal direction). More specifically, for example, the y-axis may represent vertical axes S1, S2 extending in the direction of gravity through the first and second joints J1, J2, respectively, and the x-axis may represent horizontal axes extending perpendicular to such vertical axes S1, S2. Therefore, the operation of models in FIGS. 12A and 12B are described referring to the single y-axis or x-axis for simplicity, but are actually performed on the axes set of the joins J1, J2, respectively.

Within such a coordinate system, the link assembly 1, 2 are shown as bar members of a predetermined length, and a gravitational force g is acted on the link assembly 1, 2 by a mass M of the upper limb assist robot and the user. Further, the first and second actuators 10, 20 are shown in the form of first and second springs 13, 23 that actually generate mechanical forces. Moreover, as the second and fourth couplers P2, P4 of the first and second actuators 10, 20 are directly coupled to the first and second links 1, 2, these couplers P2, P4 are shown to be connected to the first and second links 1, 2. In contrast, since the first and third couplers P1, P3 of the first and second actuators 10, 20 are connected to, but not directly coupled to the first and second links 1, 2 as described above, these couplers P1, P3 are therefore shown spaced apart from the first and second links 1, 2. In FIGS. 12A and 12B, the links 1, 2, the actuators 10, 20 the couplers P1, P3, the couplers P2, P4 and the forces fs, fg, ft are shown as a corresponding single element, respectively for simplicity and better understanding.

In such a FIG. 12A, the first and third couplers P1, P3 on which the forces fs of the actuators 10, 20 are first applied may be disposed on the vertical axes (y-axes) S1, S2, respectively. In such a case, the forces fs of the actuators 10, 20 act on the first and second joints J1, J2 as counteracting (or cancelling) forces fg that acts in a direction opposite to the direction of gravity generally along the vertical axes (y-axes) S1, S2 (i.e., in the vertical directions), and thus may offset or cancel the gravitational force g exerted on the upper limb assist robot and the upper limb of the user (at least the upper arm and the first and second links 1, 2).

Meanwhile, as shown in FIG. 12B, when the positions or locations of the first and third couplers P1, P3 are changed, the directions of the forces fs applied to the first and third couplers P1, P3 (i.e., the first and second joints J1, J2) may be changed by such changes in position. Particularly, the positions of the couplers P1, P3 may be changed by moving the couplers P1, P3. More specifically, as shown in FIG. 12B, for such movement and repositioning, the first and third couplers P1, P3 may be offset by a predetermined distance or spaced apart by a predetermined distance from the vertical axes (y-axes) S1, S2. Further, for such offsetting and spacing, the first and third couplers P1, P3 may be pivoted or turned about or around the first and second joints J1, J2 from the vertical axes (y-axes) S1, S2 by a predetermined angle a. Such movement and repositioning may cause the first and third couplers P1, P3 to be moved to or disposed in positions different from original positions, relative to the second and fourth couplers P2, P4 (or the first and second links 1, 2). On the other hand, such shifting and repositioning may correspond to relative shifting and repositioning of the first and third couplers P1, P3 with respect to the upper limb assist robot, specifically with respect to the vertical axes (y-axes) S1, S2, which are set at the first and second joints J1, J2, respectively.

As such, when the positions of the first and third couplers P1, P3 are changed to be offset from the vertical axis (y-axis) S1, S2, as well shown in FIG. 12B, the forces fs applied to these couplers P1,P3, i.e. to the first and second joints J1, J2, by the actuators 10, 20 are oriented to have a predetermined angle a with respect to the vertical axes (y-axes) S1, S2, i.e., the vertical directions, such that a vertical component force fg and a horizontal component force ft may be generated at each of the first and second joints J1, J2. Here, the vertical component force fg is a counteracting (or offsetting) force that acts against (or opposite to) the direction of gravity to offset or cancel the gravitational force g exerted on the upper limb of the user and the upper limb assist robot (at least, the upper arm and the first and second links 1, 2), while the horizontal component force ft acts as an additional force, i.e., a thrust, on the upper limb assist robot and the upper limb of the user. Further, the forces fs of the actuators 10, 20 may be preset such that the vertical component forces fg generated therefrom completely cancel or offset the gravitational force g. In such a case, each generated horizontal component force ft corresponds to a component force acting in the direction intended by the design, i.e., a kind of thrust, which may move the lower limb assist robot and the upper limb of the user (more specifically, the upper arm and the first and second links 1, 2) without any force being applied by the user. Thus, by changing the directions of the forces by changing the positions of the first and third couplers P1, P3, the forces of the actuators 10,20 may be utilized to generate the forces acting in the intended direction while offsetting or canceling the applied gravity.

Furthermore, when the first and third couplers P1, P3 are moved to different positions, for example, when the offset distance or angle a with respect to the vertical axes (y-axes) S1, S2 are changed, the magnitudes of the vertical and horizontal component forces fg, ft may also be changed. In particular, by changing the horizontal component force ft, the magnitude of the thrust applied to the upper limb assist robot, i.e., the first and second links 2, may also be adjusted to correspond to the magnitude of the force actually required. Therefore, in order to change the offset distance or the angle a with respect to these vertical axes (y-axes) S1, S2, the first and third couplers P1, P3 may be pivoted or turned by different angles about or around predetermined centers O, for example the first and second joints J1, J2, or the centers thereof. By such a revolution or turning, the offset distance or angle a and the horizontal component forces ft may be adjusted according to the required force, and the motion control of the upper limb assist robot may be conducted smoothly.

Such repositioning of the first and third couplers P1, P3 may be practically accomplished by various mechanisms. Among such mechanisms, as one example, the upper limb adjustment robot according to the second embodiment may include a first adjustment module 100 employing a pulley mechanism driven by a predetermined driving device. Such a first adjustment module 100 may utilize a simple mechanical element such as a pulley to revolve or turn the first and third couplers P1, P3 for position change, thereby making the structure of the upper limb assist robot light and compact while performing the intended function. Such a first adjustment module 100 will be described in detail below with reference back to FIGS. 10-12B.

Firstly, the first adjustment module 100 may include a first pulley 110 rotatably installed at the first joint J1. The first pulley 110 may be installed concentrically with the first joint J1 for stable force transmission to the first joint J1, and thus the first pulley 110 may share a hinge shaft or hinge pin with the first joint J1 and may be rotatably installed on such a hinge shaft of the first joint J1. Further, the first pulley 110 may be coupled to the first actuator 10, more specifically to the first end 12a of the connecting rod 12 thereof. That is, the first coupler P1 of the first actuator 10 may be rotatably or pivotably hinge-coupled to the first pulley 110. Thus, by being coupled to the first pulley 110, the first coupler P1 may form a rotatable or pivotable engagement with the first joint J1 coupled to the first pulley 110. Further, the force of the first actuator 10 may be applied to the first joint J1 via such first coupler P1 and the first pulley 110. More specifically, the first coupler P1 (i.e., the first end 12a) is rotatably or pivotably connected to an outer circumference or periphery of the first pulley 110. In other words, the first coupler P1 is spaced from the first joint J1 and/or the center of the first pulley 110 by an arm length or a radius r, such that the first coupler P1 may turn, i.e., revolve around the center (or first joint J1) when the first pulley 110 is rotated. In the first actuator 10, the second end 12b of the first connecting rod 12 is configured to always cause at least a predetermined deformation in the first spring 13, such that a predetermined force may always be applied to the first coupler P1, i.e., to the first joint J1, from the first actuator 10. Further, when the first pulley 110 rotates, the connecting rod 12 may perform the linear motion while revolving with the radius r, and, as previously described with respect to the first actuator 10, the amount of deformation of the first spring 13 and the magnitude of the force generated may be varied by further movement of the second end 12b. In this way, the amount of movement of the connecting rod 12 (i.e., the second end 12b) and the amount of deformation of the first spring 13 may be appropriately designed and controlled according to the magnitude of the force required in the motion control of the upper limb assist robot.

Further, the first adjustment module 100 may include a second pulley 120 rotatably installed at the second joint J2. The second pulley 120 may be installed concentrically with the second joint J2 for stable force transmission to the second joint J2, such that the second pulley 120 shares a hinge shaft or hinge pin with the second joint J2 and may be rotatably installed on such a hinge shaft or pin of the second joint J2. Further, the second pulley 120 may be coupled to the second actuator 20, more specifically to the third end 22a of the connecting rod 22 thereof. That is, the third coupler P3 of the second actuator 20 may be rotatably or pivotably hinge-coupled to the second pulley 120. Thus, due to the coupling to the second pulley 120, the third coupler P3 may form a rotatable engagement with the second joint J2, which is coupled to the second pulley 120. Further, the force of the second actuator 20 may be applied to the second joint J2 via such third coupler P3 and the second pulley 120. More specifically, the third coupler P3 (i.e., the third end 22a) is rotatably or pivotably connected to an outer circumference or periphery of the second pulley 120. That is, the third coupler P3 is spaced from the second joint J2 and/or the center of the second pulley 120 by an arm length or a radius r, such that the third coupler P3 may turn, i.e., revolve around the center (or second joint J2) when the second pulley 110 is rotated. In the second actuator 20, the fourth end 22b is configured to always cause at least a predetermined deformation in the second spring 23, so that a predetermined force may always be applied to the third coupler P3, i.e., to the second joint J2, from the second actuator 20. Further, when the second pulley 120 rotates, the second connecting rod 22 may linearly move while revolving with spaced by the radius r from the second joint J2, and, as previously described with respect to the second actuator 20, the amount of deformation of the second spring 23 and the magnitude of the generated force may be varied by further movement of the fourth end 22b. As such, the amount of movement of the second connecting rod 22 (i.e., the fourth end 22b) and the amount of deformation of the second spring 23 may be appropriately designed and controlled depending on the magnitude of the force required in the motion control of the upper limb assist robot.

In addition, the first adjustment module 100 may include a first driver 130 configured to rotate the first and second pulleys 110, 120. In one example, the first driver 130 may include a power unit 131 configured to provide power, such as a motor, and a drive pulley 132 coupled to the power unit 131 and configured to rotate (see FIG. 10). Further, the first driver 130 may include an auxiliary pulley 110a provided to the first pulley 110 and a drive belt 133 wound on the drive pulley 132 and the auxiliary pulley 110a. Alternatively, the auxiliary pulley 110a may be provided on the second pulley 120 instead of the first pulley 110. Rotation of the drive pulley 132 by the power unit 131 may cause rotation of the auxiliary pulley 110a by the drive belt 133, which may cause rotation of the first pulley 110 (or the second pulley 120). Further, the first and second pulleys 110, 120 are coupled to transmit power to each other by a first synchronizer 140, which will be described later, such that when either of the first and second pulleys 110, 120 is rotated by the first driver 130, the other one may also rotate together. Thus, the first driver 130 may be configured to provide the power to the first and second pulleys 110, 120 and to rotate these pulleys 110, 120. Further, the first driver 130 may be configured to revolve or turn the first and third couplers P1, P3 about the first and second joints J1, J2 by rotating the first and second pulleys 110, 120. Such a first driver 130 may comprise, in addition to the described pulley mechanism, a motor/gear train connected thereto or a number of other drive mechanisms.

Meanwhile, as previously described, in order to move the upper limb assist robot, the first and second actuators 10, 20 are essentially configured to exert the forces on the first and second links 2, i.e., the first and second joints J1, J2 thereof, corresponding to the upper arms that primarily perform the movement of the upper limb. If the forces are applied to the first and second joints J1, J2 with a time difference, the first and second links 1, 2, and furthermore the entire upper limb assist robot, may be unstably moved due to an unbalance of the applied forces. Therefore, for stable movement of the upper limb assist robot, i.e., stable movement of the first and second links 1, 2, the first and second actuators 10, 20 need to simultaneously apply forces of a constant (or same) magnitude to the first and second links 1, 2. Also, for the same reason, when the directions of the forces applied by these actuators 10, 20 are changed, it is necessary that the directions of the forces are also changed in the same direction for stable movement. As described above, the directions of the forces of the actuators 10, 20 may be determined by the positions of the first and third couplers P1, P3, and such positions may be determined by the travel (or moving) distance and the direction of travel (or movement) of the couplers P1, P3. Accordingly, the first adjustment module 100 may include the first synchronizer 140 configured to simultaneously move the first and third couplers P1, P3 in the same direction and by the same distance. Various mechanisms may be employed or adopted for such a first synchronizer 140, and as previously described, since the first adjustment module 100 uses pulleys 110, 120, a belt configured to be wound around these pulleys 110, 120 may be used. Such a belt as the first synchronizer 140 may rotate along with the first and second pulleys 110, 120 to link these pulleys 110, 120 to transmit power to each other, thereby enabling synchronized rotation of the pulleys 110, 120. Alternatively, a gear train T may be disposed between and engaging with the first and second pulleys 110, 120 instead of the belt, as shown by the dotted line in FIG. 10, and other transmission mechanisms may be used as the first synchronizer 140. When one of the pulleys, for example, the first pulley 110 is rotated by the driver 130, such a first synchronizer 140 may simultaneously rotate the second pulley 120. Further, such rotations of the first and second pulleys 110, 120 may be simultaneously performed in the same direction and at the same rotating angle. By such rotations of the same direction and same angle, the first and third couplers P1, P3 may be simultaneously disposed in the same relative position (specifically, the same position relative to the vertical direction or axis), and the directions of the forces applied by the actuators 10, 20 may be simultaneously changed in the same direction. By including such a first synchronizer 140, the first adjustment module 100 may be configured to simultaneously move the first and third couplers P1, P3 in the same direction and by the same distance.

In such a first adjustment module 100, when the first driver 130 and the first synchronizer 140 simultaneously rotate the first and second pulleys 110, 120 in the same direction and at the same angle, the first and third couplers P1, P3 are revolved by the same angle in the same direction about a predetermined center or origin O, such as the first and second joints J1, J2. By such revolutions, the positions of the first and third couplers P1, P3 are changed to form equal distances, i.e., to located at the same position with respect to the vertical axes S1, S2, and the directions of the forces applied to the couplers P1, P3 (i.e., the joints J1, J2) by the actuators 10, 20 may be equally changed. For example, if the forces are oriented to have the predetermined angle a with respect to the vertical axes by the changed directions, the vertical component forces fg for offsetting or canceling gravity and the horizontal component forces ft available for the movement of the robot may be generated, as shown in FIG. 12B. Further, when the angle a changes according to the rotations of the first and second pulleys 110, 120, the vertical and horizontal component forces fg, ft may also change properly. Accordingly, the first adjustment module 100 is configured to change the directions of the forces applied to the first and third couplers P1, P3 (i.e., the first and second joints J1, J2) by the first and second actuators 10, 20, and thus the forces of the actuators 10, 20 may be converted into the forces that offset or counteract the gravity exerted on the upper limb assist robot (i.e., the vertical component forces fg) and the forces that act in the intended direction for the movement of the robot, i.e., the first and second links 1, 2 (i.e., the horizontal component forces ft). On the other hand, in the first adjustment module 100, the first driver 130 may revolve the first and third couplers P1, P3 with respect to the first and second joints J1, J2 and then dispose the couplers P1, P3 on the vertical axes S1, S2 by simultaneously rotating the first and second pulleys 110, 120 in the same direction and at the same angle along with the first synchronizer 140. In such a case, as previously described with reference to FIG. 12A, the forces of the first and second actuators 10, 20 may both act as offsetting or counteracting forces fg acting along the vertical axes S1, S2, and may offset or cancel the gravitational force acting on the upper limb assist robot and the upper limb. Accordingly, the first adjustment module 100 may control the actuators 10, 20 to provide the forces in both the anti-gravity direction and the intended direction.

In view of the configuration of the first adjustment module 100 as described above, the first adjustment module 100 is an independent driving system that is configured to drive the actuators 10, 20, particularly the couplers P1, P3 thereof, independently of the links 1, 2. Actually, the couplers P1, P3 are movably coupled only to the first adjustment module 100 with not being constrained to the links 1, 2. Therefore, the first adjustment module 100 is configured to adjust or change the directions of the forces provided by the actuators 10, 20, independent of the orientations of the links 1, 2. More specifically, for the adjustment or change of the directions, the first adjustment module 100 is configured to change the position of the couplers P1, P3, independent of the positions of the links 1, 2, and for such repositioning, to move the couplers P1, P3, independent of the movements of the links 1, 2.

Further, by employing the first synchronizer 140, the first adjustment module 100 is configured to simultaneously move the couplers P1, P3 in the same direction by the same distance and thereby to dispose the couplers P1, P3 in the same position. For this reason, the first adjustment module 100 is configured to simultaneously change the directions of the forces in the same direction by the same amount.

Consequently, in view of the all these functionalities, the first adjustment module 100 is configured to simultaneously change the directions of the forces, independent of the links 1, 2. That is, the first adjustment module 100 is configured to simultaneously adjust the directions of the forces in an active and independent manner to be responsive to the user's intention for movement.

Meanwhile, some components of the first adjustment module 100, namely the first and second pulleys 110, 120 and the first synchronizer 140 (i.e., the belt) coupled thereto, may be connected to both the first and second links 1, 2 via first and second joints J1, J2. In particular, these components 110, 120, 140 may control the relative movement of the second link 2 with respect to the first link 1 through their association with the actuators 10, 20 (in particular, the second actuator 20). Thus, the components 110, 120, 140 of the first adjustment module 100 may constrain the second link 2 relative to the first link 1 while allowing the movement of the second link 2 relative to the first link 1. In other words, by means of these components 110, 120, 140, the second link 2 may be rotated in the same plane as the first link 1 while maintaining its orientation relative to the first link 1. For this reason, at least the parts 110, 120, 140 of the first adjustment module may function as a first parallelogram mechanism M1 of the second embodiment that performs the same function as the first embodiment.

Further, since the first supporter 5 supports the elbow, it may be required for the first supporter 5 to maintain the vertical orientation for stable support. For this reason, the upper limb assist robot according to the second embodiment may also include a second parallelogram mechanism M2 provided to the first and second links 1, 2 and the first supporter 5, similar to the first embodiment. As shown in FIGS. 9-11, the second parallelogram mechanism M2 according to the second embodiment may include the second pulley 120 rotatably installed on the second joint J2, a third pulley 150 rotatably installed on a portion of the second link 2 connected to the first supporter 5, and a belt 160 wound around the second and third pulleys 120, 150. In one example, as previously described, since the fourth end 2b of the second link 2 is rotatably or pivotably connected to the first supporter 5, the third pulley 150 may be rotatably installed on such a fourth end 2b with a hinge shaft or pin. Additionally, as an example, if the third link 3 is directly connected to the second link 2 (i.e., to the fourth end 2b, for example) instead of the first supporter 5, as previously described, the third pulley 150 may be installed concentrically with the third joint J3 of the third link 3, and may share the hinge shaft or hinge pin with the third joint J3 for rotatable installation. A belt 160 is configured to connect the second pulley 120 and the third pulley 150 to each other, and may be wound on a separate pulley that is installed on the second joint J2 instead of the second pulley 120, if necessary.

In such a second parallelogram mechanism M2, the third pulley 150 and the belt 160 connect the first supporter 5 to the first parallelogram mechanism M1: 110, 120, 140 that connects the first and second links 1,2 described above. Thus, the first supporter 5 may be constrained to the first and second links 1,2. Accordingly, the second parallelogram mechanism M2 may maintain the orientation of the first supporter 5 to be constant. That is, the second parallelogram mechanism M2 aligns the first supporter 5 in the vertical direction, whereby the elbow may always be reliably supported by such first supporter 5. Further, since the second parallelogram mechanism M2: 120, 150, 160 together with the first parallelogram mechanism M1: 110, 120, 140 is configured to connect and constrain the first and second links 1,2 and the first supporters 5 as a single assembly, the relative motion and orientation maintenance of the second link 2 with respect to the first link 1 may also be achieved more effectively.

Similar to the first embodiment, the actuators 10, 20 and the first adjustment module 100 according to this second embodiment may implement various modes of the upper limb assist robot configured to appropriately perform the movements in accordance with the user's intentions. These modes will be described in detail below with reference to FIGS. 13A and 13B.

Firstly, similar to FIG. 6 of the first embodiment, FIG. 13A illustrates a gravity compensation mode of the upper limb assist robot. In such a gravity compensation mode, the first adjustment module 100 may revolve or turn the first and third couplers P1, P3 by the rotations of the first and second pulleys 110, 120, so as to position the couplers P1, P3 on the vertical axes (y-axes) S1, S2 of the upper limb assist robot set on the first and second joints J1, J2. More specifically, the first adjustment module 100 may dispose each couplers P1, P3 on a portion of the vertical axis (y-axis) above the horizontal axis (x-axis) of each of first and second joints J1, J2. By such positioning of the first and third couplers P1, P3, as previously described with reference to FIG. 12A, the directions of the forces fs of the actuators 10, 20 are oriented substantially along the vertical axes (y-axes) S1, S2 and opposite to the direction of gravity (i.e., in the vertical direction), and may act as the counteracting forces fg to eliminate gravity. Further, referring to FIG. 6, the forces fs acting on the joints J1, J2 may act on the elbow of the user via the first supporter 5 as the combined or resultant force fe, and such a resultant force fe may act as the counteracting force fg. As previously described with reference to FIG. 6, since the forces fs of the actuators 10, 20 as combined are set to be greater than the gravitational force g acting on the upper limb and the upper limb assist robot, more specifically, at least the upper arm and the first and second links 1, 2 supporting the same, the gravitational force g is completely canceled out by this orientation, and at least the upper limb and the links 1, 2 are in a state that no gravitational force is acting. Therefore, the user may move the upper limb assist robot, precisely the link assemblies 1, 2, by applying only a small amount of his or her own force, and may stably move the upper limb while being supported by the links 1, 2.

Further, similar to FIG. 7 of the first embodiment, FIG. 13B shows a thrust mode of the upper limb assist robot. In such a thrust mode, the first adjustment module 100 may revolve or turn the first and third couplers P1, P3 by the rotations of the pulleys 110, 120, and arrange or dispose the couplers P1, P3 to have the predetermined angle a with respect to the vertical axes (y-axes) S1, S2 of the first and second joints J1, J2 as indicated by the dotted lines. Thus, at each of the first and second joints J1, J2, the force fs having the changed orientation generates the vertical component force fg and the horizontal component force ft. Further, as previously described with reference to FIG. 7 of the first embodiment, the forces fs acting on the joints J1, J2 act on the user's elbow through the first supporter 5 as the combined or resultant force fe, and this resultant force fe likewise generates the vertical resultant force fg and the horizontal resultant force ft that correspond to the sum of the vertical component forces fg and the sum of the horizontal component forces ft generated at the joints J1, J2, respectively. Such vertical resultant force fg may completely offset or cancel the gravitational force acting on the upper limb and the upper limb assist robot, more precisely, the upper arm and the links 1, 2, as described above. Further, the horizontal resultant force ft may be generated and oriented in a forward direction, as shown. Thus, the upper limb assist robot, more precisely, the link assemblies 1, 2 and other members and devices connected thereto, are moved forward by such a horizontal resultant force ft, and the user may move the upper limb forward with no use of his or her own strength by the movement of such an assembly 1, 2. Further, for example, as shown in FIG. 13B, the first and third couplers P1, P3 may be revolved or turned by the first adjustment module 100 to be disposed on the horizontal axes (x-axes) of the joints J1, J2, so as to have a phase angle a of 90 degrees with respect to the vertical axes (y-axes) of the joints J1, J2, respectively. By such positioning of the couplers P1, P3, the horizontal component force ft at each joint J1, J2 (i.e., the horizontal resultant force ft at the elbow or first supporter 5) may be maximized, and the upper limb may be moved forward by the upper limb assist robot more easily.

Meanwhile, as described above, since the first adjustment module 100 of FIGS. 10-13B repositions the couplers P1, P3 to change the directions (i.e., the orientations, more specifically, the orientations of lines of action) of the forces at the first and third couplers P1, P3, the connecting rods 12, 22 of the first and second actuators 10, 20 may be movable by such repositioning. Further, when the couplers P1, P3 are disposed at different positions, the amounts of movements of the first and second connecting rods 12, 22 of the actuators 10, 20 may change according to these positions, and the amounts of strain or deformation of the first and second springs 12, 23 coupled thereto may also change. Thus, depending on the positions of the couplers P1, P3, i.e., the modes of the upper limb assist robot, the magnitudes of the forces provided by the actuators 10, 20 may vary slightly from one another. Further, in each mode of the upper limb assist robot, different forces may be required from the actuators 10, 20 for smoother movement of the upper limb assist robot depending on operating conditions such as the intent and condition of the user and the environment. For these reasons, in order to compensate for the changed magnitudes of the forces generated by the actuators 10, 20 and to generate the required forces, the upper limb assist robot according to the second embodiment may be configured to adjust the magnitudes of the forces acted on the first and third couplers P1, P3, i.e., the first and second joints J1, J2, by the actuators 10, 20, and such a modification will be described below with reference to the related drawings.

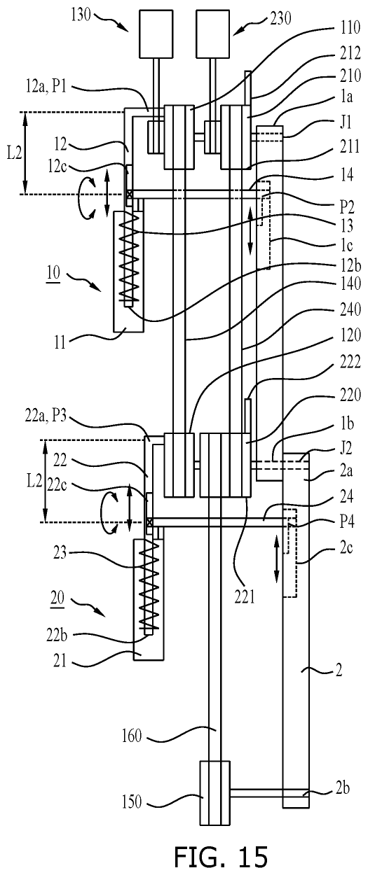

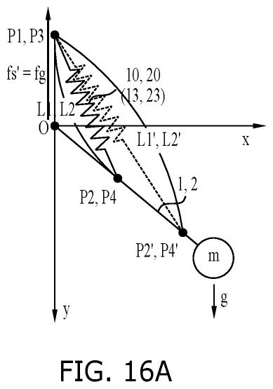

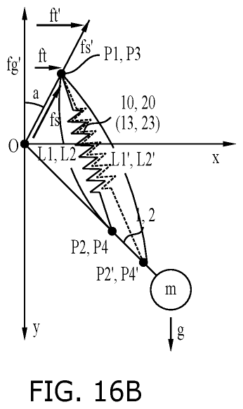

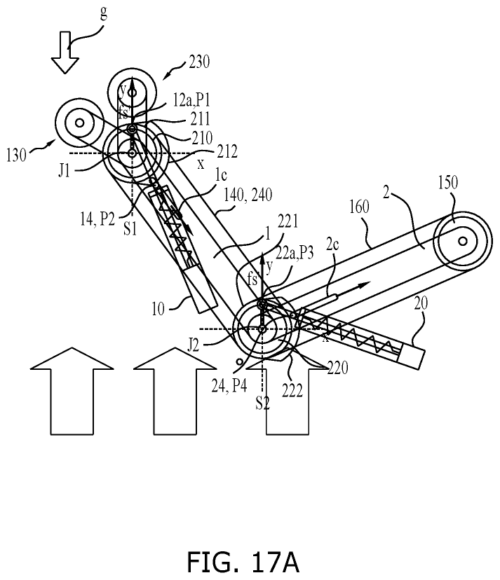

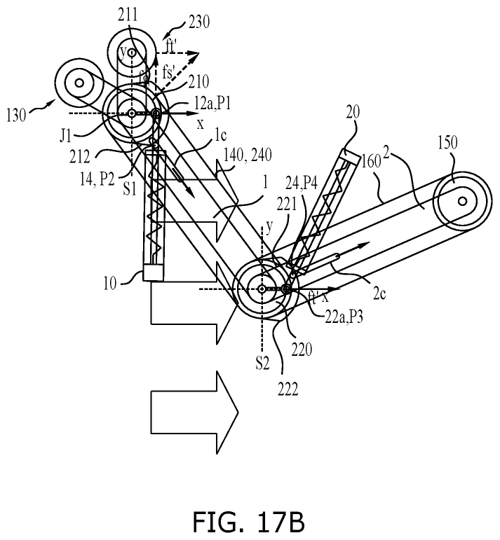

FIG. 14 is a side view illustrating a modification of the assembly for assisting the upper arm in the upper limb assist robot according to the second embodiment, and FIG. 15 is a front view illustrating the assembly of FIG. 14. Further, FIGS. 16A and 16B are conceptual diagrams illustrating dynamics models related to generation of increased force in the upper limb assist robot according to the second embodiment. Finally, FIGS. 17A and 17B are side views illustrating modes of operation of the assembly of FIG. 14.

Referring to FIGS. 14 and 15, the modification of the upper limb assist assembly according to a second embodiment may also basically include a link assembly 1, 2, first and second actuators 10, 20, and a first adjustment module 100. Since these devices 1, 2, 10, 20, 100 essentially have the same configuration and perform the same operation as previously described with reference to FIGS. 10-13B, the same descriptions of FIGS. 10-13B apply to these devices 1, 2, 10, 20, 100 and further description are omitted hereinafter. Instead, only configurations that differ from the examples of FIGS. 10-13B are further described in the following, if necessary.

Similar to the examples of FIGS. 10-13B, the dynamics model of the lower limb assist robot may be first reviewed in order for the lower limb assist robot to be designed to adjust the magnitude of the forces acting on the first and third couplers P1, P3, and such dynamics models are shown in FIGS. 16A and 16B. More specifically, FIGS. 16A and 16B illustrate the models of dynamics in which the magnitudes of the forces generated by the first and second actuators 10, 20 themselves are adjusted according to the operating situation of the upper limb assist robot, in order to vary the magnitudes of the forces applied to the first and third couplers P1, P3 (i.e., the first and second joints J1, J2). In FIG. 16A and FIG. 16B include the same basic dynamics models as described in FIG. 12A and FIG. 12B. Accordingly, the descriptions previously given with respect to FIGS. 12A and 12B apply to the setup and operation of the basic dynamics models in FIGS. 16A and 16B without further descriptions, and only descriptions for the newly added dynamics models to FIGS. 16A and 16B are provided below.

Referring to FIG. 16A and FIG. 16B, a first distance L1 is formed between the first and second couplers P1, P2 of the first actuator 10, and a second distance L2 is formed between the third and fourth couplers P3, P4 of the second actuator 20. These first and second distances L1, L2 may also be described as first length and second length. These first and second distances L1, L2 may represent, in practice, the relative amounts of movements of the first and second connecting rods 12, 22 with respect to the first and second cylinders 11, 21, i.e., the displacements of the second and fourth ends 12b, 22b with respect to the first and second cylinders 11, 21, as described with reference to FIGS. 10 and 11. Thus, the first and second distances L1, L2 may determine the amounts of deformations of the first and second springs 13, 23 connected to the second and fourth ends 12b, 22b, and thus also determine the magnitudes of the forces generated by the first and second actuators 10, 20. If the first and second distances L1, L2 are changed to new first and second distances L1′, L2′, the relative distances between the components of the first and second actuators 10, 20 (e.g., the connecting rods 12, 22 and the cylinders 11, 21) may also be changed by the changed distances. Further, by changing the distance between these components, the amounts of strains or deformations in the first and second springs 13, 23 constrained to these components are also changed. Moreover, the magnitudes of the forces fs of the actuators 10, 20 may also change to new magnitudes of the forces fs' according to the changed strains or deformations of the first and second springs 12, 22. Therefore, when the first and second distances L1, L2 are changed, the magnitudes of the forces generated at the actuators 10, 20 may change by the changes in distance, which in turn may change the magnitudes of the forces exerted on the first and third couplers P1, P3 and on the first and second joints J1, J2 via these couplers P1, P3.

In one example, the first and second distances L1, L2 may be changed by moving the second and fourth couplers P2, P4 to be disposed at new positions P2′, P4′, as shown in FIG. 16A and FIG. 16B. More specifically, to accomplish such movement and repositioning, the second and fourth couplers P2, P4 may be moved along the body of the first and second links 1, 2 (i.e., along a longitudinal direction thereof). Such movement and repositioning may cause the second and fourth couplers P2, P4 to be moved or repositioned relative to the first and third couplers P1, P3, which are disposed or stationary at a predetermined position. Alternatively, it may be described that the second and fourth couplers P2, P4 are moved relative to the first and second joints J1, J2 and disposed in the changed positions.

As such, when the amounts of strains or deformations on the springs 13, 23 change due to the changes in distances L1, L2, the forces fs of the actuators 10, 20 may change to the forces fs' having the new magnitudes. In one example, each of new force fs' may have an increased magnitude. In such a case, the offsetting or counteracting forces fg acting in a direction opposite to the direction of gravity may also be increased, as shown in FIG. 16A, and may more completely offset or cancel the gravitational force g acting on the user's upper limb and the upper limb assist robot (at least, the upper arm and the first and second links 1,2). Further, as shown in FIG. 16B, by the increased forces fs' of the actuators 10, 20, their component forces, namely, the vertical component forces fg′ and the horizontal component forces ft′, i.e., the counteracting forces and the thrust forces, may also be increased to adequately respond to changes in the forces required for proper operation of the upper limb assist robot.

Further, when the second and fourth couplers P2, P4 are moved to the different positions on the first and second links 1, 2, the distances L1, L2 may also change to different values, and the actuators 10, 20 may provide different magnitudes of forces. For example, by adjusting the distances L1, L2 in accordance with the operating conditions of the upper limb assist robot (e.g., real-time adjustment), the forces fs of the actuators 10, 20 may be increased or decreased in real time, and accordingly, the operations of the upper limb assist robot may be performed more smoothly and reliably.

Such changes of the first and second distances L1, L2 may be performed by various mechanisms, and as one example, the upper limb assist robot according to the second embodiment of the present invention may further include a second adjustment module 200 adopting a cam mechanism driven by a predetermined driving device. Such a second adjustment module 200 may utilize a simple mechanical element, such as a cam, which may selectively engage with the first and second actuators 10, 20 as need. Thus, the second adjustment module 200 may move the second and fourth couplers P2, P4 to change the distances L1, L2, thereby making the structure of the upper limb assistive robot to be lightweight and compact while still performing its intended function. Such a second adjustment module 200 will be described in detail below with reference to FIGS. 14-16B again.

First, the second adjustment module 200 may include a first cam 210 rotatably installed on the first joint J1. The first cam 210 may be installed concentrically with the first joint J1, as is the first pulley 110, such that the first cam 210 may share the hinge shaft or hinge pin with the first joint J1 and may be rotatably installed on the hinge shaft of the first joint J1. The first cam 210 may be disposed between the first pulley 110 and the first joint J1, as shown, or alternatively, the cam 210 may be disposed on the outside of the first pulley 110 in the axial direction of the hinge shaft (i.e., in the center axis) of the first joint J1.

The first cam 210 comprises a disk member or body having a predetermined thickness, as shown, and such a body may comprise a first base 211 having a predetermined radius and a first extension 212 having a radius greater than the first base 211. That is, the first cam 210 may be configured to have a first extension 212 provided at a predetermined location on the outer circumference of the body (or the first base 211). Such a first extension 212 may extend by a predetermined length circumferentially along the first cam 210, more precisely along the outer periphery of the body (or the first base 211) thereof, and may protrude radially from the body. Accordingly, the first cam 210, more precisely the first extension 212, may selectively contact or engage with the second coupler P2, i.e., the first hinge shaft 14, as will be described later, to serve to move the second coupler P2. Further, the first base 211 may be spaced apart from the first hinge shaft 14, as shown in FIG. 15. However, as shown in FIG. 14, the first base 211 may be configured to be in contact with the first hinge shaft 14, in which case both the first base 211 and the first extension 212, i.e., the entire first cam 210, may be continuously in contact with the first hinge shaft 14 to stably guide the movement of the shaft 14. Meanwhile, the first hinge shaft 14 may also be configured to be moved by the first cam 210. For example, the first link 1 may include a groove 1c extending along its body, and an end of the first hinge shaft 14 may be inserted into such a groove 1c. Further, the end of such a hinge shaft 14 may include a bracket or flange that latches or hooks onto an inner wall of the groove 1c so as not to be separated from the groove 1c. Therefore, when the external force is applied to the hinge shaft 14 (i.e., the second coupler P2) by the cam 210, e.g., when the hinge shaft 14 is pushed by the first extension 212, the hinge shaft 14 may stably move along the groove 1c while being guided by the groove 1c.

Further, the second adjustment module 200 may include a second cam 220 rotatably installed on the second joint J2. The second cam 220 may be installed concentrically with the second joint J2, as is the second pulley 120, such that the second cam 220 may share a hinge shaft or hinge pin with the second joint J2 and may be rotatably installed on the hinge shaft of the second joint J2. The second cam 220 may be disposed between the second pulley 120 and the second joint J2, as shown, or alternatively, may be disposed on the outside of the second pulley 120 in the axial direction (i.e., in the center axis) of the second joint J2.

The second cam 220 may comprise a disk member or body having a predetermined thickness, as shown, and such a body may comprise a second base 221 having a predetermined radius and a second extension 222 having a radius greater than the second base 221. In other words, the second cam 220 may be configured to have the second extension 222 provided at a predetermined location on the outer circumference of the body (or the second base 221). Such a second extension 222 may extend by a predetermined length circumferentially along the second cam 210, more precisely along the outer periphery of body (or the second base 221), and may extend radially from the body. Thus, the second cam 220, more precisely, the second extension 222, may selectively contact or engage with the fourth coupler P4, i.e., the second hinge shaft 24, as will be described later, to serve to move the fourth coupler P4. Further, the second extension 222 may have the same radius as the first extension 212 such that the first and second extension 212, 222 protrude from the first and second bases 211, 221 by the same amount and thus push or move the couplers B1, B2 by the same distance as will be described later. Further, the second base 221 may be spaced apart from the second hinge shaft 24, as shown in FIG. 15. However, as shown in FIG. 14, the second base 221 may be configured to be in contact with the second hinge shaft 24, in which case both the second base 221 and the second extension 222, i.e., the second cam 220, may be continuously in contact with the second hinge shaft 24 to stably guide movement of the shaft 24. Meanwhile, the second hinge shaft 24 may also be configured to be moved by the second cam 210. For example, the second link 2 may include a groove 2c extending along the body thereof, and an end of the second hinge shaft 24 may be inserted into such a groove 2c. Further, the end of such hinge shaft 24 may include a bracket or flange that hooks or latch onto an inner wall of the groove 2c such that the shaft 24 is not separated from the groove 2c. Thus, when an external force is applied to the hinge shaft 24 (i.e., the fourth coupler P4) by the second cam 220, e.g., when the hinge shaft 24 is pushed by the second extension 222, the hinge shaft 24 may stably move along the groove 2c while being guided by the groove 2c.

In addition, the second adjustment module 200 may include a second driver 230 configured to rotate the first and second cams 210, 220. Such second driver 230 may be configured to be substantially the same as the first driver 130 and components 131, 132, 133 thereof previously described with reference to FIGS. 10-13B. Accordingly, the same descriptions for the first driver 130 of FIGS. 10-13B apply, and further descriptions are omitted. Like the first adjustment module 100, the second driver 230 may also utilize a second synchronizer 240, which will be described later, to rotate either of the first and second cams 210, 220 so that the other thereof may also be rotated together.

Meanwhile, as previously described with respect to the first synchronizer 140 of the first adjustment module 100, for stable movement of the upper limb assist robot, i.e., for the stable movement of the first and second links 1, 2, the changes in the magnitudes of the forces applied by the first and second actuators 10, 20 need to be performed simultaneously. Furthermore, as described with reference to FIGS. 16A and 16B, the magnitude changes of the forces of the actuators 10, 20 are determined by the changes in the first and second distances L1, L2, and the distance changes may be determined by the traveling or moving distances of the second and fourth couplers P2, P4. Accordingly, the second adjustment module 200 may include the second synchronizer 240 configured to simultaneously move the second and fourth couplers P2, P4 by the same distance. As previously described, since the extensions 212, 222 perform the movement of the couplers P2, P4, the second synchronizer 240 may be configured to cause the extensions 212, 222 to contact or engage with the couplers P2, P4 at least simultaneously. Various mechanisms may be employed for such a second synchronizer 240, and similar to the first synchronizer 140, a belt may be used to synchronize the rotations of the cams 210, 220 as shown. Such a belt as the second synchronizer 240 may couple the first and second cams 210, 220 to transmit power to each other, thereby enabling the synchronized rotations of the cams 210, 220. Alternatively, like the first synchronizer 140, a gear train T may be disposed between and engage with the first and second cams 210, 220 instead of the belt, and many other transmission mechanisms may be used as the second synchronizers 240. When one of the cams 210, 220 for example, the first cam 210 as shown is rotated by the second driver 230, the second synchronizer 240 may cause the second cam 220 to also be rotated at the same time. Further, such rotations of the first and second cams 210, 220 may be performed in the same direction and at the same angle. By such simultaneous rotations of the same direction and the same angle, the extensions 212, 222 of the cams 210, 220 may simultaneously engage with the second and fourth couplers P2, P4 and move these couplers P2, P4 (i.e., the first and second hinge shafts 14, 24) in the same distance along the first and second links 1, 2 due to the same radius (i.e., the same amount of protrusion from the base 211, 221) thereof. Accordingly, the same change in the first and second distances L1, L2 may occur simultaneously, and the forces exerted by the actuators 10, 20 may therefore also change simultaneously by the same magnitude or amount due to the same amount of change in the deformations of the springs 13, 23. By including the second synchronizer 240 described above, the second adjustment module 200 may be configured to move the second and fourth couplers P2, P4 by the same distance at the same time.

In such a second adjustment module 200, when the second driver 230 simultaneously rotates the first and second cams 210, 220 in the same direction and at the same angle, the extensions 212, 222 may simultaneously engage with the first and second hinge shafts 14, 24 (i.e., the second and fourth couplers P2, P4) and simultaneously apply the forces on the shafts 14, 24 and the couplers P2, P4. Accordingly, the first and second hinge shafts 14, 24 may simultaneously travel or move by the same distance along the grooves 1c, 2c, and the first and second distances L1, L2 may be varied. Therefore, as shown, the second adjustment module 200 may be configured to push the second and fourth couplers P2, P4 in a longitudinal direction toward ends of the first and second links 1, 2 that are opposed to the first and second joints J1, J2 (i.e., the first and third couplers P1, P3). For example, in the case of the first actuator 10, since the first coupler P1 forms a portion of the connecting rod 12 and the second coupler P2 corresponds to portions of the hinge shaft 14 and the cylinder 11 coupled thereto, the change in the first distance L1 between the first and second couplers P1, P2 may in practice result in a change in the relative position of the connecting rod 12 and the cylinder 11 and a corresponding change in the distance therebetween. Thus, as shown in FIGS. 16A and 16B, the first spring 13 constrained to the rod and the cylinder 12, 11 is further deformed by this change in the distance between the rod 11 and the cylinder 12 and exerts the force fs' of the changed magnitude through the rod 12 to the first coupler P1, i.e., to the first joint J1. In the same manner, the second spring 23 of the second actuator 20 is further deformed, thereby applying the force of changed magnitude through the second connecting rod 22 to the third coupler P3, i.e., the second joint J2. Thus, the second adjustment module 200 may be configured to change and adjust the magnitudes of the forces applied to the first and third couplers P1, P3 (i.e., the first and second joints J1, J2) by changing the magnitudes of the forces generated by the first and second actuators 10, 20, and the operation of the upper limb assist robot may be carried out stably by properly responding to the changes in the forces required according to the changing operating conditions.

In view of the configuration of the second adjustment module 200 as described above, the second adjustment module 200 is an independent driving system that is configured to drive the actuators 10, 20, particularly the couplers P2, P4 thereof, independently of the links 1, 2. Therefore, the second adjustment module 200 is configured to adjust or change the magnitudes of the forces provided by the actuators 10, 20, independent of the orientations of the links 1, 2. More specifically, for the adjustment or change of the magnitudes, the second adjustment module 200 is configured to change the position of the couplers P2, P4, independent of the positions of the links 1, 2, and for such repositioning, to move the couplers P2, P4, independent of the movements of the links 1, 2.

Further, by employing the second synchronizer 240, the second adjustment module 200 is configured to simultaneously move the couplers P2, P4 in the same direction by the same distance and thereby to dispose the couplers P2, P4 in the same position. For this reason, the second adjustment module 200 is configured to simultaneously change the magnitudes of the forces by the same amount.

Consequently, in view of the all these functionalities, the second adjustment module 200 is configured to simultaneously change the magnitudes of the forces, independent of the links 1, 2. That is, the second adjustment module 200 is configured to simultaneously adjust the magnitudes of the forces in an active and independent manner to be responsive to the user's intention for movement.

Meanwhile, in the modification of the upper limb assist assembly according to FIGS. 14-17B, the components 110, 120, 140 of the first adjustment module 100 may function as the first parallelogram mechanism M1 for relative movement and orientation of the second link 2 with respect to the first link 1, like the examples of FIGS. 10-13B. Further, the components 210, 220, 240 of the second adjustment module 100 having a similar configuration to the components 110, 120, 140 of the first adjustment module 100 may also function as such first parallelogram mechanism M1.

Further, for vertical orientation of the first supporter 5, the modification of the upper limb assist assembly may further include a third pulley 150 and a belt 160 to form a second parallelogram mechanism M2. As shown in FIG. 15, the belt 160 is wound around the second cam 220, but could also be wound around the second pulley 120 to perform the same function. Such configurations of the third pulley 150 and belt 160 have been described in detail referring to FIGS. 10-13B, and those descriptions apply while further descriptions are omitted.

In the upper limb assist robot according to the second embodiment, such a second adjustment module 200 may be associated with the first adjustment module 100 to implement various modes of the upper limb assist robot. These modes will be described in detail below with reference to FIGS. 17A and 17B.

Firstly, FIG. 17A illustrates a gravity compensation mode of the upper limb assist robot. Since the operation of the first adjustment module 100 in such a gravity compensation mode according to FIG. 17A is the same as previously described with reference to FIG. 13A, the detailed description thereof will be omitted hereinafter. In this gravity compensation mode as shown, the second adjustment module 200 may move the second and fourth couplers P2, P4 by the first and second cams 210, 220, thereby changing the first and second distances L1, L2. The actuators 10, 20 may generate the new magnitudes in the generated forces, i.e., the increased forces fs′, due to the changed distances L1, L2 and the resulting further deformations of the springs 13, 23. Since the directions of the forces fs of the actuators 10, 20 are preset in the direction opposite to gravity along the vertical axes (y-axes) S1, S2 by the first adjustment module 100 in the gravity compensation mode, the increased forces fs' generated by the second adjustment module 200 may likewise be the counteracting forces fg acting in the same direction opposite to gravity. As described with reference to FIG. 6, the forces fs' acting on the joints J1, J2 may act on the user's elbow as the combined or resultant force fe, and such a resultant force fe may act as the counteracting force fg. For this reason, even when any additional loads and thus an additional gravitational force g thereby are acting on the upper limb assist robot, the additional forces generated at the actuators 10, 20 by the second adjustment module 200 may still make the upper limb assist robot weightless, i.e., gravity-free state as intended.

Further, FIG. 17B illustrates a thrust mode of the upper limb assist robot. Since the operation of the first adjustment module 100 in such a thrust mode is the same as previously described with reference to FIG. 13B, the detailed description thereof will be omitted hereinafter. In this thrust mode, as shown, the second adjustment module 100 may move the second and fourth couplers P2, P4 by the first and second cams 210, 220, thereby changing the first and second distances L1, L2. The actuators 10, 20 may generate the increased forces fs' due to the changed distances L1, L2 and the resulting further deformations of the springs 13, 23. As shown by the dotted lines, since the first and third couplers P1, P3 are revolved or turned by the first adjustment module 100 by the predetermined angle a with respect to the vertical axes (y-axes) S1, S2, the increased forces fs' may act on the respective joints J1, J2 with being oriented by the same angle a, and thus generate the increased horizontal component forces ft′ and the vertical component forces fg′. In FIG. 17B, the increased force fs' and component forces ft′, fg′ are shown for the first joint J1 only, but the same force and component forces fs′, ft′, fg′ are also generated for the second joint J2, as shown in FIG. 13B. As described with reference to FIG. 8, the increased forces fs' acting on the joints J1, J2 respectively may act on the user's elbow as the increased combined or resultant force fe′, and this increased resultant force fe′ may generates the increased vertical resultant force fg′ and the increased horizontal resultant force ft′ for the same reason. For this reason, the user may utilize these additional forces to smoothly move the upper limb using the upper limb assist robot even when the operating conditions change. Further, for example, as shown in FIG. 17B, when the first and third couplers P1, P3 are disposed on the horizontal axes x of the first and second joints J1, J2 by the first adjustment module 100, as described with reference to FIG. 13B, the horizontal component force ft′ at each of the joints J1, J2 and as a result, the horizontal resultant force ft′ at the elbow (i.e., the first supporter 5) may be maximized. In this case, such a horizontal resultant force ft′ may be further enhanced by the distance L1, L2 and the forces fs' increased by the second adjustment module 200, and the further increased forces may be applied to the forward movement of the upper limb, actively responding to the changed operational conditions, and required force.

Meanwhile, the first and second adjustment modules 100, 200 as described above utilize mechanical elements, namely pulleys 110, 120 and cams 210, 220, that basically rotate in manners similarly to each other in order to adjust the directions and magnitudes of the forces of the actuators 10, 20. Accordingly, these first and second adjustment modules 100, 200 may be integrated into a single mechanism, whereby the adjustment of the direction and magnitude of the force may be performed together by a single mechanism. For this reason, the upper arm assist assembly of the upper limb assist robot according to the second embodiment may be configured to include a single, integrated adjustment mechanism, and such a modification will be described below with reference to the accompanying drawings.

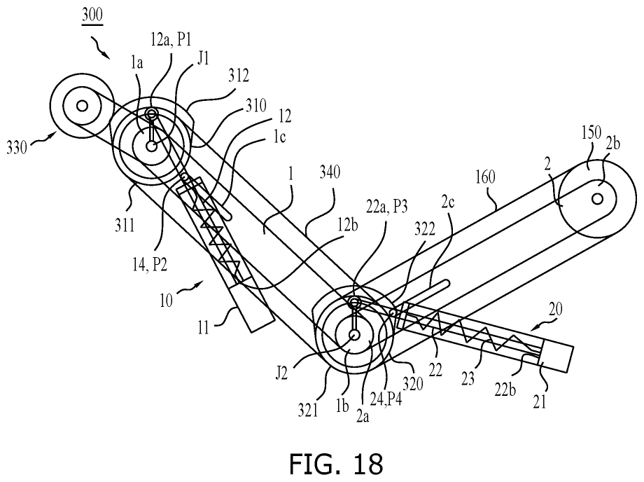

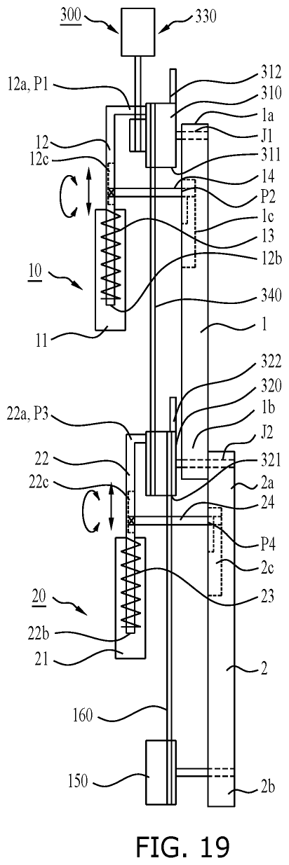

FIG. 18 is a side view illustrating a further modification of the upper arm assist assembly in the upper limb assist robot according to the second embodiment, and FIG. 19 is a front view illustrating the assembly of FIG. 18.

Referring to FIGS. 18 and 19, the further modification of the upper arm assist assembly may essentially include the link assembly 1, 2, and the first and second actuators 10, 20. As these devices 1, 2, 10, 20 basically have the same configuration and perform the same operation as previously described with reference to FIGS. 10-17B, the same descriptions of FIGS. 10-17B apply to these devices 1, 2, 10, 20 and further descriptions are omitted herein. Instead, only configurations that differ from the examples of FIGS. 10-17B are further described in the following.

As previously discussed, the first and second adjustment modules 100, 200 may be integrated with each other due to similarities in basic configuration and operating principles, and their integrated mechanism may be provided to the upper limb assist robot as a third adjustment module 300 in place of the first and second adjustment modules 100, 200 described above. Such a third adjustment module 300 may fulfill the functions of the first and second adjustment modules 100, 200 while making the structure of the upper limb assist robot lighter and more compact. The third adjustment module 300 will be described in detail below with reference to FIGS. 18 and 19.

Firstly, the third adjustment module 300 may include a first rotor 310 rotatably installed at the first joint J1. The basic configuration and function of such a first rotor 310 is the same as those of the first pulley 110 previously described in FIGS. 10-13B, and therefore, the descriptions thereof apply and further descriptions are omitted herein. Further, the first rotor 310 may comprise a disk member or body having a predetermined thickness, and such a body may include a first cylinder 311 having a predetermined radius and a first protrusion 312 having a radius greater than the first cylinder 311. Since these first cylinder 311 and first protrusion 312 are substantially identical to the first base 211 and first extension 212 of the first cam 210 described in FIGS. 14-17B, the descriptions of the first base 211 and first extension 212 apply, and further descriptions are omitted herein. Meanwhile, as previously described, since the position of the first coupler P1 connected to the first rotor 310 determines the direction of the force given by the first actuator 10, the first protrusion 312, which moves the second coupler P2, may be disposed on the first rotor 310 to be adjacent to the first coupler P1, as shown, such that the magnitude of the force may be adjusted along with the direction of the force. More specifically, the first protrusion 312 may be provided over a portion of the outer periphery or circumference of the body of the first rotor 310 where the first coupler P1 is disposed.

Further, the third adjustment module 300 may include a second rotor 320 rotatably installed on the second joint J2. The basic configuration and function of such second rotor 320 is the same as those of the second pulley 120 previously described in FIGS. 10-13B, and therefore, those descriptions apply and further descriptions are omitted herein. Further, the second rotor 320 may comprise a disk member or body having a predetermined thickness, and such a body may include a second cylinder 321 having a predetermined radius and a second protrusion 322 having a radius greater than the second cylinder 321. Since such second cylinder 321 and second protrusion 322 are substantially identical to the second base 221 and second extension 222 of the second cam 220 described in FIGS. 14-17B, the descriptions of the second base 221 and second extension 222 apply, and further descriptions are omitted hereinafter. Meanwhile, as previously described, since the position of the third coupler P3 connected to the second rotor 320 determines the direction of the force given by the second actuator 20, the second protrusion 322 for moving the fourth coupler P4 may be disposed on the second rotor 320 to be adjacent to the third coupler P3 as shown, such that the magnitude of the force may be adjusted along with the direction of the force. More specifically, the second protrusion 322 may be provided over at least a portion of the outer periphery or circumference of the body of the second rotor 320 where the third coupler P3 is disposed.

Further, the third adjustment module 300 may include a third driver 330 configured to rotate the first and second rotors 310, 320. Such a third driver 330 may be configured substantially the same as the first driver 130 previously described with reference to FIGS. 10-13B and the second driver 230 previously described with reference to FIGS. 14-17B. Accordingly, the descriptions of these first and second drivers 130,230 apply, and further descriptions are omitted herein.

In addition, the third adjustment module 300 may include a third synchronizer 340 configured to move the first and third couplers P1, P3 as well as the second and fourth couplers P2, P4 simultaneously. Since such a third synchronizer 340 has substantially the same configuration as the first and second synchronizers 140, 240 described above and is configured to perform a combination of their functions, the descriptions of these synchronizers 140, 240 applies and further descriptions are omitted hereinafter.

In the further modification of the upper arm assist assembly according to FIGS. 18-19, similar to the examples of FIGS. 10-17B, the components 310, 320, 340 of the third adjustment module 300 may function as the first parallelogram mechanism M1. Additionally, for the vertical orientation of the first supporter 5, the further modification of the upper arm assist assembly may further include the third pulley 150 and the belt 160 to form the second parallelogram mechanism M2. As shown in FIG. 19, the belt 160 may be wound around the second rotor 320 and the third pulley 150 to form the second parallelogram mechanism M2. The configuration of such third pulley 150 and belt 160 has been described in detail with reference to FIGS. 10-13B, and thus the same descriptions apply and further descriptions are omitted.

As such, the third adjustment module 300 may rotate the first and second rotors 310, 320 simultaneously in the same direction and at the same angle using the third driver 330 and the third synchronizer 340 based on the configuration described above. Accordingly, the third adjustment module 300 may be configured to simultaneously move the first and third couplers P1, P3 in the same direction and by the same distance, and to simultaneously move the second and fourth couplers P2, P4 by the same distance. More specifically, the third adjustment module 300 may be configured to revolve or turn the first and second joints P1,P3 by a predetermined angle around the first and second joints J1, J2 so as to offset or space apart the first and third couplers P1, P3 by a predetermined distance from the vertical axes (y-axes) S1, S2, and at the same time, may be configured to move the second and fourth couplers P2, P4 in the longitudinal directions of the first and second links 1, 2. Further, by such revolution of the first and third couplers P1, P3 and linear movement of the second and fourth couplers P2, P4, the third adjustment module 300 may be configured to change the relative positions of the first and third couplers P1, P3 with respect to the vertical axes (y-axes) S1, S2 and simultaneously change the first and second distances L1, L2. As a result, by this series of operations, the third adjustment module 300 may simultaneously change the directions and magnitudes of the forces generated by the first and second actuators 10, 20. As such operations of the third adjustment module 300 have already been previously described in detail through the operations of the first and second adjustment modules 100, 200 of FIGS. 10-17B, such descriptions apply equally to the third adjustment module 300 and no further descriptions will be provided.

Like the first embodiment, to further facilitate the movement of the user's upper limb, the upper limb assist robot according to the second embodiment may further include a third actuator 30 configured to assist the movement of the forearm as shown in FIG. 9.

As previously described, in the upper limb assist robot, the third link 3 may support the forearm and be configured to assist movement thereof, and thus the third actuator 30 may be configured to exert the force on the third link 3. Further, the movement of the third link 3 is achieved by the relative rotation of the third link 3 with respect to the third joint J3. For this reason, in order to assist the movement of the third link 3 and the movement of the forearm thereby, the third actuator 30 may be configured to apply the force to the third joint J3. As shown in FIGS. 6-8 of the first embodiment and FIG. 9 of the second embodiment, the force exerted on the third joint J3 by the third actuator 30 ultimately acts on the wrist of the upper limb via the third link 3 (and further, via the second supporter 6).

Instead of the conventional actuator having the motorized or electric-powered mechanism, the third actuator 30 may also be configured to provide the third link 3 with the mechanical force generated by the mechanical element, i.e. the elastic force generated by the deformation and restoration of the elastic member, similar to the first and second actuators 10, 20. In order to appropriately generate and provide the mechanical force to the third joint J3, the third actuator 30 may include a fifth coupler P5 connected to the third joint J3. Further, to provide the support for deformation and restoration of the mechanical element (i.e., the elastic member), the third actuator 30 may include a sixth coupler P6 connected to any other member or device, e.g., the third link 5 spaced apart from the fifth coupler P5. More specifically, instead of being coupled directly to the third joint J3, the fifth coupler P5 may be connected to the third joint J3 by being coupled to any intermediate member provided to the third joint J3 such as a first auxiliary pulley 410 of an auxiliary adjustment module 400, as will be described later. The third actuator 30 may first apply the generated force directly to the fifth coupler P5, and the applied force may then be transmitted to the third joint J3. Further, the third actuator 30 needs to be configured to move relative to the third link 3 in order to perform its intended function, namely the generation of the force and the change of direction and magnitude of the generated force, as will be described later. For this reason, the fifth coupler P5 may be rotatably or pivotably connected to the third joint J3, and the sixth coupler P6 may be rotatably or pivotably connected to the third link 3.

In addition to this basic configuration, the third actuator 30 is configured to utilize mechanical forces in the same manner as the first and second actuators 10, 20, and thus may include detailed configurations similar to those of the first and second actuators 10,20. In one example, the third actuator 30 may include a third cylinder 31, a third connecting rod 32, a third spring 33, and a third hinge shaft 34. Similar to the first and second actuators 10,20, the third connecting rod 32 may include a fifth end 32a rotatably or pivotably connected to the third joint J3 and a sixth end 32b coupled to the third spring 33, wherein the fifth end 32a may form the fifth coupler P5 of the third actuator 30. Further, the third hinge shaft 34 may form the sixth coupler P6 of the third actuator 30. The detailed configurations of these components 31-34 of the third actuator 30 and the associated third link 3 are substantially the same as the detailed configurations of the corresponding components 11-14, 21-24 of the first and second actuators 10, 20 and the first and second links 1, 2. Accordingly, the descriptions of the corresponding components 11-14, 21-24 and the first and second links 1, 2 provided with reference to FIGS. 10-13B also apply to the components 31-34 and the third link 3 of the third actuator 30, and further descriptions are omitted herein.

Further, to achieve such a change in direction of the force of the third actuator 30 as described with reference to FIGS. 12A and 12B, the upper limb assist robot according to the second embodiment may further include an auxiliary adjustment module 400. Such an auxiliary adjustment module 400 may have a detailed configuration similar to the first adjustment module 100 described above. More specifically, the auxiliary adjustment module 400 may include a first auxiliary pulley 410 and an auxiliary driver 430 configured to rotate the first auxiliary pulley 410. The auxiliary driver 430 may include a power unit 431, a drive pulley 432 coupled to the power unit 431, and a drive belt 433 connecting the drive pulley 432 and the first auxiliary pulley 410. The first auxiliary pulley 410 and the auxiliary drivers 430: 431-433 of the auxiliary adjustment module 400 are substantially the same as the first pulley 110 and the first driver 130: 131-133 of the first adjustment module 100. Accordingly, the descriptions of those components 110, 130 provided with reference to FIGS. 10-13B also apply to the components 410, 430 of the second adjustment module 400, and further descriptions are omitted herein.

Further, similar to the first embodiment, the upper limb assist robot according to the second embodiment may also include a third parallelogram mechanism M3 configured to maintain a vertical orientation of the second supporter 6, for stable support of the wrist. As shown in FIG. 9, the third parallelogram mechanism M3 according to the second embodiment may include the first auxiliary pulley 410, a second auxiliary pulley 420 rotatably connected to the second supporter 6/third link 3, and a belt 440 wound on the first and second auxiliary pulleys 410, 420. In such a third parallelogram mechanism M3, the first and second auxiliary pulleys and belt 410, 420, 440 may traverse the first and second supporters 5, 6 and connect them to each other. Thus, the first and second supporters 5, 6 are constrained to each other, and the constant orientation of the first supporter 5 allows the constant orientation of the second supporter 6 to be maintained.

The auxiliary adjustment module 400 may rotate the first auxiliary pulley 410 to position the fifth coupler P5 of the third actuator 30 on the vertical axis S′, as shown in FIG. 9. In such a case, as shown by the solid line, a force fw of the third actuator 30 acts on the third joint J3 in the direction opposite to gravity along the vertical axis S′, and may finally act as a counteracting force fg on the wrist of the upper limb via the third link 3 and the second supporter 6. Further, when the auxiliary adjustment module 400 positions the fifth coupler P5 away from the vertical axis S′ the force fw of the third actuator 30 acts on the third joint J3 oriented at a predetermined angle to the vertical axis S′, as also described referring to FIG. 13B, and as shown by the dotted line in FIG. 9, may finally act on the wrist via the third link 3 and the second supporter 6 as the force fw with the same orientation. Similarly, as shown by the dotted line, this force fw may generate a horizontal component force ft that acts as a thrust to move the upper limb, more specifically the forearm, and a vertical component force fg that offsets or cancels gravity. This change in the direction of the force and the results thereof by the auxiliary adjustment module 400 are substantially the same as previously described in detail with reference to FIGS. 10-13B, and accordingly, the same descriptions apply to the auxiliary adjustment module 400.

In addition to the auxiliary adjustment module 400, the upper limb assist robot according to the second embodiment may further include an additional second adjustment module 200 configured to change the magnitude of the force of the third actuator 30. Since such an additional second adjustment module 200 only adjusts the magnitude of the force of the third actuator 30, it may include only a first cam 210 rotatably installed on the third joint J3 and a second driver 230 driving the first cam 210 among the previously described components of FIGS. 14-17B. Similar to the description previously provided referring to FIGS. 14-17B, the third actuator 30, in particular the third hinge shaft 34 thereof and the third link 3, may also be further modified to engage and interact with the additional second adjustment module 200 for the third actuator 30. The detailed configuration and operation of such an additional second adjustment module 200 and associated components are the same as those previously described in detail with reference to FIGS. 14-17B, and such descriptions are hereby incorporated without substantive changes.

Moreover, the auxiliary adjustment module 400 and the additional second adjustment module 200 may be replaced by the third adjustment module 300 configured to simultaneously change the direction and magnitude of the force. That is, the upper limb assist robot according to the second embodiment may further includes an additional third adjustment module 300 configured to adjust both the magnitude and direction of the force of the third actuator 30, instead of the auxiliary adjustment module 400 and the second adjustment module 200. Such an additional third adjustment module 300 manipulates only the force of the third actuator 30, and thus may include only the first rotor 310 rotatably installed at the third joint J3 and the third driver 330 that rotates the first rotor 310, among the previously described components of FIGS. 18 and 19. Similar to the descriptions previously provided referring to FIGS. 18 and 19, the third actuator 30, in particular the third hinge shaft 34 thereof and third link 3, may also be further modified to engage and interact with the additional third adjustment module 300 for the third actuator 30. The detailed configuration and operation of such an additional third adjustment module 300 and related components are the same as those previously described in detail with reference to FIGS. 18-19, and such descriptions are hereby incorporated without substantive changes.

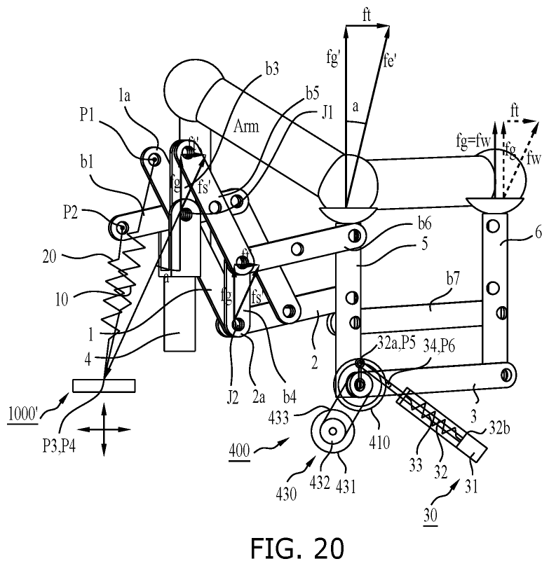

Meanwhile, as shown in FIG. 20, the auxiliary adjustment module 400 and the third actuator 30 of the second embodiment previously described with reference to FIG. 9 may be applied to the first embodiment in the same manner. That is, the auxiliary adjustment module 400 and the third actuator 30 of the second embodiment may be applied to the chassis 1-6, M1-M3 of the first embodiment together with the first and second actuators 10, 20 and adjustment module 1000′ of the first embodiment. Further, as described above, the second adjustment module 200 for the third actuator 30 of the second embodiment may be applied in addition to the auxiliary adjustment module 400, and only the third adjustment module 300 of the second embodiment may be applied instead of the auxiliary adjustment module 400 and the second adjustment module 200. In such a case, since the upper limb assist robot of the first embodiment already includes the third parallelogram mechanism M3 utilizing the seventh bar member b7, the second auxiliary pulley 420 and the belt 440, which are the third parallelogram mechanism M3 of the second embodiment, may not be applied. Thus, by application of the third actuator 30 of the second embodiment and the associated adjustment modules 200, 300, 400, the change in direction and magnitude of the force for canceling gravity and generating thrust at the wrist may be effectively performed even in the first embodiment.

[Lower Limb Assist Robot]

In the following, the present invention includes as an example a robot configured to assists a lower limb, i.e., a leg of a human body, but the described examples of the robot may be applied to robots configured to assist the movement of the upper limb, i.e., an arm and other parts of the human body such as the upper limb assist robot described referring to FIGS. 1-20, without substantial modifications to their principles and configurations. Therefore, the descriptions of the upper limb assist robot provided along with FIGS. 1-20 are hereby incorporated by reference, and for configurations and operations/functions of the lower limb assist robot that are similar to or substantially the same as those of the upper limb assist robot, the corresponding descriptions provided with regard to the upper limb assist robot may apply, if any contrary descriptions are not given.

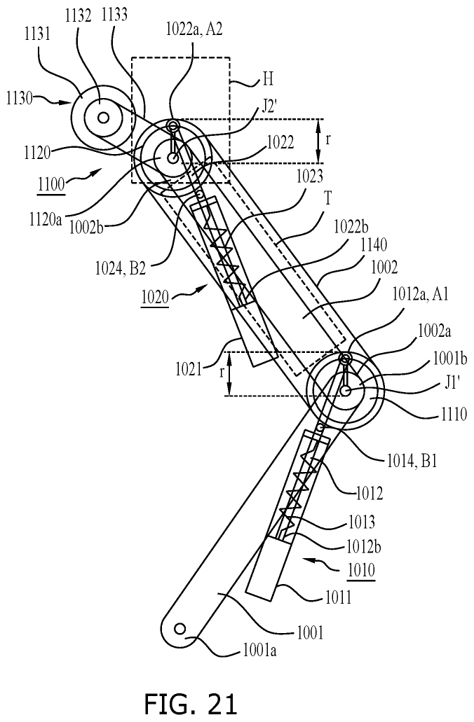

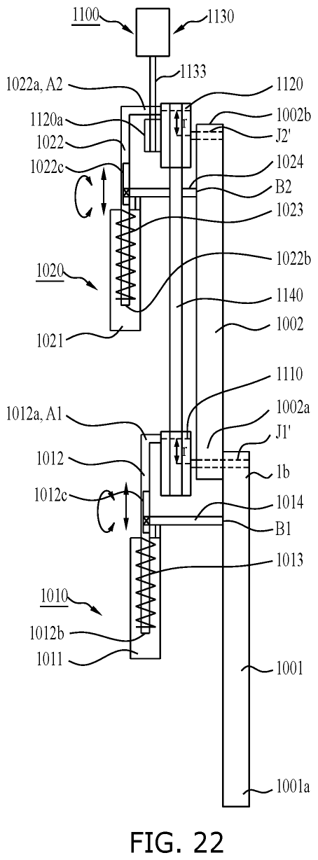

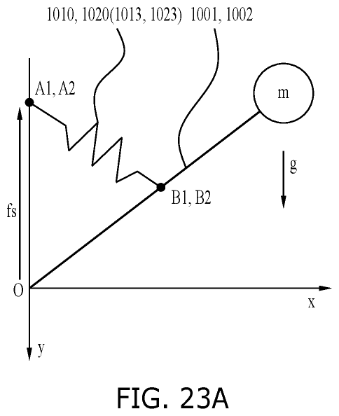

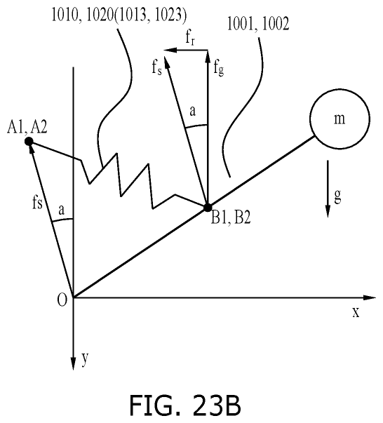

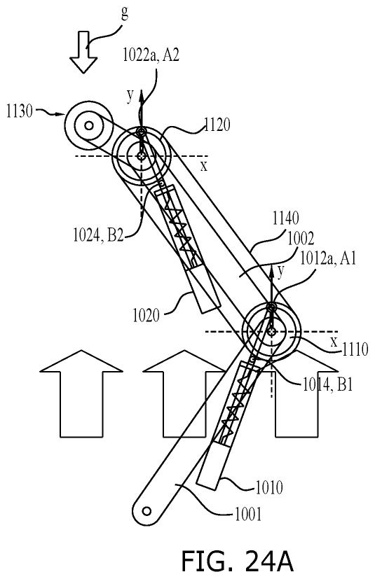

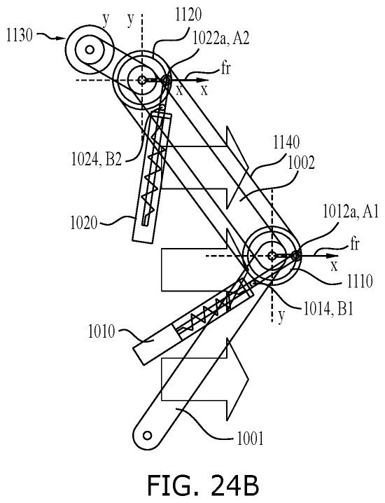

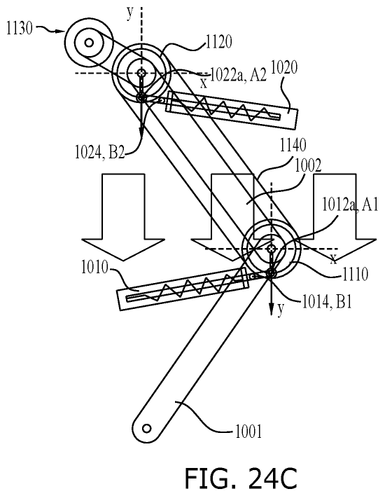

FIG. 21 is a side view illustrating a lower limb assist robot according to the present invention, and FIG. 22 is a front view illustrating the lower limb assist robot of FIG. 21. Further, FIGS. 23A and 23B are conceptual diagrams illustrating dynamics models of the lower limb assist robot of FIG. 21. Finally, FIGS. 24A-24C are side views illustrating operation modes of the lower limb assist robot of FIG. 21.

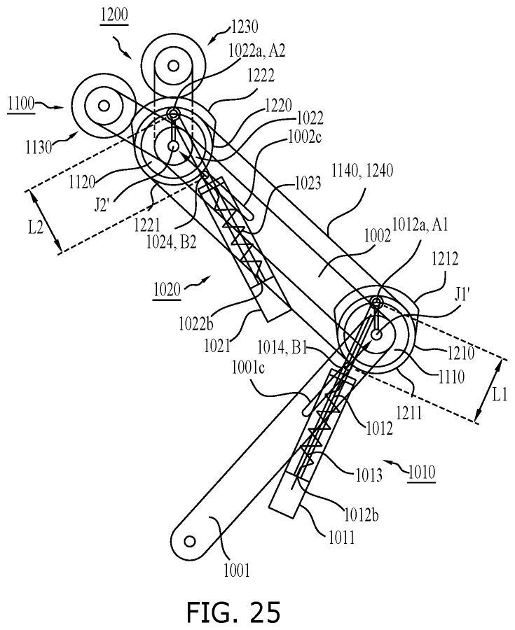

Referring to FIG. 21, a lower limb assist robot according to the present invention may include a link assembly of links 1001, 1002 that are configured to provide overall support for a user's leg and are connected to each other to be relatively pivotable or rotatable. Further, the lower limb assist robot may include actuators 1010, 1020 that apply forces to the link assembly 1001, 1002 to assist a movement of the user's leg. In addition, as will be described in more detail later, an accessory, i.e., an adjustment module 1100 that interacts with the actuators 1010, 1020 to assist a leg movement, may be installed on the lower limb assist robot, and other accessories 1200, 1300 may also be installed on the robot, as shown in FIGS. 25-31B. The adjustment modules 1100-1300 may control the forces exerted by the actuators 1010, 1020 to move the link assembly 1001, 1002 in accordance with the user's intent, thereby properly assisting the movement of the user's leg. In addition, the lower limb assist robot of the present invention may include a mounting unit H that is disposed on a pelvis of the user, as shown in FIG. 21. The mounting unit H may assist a mounting of the main devices 1001, 1002, 1010, 1020, 1100-1400 of the lower limb assist robot to the body of the user, but is not required necessarily.

Meanwhile, FIGS. 21-24C illustrate, as an example, a right unit of the lower limb assist robot provided on a right leg of the user, and configurations of such a right unit will be described hereinafter for convenience of description. However, the lower limb assist robot of the present invention may include a left unit that is configured identically to the illustrated right unit for balanced support of movement of the user's legs. In one example, such a left unit and the illustrated right unit may be coupled to the left and right sides of the mounting unit H, respectively. Thus, without further mention hereinafter, the lower limb assist robot of the present invention includes the left unit configured identically to the illustrated right unit, and the descriptions relating to the right unit provided with reference to FIGS. 21-24C hereinafter are equally applicable to such a left unit. Likewise, the examples of FIGS. 25-31B of the present invention all relate to the right unit of a lower limb assist robot, but the lower limb assist robot of the present invention includes a left unit configured identically to these examples, and the descriptions of these examples apply equally to such a left unit. Under this premise, the individual components or elements of the lower limb assist robot according to the present invention will be described in more detail in the following.

Firstly, the lower limb assist robot may include a first link 1001, as the link assembly, which is configured to support the lower leg of the user (i.e., a calf of the leg). The first link 1001 may comprise a body extending along the lower leg, and may be provided at an outer portion or surface of the lower leg, as shown in FIGS. 21 and 22. The first link 1001 may have a length extending from an ankle to a knee of the user to stably support the lower leg. Such a first link 1001 may therefore include a lower end 1001a disposed near the ankle and an upper end 1001b disposed near the knee.

Further, the lower limb assist robot may include a second link 1002, as the link assembly, which is configured to support the upper leg (i.e., a thigh of the leg) of a user. The second link 1002 may comprise a body extending along the upper leg and may be provided at a side portion or surface of the upper leg. The second link 1002 may have a length that extends from the user's knee to near the hip, for example, to the hip joint, in order to stabilize and support the upper leg. Such a second link 1002 may thus include a lower end 1002a disposed near the knee and an upper end 1002b disposed near the hip.

Further, the second link 1002 may be pivotably or rotatably connected to the first link 1001 to assist the movement of the upper and lower legs that are in relative rotational or pivotal motion That is, the second link 1002 may have a first joint J1′ pivotably or rotatably connected to the first link 1001, more specifically, to the upper end 1001b of the first link 1001. The first joint J1′ along with the first link 1 may be configured to allow the lower leg to move relative to the knee. More specifically, the first joint J1′ may comprise the upper end 1001b of the first link 1001, the lower end 1002a of the second link 1002, and a pivot shaft or pin (or a hinge shaft or pin) rotatably or pivotably coupling these ends 1001b, 1001a. Alternatively, the hinge shaft or pin coupling these first and second links 1001, 1002 may itself be the first joint J1′. Still alternatively, only the upper end 1001b of the first link 1001 and the lower end 1002a of the second link 1002 that connect the first and second links 1001, 1002 with being subject to the force may be defined as the first joint J1′. Further, the second link 1002 may include a second joint J2′ disposed opposite to the first joint J1′. For example, the second joint J2′ may be configured to be rotatably or pivotably coupled to the mounting unit H to assist the movement of the upper leg relative to the pelvis of the user. More specifically, in one example, the second joint J2′ may comprise the upper end 1002b of the second link 1002, the mounting unit H, and a pivot shaft or pin (or a hinge shaft or pin) rotatably or pivotably coupling the end 1002b and the unit 1 H. Alternatively, the hinge pin or shaft itself that couples these second link 1002 and the mounting unit H may be the second joint J2′. Still alternatively, only the upper end 1002b of the second link 1001 and a portion of the mounting unit H that actually connects the second link 1002 and the mounting unit H may be defined as the second joint J2′. Meanwhile, since the mounting unit H is an optional component or configuration, if the lower limb assist robot does not include the mounting unit H, the second link 1002, i.e., the upper end 1002b thereof, may remain attached to the upper leg and may rotate or pivot relative to the pelvis under force. Thus, in such a case, the second joint J2′ may be a hinge shaft provided at the upper end 1002b of the second link 1002 for installation or coupling of the upper end 1002b and other accessory 1100. Such first and second joints J1′, J2′ may be disposed near the knee joint and hip joint of the user, respectively, and assist rotational or pivotal movements at the knee joint and hip joint.

To apply the force for movement of the link assembly 1001, 1002 described above, the lower limb assist robot may include actuators 1010, 1020. As previously described, in the user's lower limb, the upper leg plays a primary role in the movement of the lower limb, with moving relative to both the lower leg and pelvis. Accordingly, the actuators 1010, 1020 may be configured to apply forces primarily to the second link 1002 to assist such movement of the upper leg. Further, the upper leg rotates or pivot with respect to both the pelvis as well as the lower leg in order to perform the movement of lower limb. Therefore, the forces applied to both the knee joint and the hip joint, which are the absolute rotation points of the upper leg, are required to adequately assist the rotation of the upper leg and to stabilize the movement of not only the upper leg but also the entire lower limb. For this reason, the lower limb assist robot may include first and second actuators 1010, 1020 configured to apply forces to the second link 1002, more specifically, to the first and second joints J1′, J2′ corresponding to the knee joint and hip joint of the lower limb, respectively.

Conventional actuators applied to the lower limb assist robots have a motorized mechanism or an electric-powered mechanism that utilizes electricity to generate the required force. In contrast to such conventional actuators, the first and second actuators 1010, 1020 are configured to provide the required forces to the lower limb assist robot by utilizing only mechanical forces generated by the mechanical elements without the aid of electrical forces. For example, as will be described later, the first and second actuators 1010, 1020 may generate and provide to the second link 1002 elastic forces of the mechanical elements, more specifically, tensions or elastic forces due to deformation and restoration of the elastic members. Further, the conventional electric actuator is configured to be coupled directly to an axis or a shaft of the joint and to add torque directly to the axis of the joint. In contrast, since the first and second actuators 1010, 1020 utilize the forces generated from deformations of the mechanical elements, the actuators 1010, 1020 require spaces for such deformations, and may therefore not be directly coupled to the axis or shaft of the respective joints but be spaced away from the joints.

Due to these structural differences from the conventional electric-powered actuators, the first actuator 1010 may include a first coupler (or connector) A1 coupled or connected to the first joint J1′ to properly generate and provide the mechanical force. Further, to provide support for the deformation and restoration of the mechanical element (i.e., the elastic member), the first actuator 1010 may include a second coupler (or connector) B1 connected to the first link 1001. More specifically, the first coupler A1 may be connected to the first joint J1′ by being coupled to any other member provided to the first joint J1′ (e.g., a first pulley 1110 of a first adjustment module 1100), instead of being directly coupled to the first joint J1′, as will be described later. The first actuator 1010 may first directly apply the generated force to the first coupler A1, as will be described later, and the applied force may then be transmitted to the first joint J1′. Further, the second coupler B1 may be connected to the second link 1002 and any other members instead of the first link 1001, provided that the support for deformation of the mechanical element is possibly provided. Similar to such a first actuator 1010, the second actuator 1020 may include a third coupler (or connector) A2 connected to the second joint J2′. Further, to provide the support for deformation and restoration of the mechanical element (i.e., the elastic member), the second actuator 1020 may include a fourth coupler (or connector) B2 that is connected to the second link 1002. More specifically, the third coupler A2 may be connected to the second joint J2′ by being coupled to any other member provided to the second joint J2′ (e.g., a second pulley 1120 of the first adjustment module 1100) instead of being directly coupled to the second joint J2′, as will be described later. The second actuator 1020 may first apply the generated force directly to the third coupler A2, as will be described later, and then the applied force may be transmitted to the second joint J2′. Further, the fourth coupler B2 may be connected to any other adjacent members instead of the second link 1002, provided that the support for deformation of the mechanical element is enabled by such a connection. Meanwhile, since the first and second actuators 1010, 1020 are connected to the first and second links 1001, 1002 by the first to fourth couplers A1, B1, A2, B2, it may be required that the first and second actuators 1010, 1020 are also configured to move relative to the links 1001, 1002, for smooth movement of the links 1001, 1002. For this reason, in the first actuator 1010, the first coupler A1 may be pivotably or rotatably connected to the first joint J1′ and the second coupler B1 may be configured to be pivotably or rotatably connected to the first link 1001. Likewise, in the second actuator 1020, the third coupler A2 may be configured to be rotatably or pivotably connected to the second joint J2′, and the fourth coupler B2 may be rotatably or pivotably connected to the second link 1002.

In addition to these basic configurations, the detailed configurations of the first and second actuators 1010, 1020 will be described in more detail with reference to FIGS. 21 and 22.

Firstly, the first actuator 1010 may include a first cylinder 1011 provided to the first link 1001. The first cylinder 1011 may form an inner space of a predetermined size. The first cylinder 1011 may accommodate a first spring 1013 within the formed inner space, and may protect the first spring 1013 during operation of the first spring 1013, i.e., the deformation and restoration.

Further, the first actuator 1010 may include a first connecting rod 1012 extending from the first cylinder 1011 to the first joint J1′. The first connecting rod 1012 may connect the first spring 1013 and the first cylinder 1011 receiving the spring 1013 to the first joint J1′, and may thereby serve to transmit the force generated by deformation of the first spring 1013 to the first coupler A1, i.e., the first joint J1′. More specifically, the first connecting rod 1012 may include a longitudinally elongated body and first and second ends 1012a, 1012b corresponding to two ends of the body. The first end 1012a of such a connecting rod 1012 may be disposed adjacent to the first joint J1′ and may be rotatably or pivotably connected to the first joint J1′, for example by a hinge structure such as a hinge shaft or pin. As will be described later, instead of being directly coupled to the first joint J1′, the first end 1012a may be pivotably or rotatably coupled to any other member provided at the first joint J1′ (e.g., the first pulley 1110 of the first adjustment module 1100), and thus substantially pivotably or rotatably coupled to the first joint J1′ as well. As a result of this configuration, the first end 1012a may substantially form the first coupler A1 rotatably or pivotably connected to the first joint J1′ as described above. That is, the first coupler A1 may comprise a hinge shaft of pin that is provided at the first connecting rod 1012 and rotatably or pivotably connects the first actuator 1010, particularly the first connecting rod 1012 to the first joint J1′. Such a first coupler A1 may be configured to revolve or turn about or around the first joint J1′ or a center thereof, as will be described later. Meanwhile, the first connecting rod 1012 may extend longitudinally into the first cylinder 1011, as shown, such that the second end 1012b may be disposed within the first cylinder 1011. Further, the first connecting rod 1012 may be configured to be movable relative to the first cylinder 1011 while being coupled to the first spring 1013. In particular, a linear motion or movement of the first connecting rod 1012 may cause the second end 1012b to move within the first cylinder 1011 and may deform the first spring 1013.

Further, the first actuator 1010 may include the first spring 1013 housed within the first cylinder 1011, as previously described. One end of the first spring 1013 may be coupled to a portion of the cylinder 1011, and the other end may be coupled to a second end 1012b of the first connecting rod 1012. Thus, the movement of the first connecting rod 1012 relative to the first cylinder 1011, i.e., the movement of the second end 1012b, may cause the first spring 1013 to deform and generate the force intended to move the second link 1002. Such a first spring 1013 may comprise, for example, a zero-free length spring to accurately generate the intended force. Such a first spring 1013 of zero-free length spring, may be configured to be deformable using a wire, in place of the first connecting rod 1012.

Moreover, the first actuator 1010 may include a first hinge shaft 1014 that is installed on the first link 1001 and engages with or is coupled to the first connecting rod 1012. More specifically, the first hinge shaft 1014 may extend from the first link 1001 and may be coupled at a predetermined location, e.g., a middle portion of the first connecting rod 1012. As previously described, the first connecting rod 1012 is configured to perform a linear reciprocating motion with respect to the first cylinder 1011 to deform the first spring 1012. At the same time, since the first connecting rod 1012 is constrained or bound to the first and second links 1001, 1002 by the first end 1012a and the first hinge shaft 1014, the first connecting rod 1012 may be required to relatively rotate or pivot for smooth rotations of the first and second links 1001, 1002. For this reason, the first hinge shaft 1014 may be configured to allow the rotational and linear motion of the first connecting rod 1012. For example, the first connecting rod 1012 may include a rail 1012c extending along its longitudinal direction, and the first hinge shaft 1014, or more precisely, an end thereof that engages with the first connecting rod 1012, may include a bracket guided by the rail 1012c to guide linear motion. Further, the end of the first hinge shaft 1014 that engages with the first connecting rod 1012 may include a bearing that enables rotational movement thereof within the rail 1012c. Thus, the first connecting rod 1012 may perform the linear motion and rotational motion with respect to the first hinge shaft 1014 and/or the first link 1001, and may perform its intended operation while not interfering with the movement of the first and second links 1001, 1002. Further, since the first hinge shaft 1014 is also coupled to the first link 1001, the first hinge shaft 1014 may be configured to be rotatable or pivotable with respect to the first link 1001 instead of being immovably fixed to the first link 1001 so as not to interfere with the rotational movement of the first link 1001 at least. In such a case, even though the first hinge shaft 1014 and the first connecting rod 1012 are configured to be non-rotatable with respect to each other, these members 1012, 1014 may be rotatable with respect to the first and second links 1001, 1002, and will be rotatable together with the first and second links 1001,1002. Thus, in view of this configuration of the first hinge shaft 1014, the first hinge shaft 1014 may substantially function as the second coupler B1 that rotatably or pivotably couples the first actuator 1010 to the first link 1001. That is, the second coupler B1 may comprise a hinge shaft of pin (i.e., the shaft 1014) that is provided at the first connecting rod 1012 and rotatably or pivotably connects the first actuator 1010, particularly the first connecting rod 1012 to the first link 1001. Further, as well shown in FIG. 22, the first cylinder 1011 may be coupled to the first hinge shaft 1014 coupled to the first link 1001, and thus the first cylinder 1011 and one end of the first spring 1013 coupled thereto may maintain a fixed position on the first link 1001 relative to the moving first connecting rod 1012. Thus, the deformation of the first spring 1013 is enabled by the second end 1012b of the moving first connecting rod 1012.

In such a first actuator 1010, when the first connecting rod 1012 is linearly moved relative to the first cylinder 1011 by a separate drive mechanism (e.g., the first pulley 1110 of the first adjustment module 1100, described later), such movement may be reliably guided by the first hinge shaft 1014, as previously described. Further, the movement of the first connecting rod 1012 may causes the second end 1012b of the first connecting rod 1012 to move within the cylinder 1011 along with the other end of the first spring 1013, and the deformation may occur in the first spring 1013 relative to the one end of the first spring 1013 fixed to the cylinder 1013. This deformation generates the mechanical force, which may be applied to the first coupler A1 via the first connecting rod 1012. The force applied to the first coupler A1 may then be transmitted to the first joint J1′ connected thereto. Further, by adjusting the amount of movement of the first connecting rod 1012, i.e., the second end 1012b, the amount of deformation of the first spring 1013 and the magnitude of the generated force may also be adjusted. Therefore, when the force of the first actuator 1010 is transmitted to the first joint J1′ in this manner, the second link 1002 may be moved by the transmitted force, and the direction of the transmitted force may determine the direction of movement of the second link 1002.

Additionally, the second actuator 1020 may include a configuration similar to the first actuator 1010 described above. Firstly, the second actuator 1020 may include a second cylinder 1021 provided on the second hinge 1002. The second cylinder 1021 may form an inner space of a predetermined size. The second cylinder 1021 may accommodate a second spring 1023 within the formed inner space, and may protect the second spring 1023 during operation of the second spring 1023, i.e., deformation and restoration.

Further, the second actuator 1020 may include a second connecting rod 1022 extending from the second cylinder 1021 to the second joint J2′. The second connecting rod 1022 may connect the second spring 1023 and the second cylinder 1021 receiving the second spring 1023 to the second joint J2′, and may thereby serve to transmit a force generated by the deformation of the second spring 1023 to the third coupler A2, i.e., the second joint J2′. In more detail, the second connecting rod 1022 may comprise a body elongated in the longitudinal direction and third and fourth ends 1022a, 1022b corresponding to two ends of the body. The third end 1022a of such a second connecting rod 1022 may be disposed adjacent to the second joint J2′ and may be rotatably or pivotably connected to the second joint J2′, for example by a hinge structure like a hinge shaft or pin. As will be described later, instead of being directly coupled to the second joint J2′, the third end 1022a may be pivotably or rotatably coupled to any other member provided at the second joint J2′ (e.g., the second pulley 1120 of the first adjustment module 1100) and thus substantially pivotably or rotatably coupled to the second joint J2′ as well. As a result of this configuration, the third end 1022a may substantially form the third coupler A2 rotatably or pivotably connected to the second joint J2′ as described above. That is, the third coupler A2 may comprise a hinge shaft of pin that is provided at the second connecting rod 1022 and rotatably or pivotably connects the second actuator 1020, particularly the second connecting rod 1022 to the second joint J2′. Such a third coupler A2 may be configured to revolve or turn about or around the second joint J2′ or a center thereof, as will be described later. Meanwhile, the second connecting rod 1022 may extend into the second cylinder 1021, as shown, such that the fourth end 1022b may be disposed within the second cylinder 1021. Further, the second connecting rod 1022 may be configured to be movable relative to the second cylinder 1021 while being coupled to the second spring 1023. In particular, linear motion of the second connecting rod 1022 may cause the fourth end 1022b to deform the second spring 1023 while the fourth end 1022b moves within the second cylinder 1021.

Further, the second actuator 1020 may include the second spring 1023 housed within the second cylinder 1021, as previously described. One end of the second spring 1023 may be coupled or fixed to a portion of the cylinder 1021, and the other end may be coupled to the fourth end 1022b of the second connecting rod 1022. Thus, the movement of the second connecting rod 1022 relative to the second cylinder 1021, i.e., the movement of the fourth end 1022b, may cause the second spring 1023 to deform and generate the force intended to move the second link 1002. Such a second spring 1023 may be made of, for example, a zero-free length spring to accurately generate the intended force. Such a second spring 1023 of zero-free length spring, may be configured to be deformable using a wire, in place of the second connecting rod 1022.

Moreover, the second actuator 1020 may include a second hinge shaft 1024 that is installed on the second link 1002 and is coupled to or engages with the second connecting rod 1022. More specifically, the second hinge shaft 1024 may extend from the second link 1002 and may be coupled at a predetermined location, e.g., at a middle portion of the second connecting rod 1022. As previously described, the second connecting rod 1022 is configured to perform a linear reciprocating motion with respect to the second cylinder 1021 to deform the second spring 1022. At the same time, since the second connecting rod 1022 is constrained or bound to the second link 1002 by the third end 1022a and the second hinge shaft 1024, the rod 1022 is also required to relatively rotate or pivot for smooth rotation of the second link 1002. For this reason, the second hinge shaft 1024 may be configured to allow rotational motion and linear motion of the second connecting rod 1022. For example, the second connecting rod 1022 may include a rail 1022c extending along its longitudinal direction, and the second hinge shaft 1024, precisely an end thereof that engages with the second connecting rod 1022, may include a bracket guided by the rail 1022c to guide the linear motion. Further, the end of the second hinge shaft 1024 that engages with the second connecting rod 1022 may include a bearing that enables the rotational movement thereof within the rail 1022c. Thus, the second connecting rod 1022 may perform the linear motion and rotational motion with respect to the second hinge shaft 1024 and/or the second link 1002, and may perform its intended operation while not interfering with the movement of the second link 1002. Further, since the second hinge shaft 1024 is also coupled to the second link 1002, the second hinge shaft 1024 may also be configured to be rotatable with respect to the second link 1002, instead of being immovably fixed to the second link 1002, in order not to interfere with the rotational motion of the second link 1002 at least. In such a case, even though the second hinge shaft 1024 and the second connecting rod 1022 are configured to be non-rotatable with respect to each other, these members 1022,1024 may be rotatable with respect to the second link 1002 and may move smoothly together with the first and second links 1001,1002. Accordingly, in view of this configuration of the second hinge shaft 1024, the second hinge shaft 1024 may function as the fourth coupler B2 that substantially rotatably or pivotably couples the second actuator 1020 to the second link 1002. That is, the fourth coupler B2 may comprise a hinge shaft of pin (i.e., the shaft 1024) that is provided at the second connecting rod 1022 and rotatably or pivotably connects the second actuator 1020, particularly the second connecting rod 1022 to the second link 1022. Further, as well shown in FIG. 22, the second cylinder 1021 may be coupled to the second hinge shaft 1024 coupled to the second link 1002, such that the second cylinder 1021 and one end of the second spring 1023 secured thereto may maintain a fixed position on the second link 1002 relative to the moving second connecting rod 1022. Thus, the deformation of the second spring 1023 is enabled by the fourth end 1022b of the moving second connecting rod 1022.

In such a second actuator 1020, when the second connecting rod 1022 is linearly moved relative to the second cylinder 1021 by a separate drive mechanism (e.g., the second pulley 1120 of the first adjustment module 1100, described later), such movement may be reliably guided by the second hinge shaft 1024, as previously described. Further, the movement of the second connecting rod 1022 causes the fourth end 1022b of the second connecting rod 1022 to move within the cylinder 1021 along with the other end of the second spring 1023, and the deformation may occur in the second spring 1023 relative to the one end of the second spring 1023 fixed to the cylinder 1021. This deformation generates the mechanical force, which may be applied to the third coupler A2 via the second connecting rod 1022. The force applied to the third coupler A2 may then be transmitted to the second joint J2′ connected thereto. Further, by adjusting the amount of movement of the second connecting rod 1022, i.e., the fourth end 1022b, the amount of deformation of the second spring 1023 and the magnitude of the generated force may also be adjusted. Therefore, when the force of the second actuator 1010 is transmitted to the second joint J2′ in this manner, the second link 1002 may be moved by the transmitted force, and the direction of the transmitted force may determine the direction of movement of the second link 1002.

In order for the lower limb assist robot of the present invention as described above, to be optimally designed to move the links 1001, 1002 using only the forces of the actuators 1010, 1020, a dynamics model thereof needs to be reviewed. Accordingly, the lower limb assist robot, namely the link assembly 1001,1002 and actuators 1010, 1020 thereof, is shown in FIGS. 23A and 23B as dynamics models.

Referring to FIGS. 23A and 23B, the link assembly 1001, 1002 and the actuators 1010, 1020 are shown simplified within a two-dimensional coordinate system comprising an x-axis and a y-axis. The y-axis is set along the direction of gravity, i.e., perpendicular to the ground (i.e., a vertical direction), and the x-axis is set along a direction perpendicular to the direction of gravity, i.e., parallel to the ground (i.e., horizontal direction). Therefore, the y-axis represents and corresponds to a vertical axis set on each of the joints J1′, J2′ as shown in FIGS. 24A-24C, and the x-axis represents and corresponds to a horizontal axis set on each of such joints J1′, J2′. In addition, the origin O represents each of the joints J1, J2 or the centers thereof. Therefore, the operation of models in FIGS. 24A-24C are described referring to the single y-axis or x-axis for simplicity, but are actually performed on the axes set of the joins J1, J2, respectively.

Within such a coordinate system, the first and second links of the link assembly 1001, 1002 are shown as bar members of a predetermined length, and a gravitational force g is acted on the link assembly 1001, 1002 by a mass m of the lower limb assist robot and the user. Further, the first and second actuators 1010, 1020 are shown in the form of first and second springs 1013, 1023 that substantially generate the mechanical forces. Moreover, as the second and fourth couplers B1, B2 of the first and second actuators 1010, 1020 are shown directly coupled to the first and second links 1001, 1002, these couplers B1, B2 are shown to be connected to the first and second links 1001, 1002. In contrast, the first and third couplers A1, A2 of the first and second actuators 1010, 1020 are connected to, but not directly coupled to the first and second links 1001, 1002 (i.e., the joints J1′, J2′), as previously described, and are therefore shown spaced apart from the first and second links 1001, 1002 (i.e., the origin O or the joints J1′, J2′). In FIGS. 23A and 23B, the links 1001, 1002, the actuators 1010, 1020 the couplers A1, A2, the couplers B1, B2 and the forces fs, fg, ft are shown as a corresponding single element for simplicity and better understanding.

In such a FIG. 23A, the first and third couplers A1, A2 (i.e., the first and second joints J1′, J2′) on which the forces fs of the actuators 1010, 1020 are applied may be disposed on the vertical axes (y-axes). Thus, the forces fs of the actuators 1010, 1020 act substantially along the vertical axes (y-axes) and in the direction opposite to the direction of gravity (i.e., in the vertical direction), and may cancel out the gravitational force g.

Alternatively, as shown in FIG. 23B, when the positions of the first and third couplers A1, A2 are changed, the directions of the forces fs applied to the first and third couplers A1, A2 (i.e., the first and second joints J1′, J2′) may be changed by such changes in position. Specifically, the positions of the couplers A1, A2 may be changed by moving the couplers A1, A2. To accomplish such movement and repositioning, the couplers A1, A2 may be offset or spaced apart by a predetermined distance from the vertical axes (y-axes). More specifically, the couplers A1, A2 may be revolve or turn around or about the origins O, i.e., the joints J1′, J2′ by a predetermined angle a. Such shifting and repositioning may cause the first and third couplers A1, A2 to be moved or shifted and be disposed in positions different from original positions, relative to the second and fourth couplers B1, B2. On the other hand, such shifting and repositioning may correspond to the relative shifting and repositioning of the first and third couplers A1, A2 with respect to the lower limb assist robot, more specifically with respect to the vertical axes (y-axes), each of which is the direction of gravity and is set at the first and second joints J1′, J2′.

As such, when the positions of the couplers A1, A2 are changed, the forces fs of the actuators 1010, 1020 may be oriented to have the angle a with respect to the vertical axes (y axes), as shown well in FIG. 23B, and a vertical component force fg and a horizontal component force fr may be generated from each of the forces fs due to such orientation. In FIG. 23B, only for the distinction and better understanding thereby, the forces fs, fg, fr generated by such orientation are shown from the origin O. Here, each vertical component force fg may cancel the gravitational force g exerted on the lower limb assist robot, while each horizontal component force fr may acts as an additional force on the lower limb assist robot. Further, the forces fs of the actuators 1010, 1020 may be set such that the vertical component forces fg generated thereby completely counteract or cancel the gravitational force g. In such a case, all of the generated horizontal component forces fr act as a kind of thrust, which may move the second link 1002, i.e., the lower limb assist robot, without any force being applied by the user. Therefore, by changing the directions of the forces by changing the position of the first and third couplers A1, A2, the forces from the actuators 1010,1020 may be utilized to generate the force in the intended direction while cancelling the applied gravity.

Moreover, when the first and third couplers A1, A2 are moved to different positions, for example, when the distances or the angles a with respect to the vertical axes (y axes) are changed, the magnitudes of the vertical and horizontal component forces fg, fr may also be changed. In particular, by changing the horizontal component forces fr, the magnitude of the force applied to the lower limb assist robot, i.e., the second link 1002, may also be adjusted to correspond to the magnitude of the force actually required. Accordingly, for such a change of the distance or the angle a with respect to the vertical axes (y-axes), the first and third couplers A1, A2 may be revolved or turned about or around a predetermined center or origin O, for example the first and second joints J1′,J2′, or the centers thereof, by different angles or distances. By such a revolution, the angles a and the corresponding horizontal component forces fr may be adjusted according to the required force, and the motion control of the lower limb assist robot may be carried out smoothly.

Such repositioning of the first and third couplers A1, A2 may be practically accomplished by various mechanisms. Among such mechanisms, as one example, the lower limb adjustment robot of the present invention may include the first adjustment module 1100 employing a pulley mechanism driven by a predetermined driving device. Such a first adjustment module 1100 may utilize a simple mechanical element, such as a pulley, to move, particularly revolve the first and second couplers A1, A2 for repositioning, thereby making the structure of the lower limb assist robot light and compact while performing its intended function. Such a first adjustment module 1100 will be described in detail below with reference back to FIGS. 21-24C.

Firstly, the first adjustment module 1100 may include a first pulley 1110 rotatably installed at the first joint J1′. The first pulley 1110 may be installed concentrically with the first joint J1′ for stable force transmission to the first joint J1′, such that the first pulley 1110 may share the hinge shaft or hinge pin with the first joint J1′ and may be rotatably installed on the hinge shaft of the first joint J1′. Further, the first pulley 1110 may be coupled to the first actuator 1010, more specifically, to the first end 1012a of the connecting rod 1012 thereof. That is, the first coupler A1 of the first actuator 1010 may be pivotably or rotatably hinge-coupled to the first pulley 1110. Thus, the first coupler A1 may form a rotatable engagement with the first joint J1′ coupled to the first pulley 1110 by being coupled to the first pulley 1110. Further, the force of the first actuator 1010 may be applied to the first joint J1′ via such a first coupler A1 and first pulley 1110. More specifically, the first coupler A1 (i.e., the first end 1012a) is pivotably or rotatably connected to an outer circumference or periphery of the first pulley 1110. That is, the first coupler A1 is spaced from the first joint J1′ and/or a center of the first pulley 1110 by an arm length or a radius r, such that the first coupler A1 may revolve or turn around the center or the joint J1′ when the first pulley 1110 rotates. In the first actuator 1010, the second end 1012b of the first connecting rod 1012 may be configured to constantly cause at least a predetermined strain or deformation in the first spring 1013, and thus a predetermined force may be constantly applied from the first actuator 1010 to the first coupler A1, i.e., to the first joint J1′. Further, when the first pulley 1110 rotates, the connecting rod 1012 may be in linear motion while revolving with the radius r, and as previously described with respect to the first actuator 1010, the amount of strain or deformation on the first spring 1013 and the magnitude of the generated force may be varied by the further movement of the second end 1012b. such amount of movement of the connecting rod 1012 (i.e., the second end 1012b) and the amount of deformation of the first spring 1013 may be appropriately designed and controlled according to the magnitude of the force required in the motion control of the lower limb assist robot.

Further, the first adjustment module 1100 may include a second pulley 1120 rotatably installed at the second joint J2′. The second pulley 1120 may be installed concentrically with the second joint J2′ for stable force transmission to the second joint J2′, such that the second pulley 1120 may share a hinge shaft or pin with the second joint J2′ and may be rotatably or pivotably installed on the hinge pin of the second joint J2′. Further, the second pulley 1120 may be coupled to the second actuator 1020, more specifically, to the third end 1022a of the connecting rod 1022 thereof. That is, the third coupler A2 of the second actuator 1020 may be pivotably or rotatably hinge-coupled to the second pulley 1120. Thus, the third coupler A2 may form a rotatable engagement with the second joint J2′ coupled to the second pulley 1120 by being coupled to the second pulley 1120. Further, the force of the second actuator 1020 may be applied to the second joint J2′ via such third coupler A2 and the second pulley 1120. More specifically, the third coupler A2 (i.e., the third end 1022a) is rotatably or pivotably connected to the outer periphery or circumference of the second pulley 1120. That is, the third coupler A2 may be spaced from the second joint J2′ and/or a center of the second pulley 1120 by the radius r, such that the third coupler A2 may revolve or turn around the center or the joint J2′ as the second pulley 1110 rotates. In the second actuator 1020, the fourth end 1022b may be configured to constantly cause at least a predetermined strain of deformation to the second spring 1023, such that a predetermined force may be constantly applied from the second actuator 1020 to the third coupler A2, i.e., to the second joint J2′. Further, as the second pulley 1120 rotates, the second connecting rod 1022 may be in linear motion while revolving with the arm length r, and as previously described with respect to the second actuator 1020, the amount of deformation of the second spring 1023 and the magnitude of the generated force may be varied by the further movement of the fourth end 1022b. The amount of movement of the second connecting rod 1022 (i.e., the fourth end 1022b) and the amount of strain or deformation on the second spring 1023 may be appropriately designed and controlled depending on the magnitude of force required in controlling the motion of the lower limb assist robot.

Further, the first adjustment module 1100 may include a first driver 1130 configured to rotate the first and second pulleys 1110, 1120. In one example, the first driver 1130 may include a power unit 1131 configured to provide power, such as a motor, and a drive pulley 1132 coupled to the power unit 1131 and configured to rotate. Further, the first driver 1130 may include an auxiliary pulley 1120a provided to the second pulley 1120 and a drive belt 1133 wound around the drive pulley 1132 and the auxiliary pulley 1120a. Alternatively, the auxiliary pulley 1120a may be provided on the first pulley 1110 instead of the second pulley 1120. When the drive pulley 1132 is rotated by the power unit 1131, the auxiliary pulley 1120a is rotated by the drive belt 1133, which may cause a rotation of the second pulley 1120 (or the first pulley 1110). Further, the first and second pulleys 1110, 1120 may be coupled to transmit the power to each other by a first synchronizer 1140, which will be described later. When either of the first and second pulleys 1110, 1120 is rotated by the first driver 1130, the other may also be rotated by the synchronizer 1140. Thus, the first driver 1130 may be configured to provide the power to the first and second pulleys 1110, 1120 and to rotate these pulleys 1120, 1230. Further, the first driver 1130 may be configured to revolve the first and third couplers A1, A3 about or around the first and second joints J1′, J2′ by rotating the first and second pulleys 1110, 1120. Such a first driver 1130 may comprise a gear train and a number of other drive mechanisms in addition to the pulley mechanism as described above.

Meanwhile, as described above, in order to move the lower limb assist robot, the first and second actuators 1010, 1020 may be configured to apply the forces to the second link 1002, i.e., the first and second joints J1′, J2′ thereof, corresponding to the upper leg and the joints thereof that primarily perform the movement of the lower limb. If the forces are applied to the first and second joints J1′, J2′ with a time difference, the second link 1002, and furthermore the lower limb assist robot, may move unstably due to an unbalance of the applied forces. Therefore, for stable movement of the lower limb assist robot, i.e., the movement of the second link 1002, the first and second actuators 1010, 1020 may need to apply the forces to the second link 1002 simultaneously. Further, for the same reason, when the directions of the forces applied by these actuators 1010,1020 are required to be changed, the directions of the forces also need to simultaneously change in the same direction for stable movement. As described above, the directions of the forces at the actuators 1010, 1020 are determined by the positions of the first and third couplers A1, A2, and such positions may be determined by the distance and the direction of travel of the couplers A1, A2. Accordingly, the first adjustment module 1100 may include the first synchronizer 1140 configured to simultaneously move the first and third couplers A1, A2 in the same direction and by the same distance. Various mechanisms may be employed for such a first synchronizer 1140, and as described above, since the first adjustment module 1100 uses the pulleys 1110, 1120, a belt may be used to synchronize the rotation of these pulleys 1110, 1120 as shown. Such a belt as the first synchronizer 1140 may couple or link the first and second pulleys 1110, 1120 to transmit power to each other, thereby enabling synchronized rotation of the pulleys 1110, 1120. Alternatively, a gear train T may be disposed between and engaging with the first and second pulleys 1110, 1120 in place of the belt, as shown by the dotted lines in FIG. 21, and other transmission mechanisms may be used as the first synchronizer 1140. When one of pulleys, for example, the second pulley 1120 as shown, is rotated by the driver 1130, such a first synchronizer 1140 simultaneously cause the other of pulleys, the first pulley 1110 to rotate as well. Further, such rotations of the first and second pulleys 1110, 1120 may be performed in the same direction and by the same angle. By the simultaneous rotations of same direction and same angle, the first and third couplers A1, A2 may be simultaneously disposed in the same position (i.e., the same relative position with regard to the vertical direction or axis), and the directions of the forces exerted by the actuators 1010, 1020 may be simultaneously changed in the same direction.

More specifically, in such a first adjustment module 1100, when the first driver 1130 simultaneously rotates the first and second pulleys 1110, 1120 in the same direction and by the same angle, the first and third couplers A1, A2 may be simultaneously revolved by the same angle about the center O, such as the first and second joints J1′, J2′. As a result of this rotation, the first and third couplers A1, A2 are simultaneously disposed at the same position, and the directions of the forces applied to the couplers A1, A2 (i.e., the joints J1′, J2′) by the actuators 1010, 1020 may also simultaneously change to the same direction. For example, if the forces are oriented to have the predetermined angle a with respect to the vertical axes by the changed directions, the vertical component forces fg for counteracting the gravity and the horizontal component forces fr available for movement of the robot may be generated, as shown in FIG. 23B. Further, when the angle a changes according to the rotations of the first and second pulleys 1110, 1120, the vertical and horizontal component forces fg, fr may also change appropriately. Accordingly, the first adjustment module 1100 may be configured to change the directions of the forces exerted on the first and third couplers A1, A2 (i.e., the first and second joints J1′, J2′) by the first and second actuators 1010, 1020, thereby converting the force of each of the actuators 1010, 1020 into the force that offsets the gravity exerted on the lower limb assist robot (i.e., the vertical component force fg) and the force that acts in the direction intended for the movement of the robot, i.e., the second link 1002 (i.e., the horizontal component force fr). In other words, the first adjustment module 1100 may control the actuators 1010, 1020 to provide the forces in both the anti-gravity direction and the intended direction.

In view of the configuration of the first adjustment module 1100 as described above, the first adjustment module 1100 is an independent driving system that is configured to drive the actuators 1010, 1020, particularly the couplers A1, A2 thereof, independently of the links 1001, 1002. Actually, the couplers A1, A2 are movably coupled only to the first adjustment module 1100 with not being constrained to the links 1001, 1002. Therefore, the first adjustment module 1100 is configured to adjust or change the directions of the forces provided by the actuators 1010, 1020, independent of the orientations of the links 1001, 1002. More specifically, for the adjustment or change of the directions, the first adjustment module 1100 is configured to change the position of the couplers A1, A2, independent of the positions of the links 1001, 1002, and for such repositioning, to move the couplers A1, A2, independent of the movements of the links 1001, 1002.

Further, by employing the first synchronizer 1140, the first adjustment module 1100 is configured to simultaneously move the couplers A1, A2 in the same direction by the same distance and thereby to dispose the couplers A1, A2 in the same position. For this reason, the first adjustment module 1100 is configured to simultaneously change the directions of the forces in the same direction by the same amount.

Consequently, in view of the all these functionalities, the first adjustment module 1100 is configured to simultaneously change the directions of the forces, independent of the links 1001, 1002. That is, the first adjustment module 1100 is configured to simultaneously adjust the directions of the forces in an active and independent manner to be responsive to the user's intention for movement.

Additionally, these actuators 1010, 1020 and the first adjustment module 1100 associated therewith may implement various modes of the lower limb assist robot configured to appropriately perform motions or movements in accordance with the user's intentions. These modes will be described in detail below with reference to FIGS. 24A-24C.

First, FIG. 24A illustrates a zero-gravity mode or a gravity compensation mode (i.e., a first mode) of the lower limb assist robot. In such a gravity-free mode, the first adjustment module 1100 may revolve the first and third couplers A1, A2 to be positioned on the vertical axes (y-axes) of the lower limb assist robot, i.e., the vertical axes passing through the first and second joints J1′, J2′, respectively. More specifically, the first adjustment module 1100 may position the couplers A1, A2 on portions of the vertical axes (y-axes) above the horizontal axes (x-axes) of the first and second joints J1′, J2′. By such positioning of the first and third couplers A1, A2, the directions of forces fs of the actuators 1010, 1020 may be oriented substantially along the vertical axes (y-axes) (i.e., vertically) and in a direction opposite to the direction of gravity, as previously described with reference to FIG. 23A. As described above, since the forces fs of the actuators 1010, 1020 as well as their vertical component forces fg may be set to be greater than the gravitational force g acting on the lower limb assist robot, the gravitational force g may be completely canceled out by this orientation, and the lower limb assist robot may be in a state in which no gravity is acting. Thus, the user may move the link assembly 1001, 1002 by applying only a small amount of his or her own force, and may stably move the lower limb while being supported by the link assembly.

Further, FIG. 24B illustrates a swing mode (i.e., a second mode) of the lower limb assist robot. In such a swing mode, the first adjustment module 1100 may be arranged to revolve the first and third couplers A1, A2 so as to have the predetermined angle a with respect to each of the vertical axes of the first and second joints J1′, J2′. For example, the first and third couplers A1, A2 may be disposed on the horizontal axes x of the first and second joints J1′, J2′ to have a phase angle a of 90 degrees with respect to each of the vertical axes y. By such positioning of the couplers A1, A2, the gravitational force g may be completely canceled by the vertical component force fg, as previously described with reference to FIG. 23B. Furthermore, the horizontal component force fr may be maximally generated and oriented in a direction of progression of the lower limb movement, i.e., in the forward direction as shown. Thus, the link assembly 1001,1002 may be moved by these horizontal component forces fr, and the user may walk with little or no use of his or her own strength by the movement of the assembly 1001,1002.

Moreover, FIG. 24C illustrates a standing mode (i.e., a third mode) of the lower limb assist robot. In such a standing mode, the first adjustment module 1100 may revolve the first and third couplers A1, A2 to be positioned on the vertical axes (y-axes) set on the first and second joints J1′, J2′. More specifically, the first adjustment module 1100 may position the couplers A1, A2 on portions of the vertical axes (y-axes) that are below the horizontal axes (x-axes) of the first and second joints J1′, J2′, as opposed to the gravity-free mode of FIG. 24A. By such positioning of the first and third couplers A1, A2, the directions of the forces of the actuators 1010, 1020 are oriented substantially along the vertical axes (y-axes) (i.e., vertically) in the same direction as the direction of gravity. Thus, the forces of these actuators 10, 20 may act as an additional force to support the user's lower limbs with respect to the ground. For this reason, the user may be able to maintain his upright posture with little use of his own strength.

Meanwhile, as described above, since the first adjustment module 1100 of FIGS. 21-24C repositions the couplers A1, A2 to change the acting directions of the forces on the first and third couplers A1, A2 (i.e., the joints J1′, J2′), the connecting rods 1012, 1022 of the first and second actuators 1010, 1020 may be movable by such repositioning. Further, when the couplers A1, A2 are disposed in different positions, the amounts of movements of the first and second connecting rods 1012, 1022 of the actuators 1010, 1020 may change according to these positions, and the amounts of strains or deformations of the first and second springs 1012, 1023 coupled thereto may also change. Therefore, depending on the positions of the couplers A1, A2, i.e., the modes of the lower limb assist robot, the magnitudes of the forces provided by the actuators 1010,1020 may vary slightly from one another. Further, in each mode of the lower limb assist robot, different forces may be required from the actuators 1010, 1020 for smoother movement of the lower limb assist robot, depending on operating conditions such as the intent and condition of the user and the environment. For these reasons, in order to compensate for the differences in the generated forces and to generate the forces as required, the lower limb assist robot of the present invention may be configured to adjust the magnitudes of the forces acting on the first and third couplers A1, A3, i.e., the first and second joints J1′, J2′. Particularly, for the same purposes, the lower limb assist robot may be configured to adjust or control the magnitudes of the forces generated by the actuators 1010, 1020. Such a modification will be described below with reference to the related drawings.

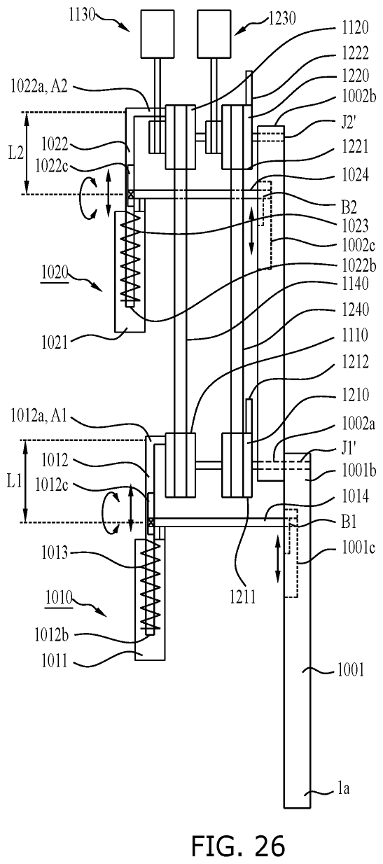

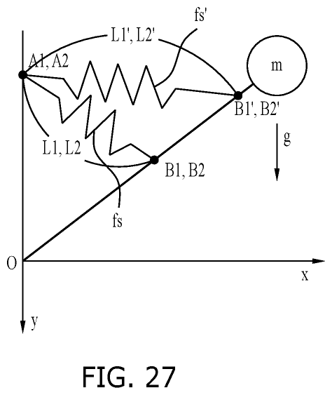

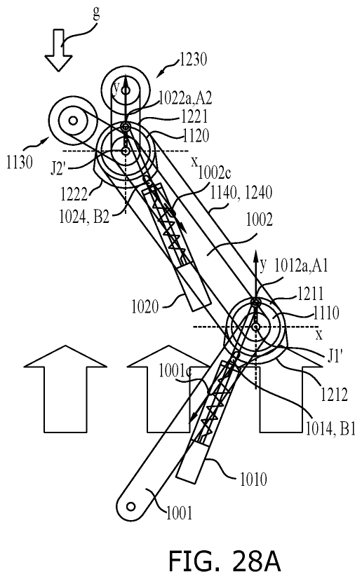

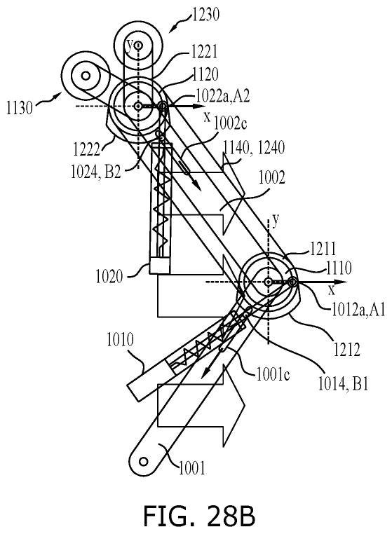

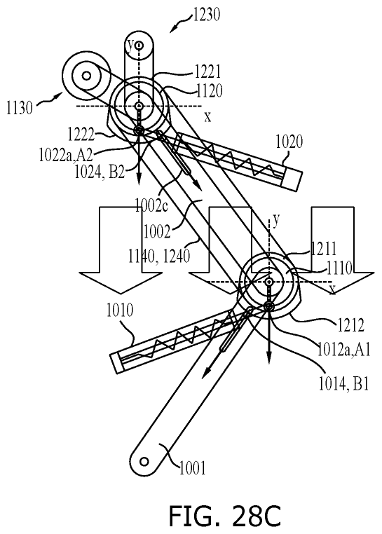

FIG. 25 is a side view illustrating a modification of the lower limb assist robot according to the present invention, and FIG. 26 is a front view illustrating the lower limb assist robot of FIG. 25. Further, FIG. 27 is conceptual views illustrating dynamics model of the lower limb assist robot of FIG. 25. Finally, FIGS. 28A-28C are side views illustrating operation modes of the lower limb assist robot of FIG. 25.

Referring to FIGS. 25 and 26, the modification of the lower limb assist robot of the present invention may essentially include a link assembly 1001, 1002, first and second actuators 1010, 1020, and a first adjustment module 1100. Because these devices 1001, 1002, 1010, 1020, 1100 may basically have the same configuration and perform the same operation as previously described with reference to FIGS. 21-24C, the same descriptions of FIGS. 21-24C apply to these devices 1001, 1002, 1010, 1020, 1100 in the modification and further descriptions are omitted herein. Instead, only configurations that differ from the examples of FIGS. 21-24C may be further described in the following.

Like the examples of FIGS. 21 to 24C, in order to be designed to adjust the magnitudes of the forces acting on the first and third couplers A1, A2, the dynamics model of the lower limb assist robot may first be considered, and such a dynamics model is shown in FIG. 27. Since the basic settings of the dynamical model of the lower limb assist robot have been previously described with reference to FIGS. 23A and 23B, the same descriptions with respect to FIGS. 23A and 23B apply and further descriptions are omitted.

Referring to FIG. 27, a first length or distance L1 is formed between the first and second couplers A1, B1 of the first actuator 1010, and a second length or distance L2 is formed between the third and fourth couplers A2, B2 of the second actuator 1020. These first and second lengths L1, L2 may determine the amounts of strains or deformations in the first and second springs 1013,1023, as shown and described with reference to FIG. 21, FIG. 22, FIG. 25, and FIG. 26, and in turn, may determine the magnitudes of the forces generated by the first and second actuators 1010, 1020. If the first and second lengths L1, L2 are changed to new first and second lengths L1′, L2′, the relative distances between the components of the first and second actuators 1010, 1020 (e.g., the connecting rods 1012, 1022 and the cylinders 1011, 1021) may be also changed by the changed lengths. Further, the amounts of strains or deformations in the first and second springs 1013, 1023 constrained or bound to these components may also change due to the changes in distance between these components, and the magnitudes of the forces fs of the actuators 1010, 1020 may also change to new magnitudes of force fs' based on the changed amounts of strains or deformations. Accordingly, when the first and second lengths L1, L2 change, the magnitudes of the forces applied to the first and third couplers A1, A2 (i.e., the first and second joints J1′, J2′) may change due to the changes in distance.

In one example, the first and second lengths L1, L2 may be changed by moving the second and fourth couplers B1, B2 to be disposed at new positions B1′, B2′, as shown in FIG. 27. More specifically, to accomplish such movement and repositioning, the second and fourth couplers B1, B2 may be moved along the body of the first and second links 1001, 1002 (i.e., along a longitudinal direction thereof). Such movement and repositioning may cause the second and fourth couplers B1, B2 to be moved or disposed at positions different from their original positions, relative to the first and third couplers A1, A2, which are disposed or stationary at a predetermined position. Alternatively, it may be described that the second and fourth couplers B1, B2 are moved and thus disposed in the shifted or changed positions, relative to the first and second joints J1′, J2′ or the vertical axes (y axes) set on these joints J1′, J2′ instead of the first and third couplers A1, A2. Further, while FIG. 27 illustrates the shifting of the second and fourth couplers B1, B2 to change the first and second lengths L1, L2, the first and third couplers A1, A2 may also be shifted relative to these second and fourth couplers B1, B2 to result in the same change in the first and second lengths L1, L2.

As such, when the amounts of strains or deformations on the springs 1013, 1023 are varied by the changes in lengths L1, L2, the magnitudes of the forces on the actuators 1010, 1020 may be varied. Further, by adjusting the lengths L1, L2 to different values, the actuators 1010, 1020 may provide different magnitudes of forces. For example, by adjusting the lengths L1, L2 in accordance with the operating conditions of the lower limb assist robot (e.g., real-time adjustment), the forces of the actuators 1010, 1020 may be increased or decreased in real time, and the operation of the lower limb assist robot may be performed more smoothly and reliably.

Such changes to the first and second lengths L1, L2 may be accomplished by a variety of mechanisms, and as one example, the lower limb assist robot of the present invention may include a second adjustment module 1200 employing a cam mechanism driven by a predetermined driving device. Such a second adjustment module 1200 may utilize a simple mechanical element, such as a cam, which may selectively engage with the first and second actuators 1010, 1020 as needed. Thus, the second adjustment module 1200 may move the second and fourth couplers B1, B2 to change the distances L1, L2, thereby making the structure of the lower limb assist robot light and compact while still performing its intended function. Such a second adjustment module 1200 will be described in detail below with reference back to FIGS. 25-28C.

Firstly, the second adjustment module 1200 may include a first cam 1210 rotatably installed on the first joint J1′. The first cam 1210 may be installed concentrically with the first joint J1′, like the first pulley 1110, such that the first cam 1210 shares a hinge shaft or hinge pin with the first joint J1′ and may be rotatably installed on the hinge shaft of the first joint J1′. The first cam 1210 may be disposed between the first pulley 1110 and the first joint J1′, as shown, or alternatively, may be disposed outside the first pulley 1110 in the axial direction of the hinge pin of the first joint J1′.

The first cam 1210 may comprise a disk member or body having a predetermined thickness, as shown, and such a body may include a first base 1211 having a predetermined radius and a first extension 1212 having a radius greater than the first base 1211. That is, the first cam 1210 may be configured to have the first extension 1212 provided at a predetermined location on the outer circumference or periphery of the body or the first base 1211. Such a first extension 1212 may extend by a predetermined length circumferentially along the first cam 1210, more precisely along the outer periphery of its body or the first base 1211, and may protrude radially from the body or the first base 1211. Accordingly, the first cam 1210, more precisely the first extension 1212, may optionally or selectively contact or engage with the second coupler B1, i.e., the first hinge shaft 1014, as will be described later, to serve to move the second coupler B1. Further, the first base 1211 may be spaced apart from the first hinge shaft 1014, as shown in FIG. 26. However, as shown in FIG. 25, the first base 1211 may be configured to be in contact with the first hinge shaft 1014, in which case both the first base 1211 and the first extension 1212, i.e., the entire first cam 1210, may be continuously in contact with the first hinge shaft 1014 to stably guide movement of the shaft 1014. Meanwhile, the first hinge shaft 1014 may also be configured to be moved by the first cam 1210. For example, the first link 1001 may include a groove 1001c extending along its body, and an end of the first hinge shaft 1014 may be inserted into such a groove 1001c. Further, the end of such a hinge shaft 1014 may include a bracket or flange that engages with an inner wall of the groove 1001c so as not to be separated from the groove 1001c. Thus, when an external force is applied to the hinge shaft 1014 by the cam 1210, the hinge shaft 1014 may stably move along the groove 1001c while being guided by the groove 1001c.

In addition, the second adjustment module 1200 may include a second cam 1220 rotatably installed on the second joint J2′. The second cam 1220 may be installed concentrically with the second joint J2′, like the second pulley 1120, such that the second cam 1220 shares a hinge shaft or hinge pin with the second joint J2′ and may be rotatably installed on the hinge shaft of the second joint J2′. The second cam 1220 may be disposed between the second pulley 1120 and the second joint J2′ as shown, or alternatively, may be disposed outside the second pulley 1120 in the axial direction of the second joint J2′.

The second cam 1220 may comprise a disk member or body having a predetermined thickness, as shown, and such a body may include a second base 1221 having a predetermined radius and a second extension 1222 having a radius greater than the second base 1221. That is, the second cam 1220 may be configured to have the second extension 1222 provided at a predetermined location on the outer circumference or periphery of the body or the second base 1221. Such second extension 1222 may extend a predetermined length circumferentially along the second cam 1210, more specifically along the outer periphery of its body or the second base 1221, and may extend radially from the body or the second base 1221. Accordingly, the second cam 1220, more precisely, the second extension 1222, may optionally or selectively contact or engage with the fourth coupler B2, i.e., the second hinge shaft 1024, as will be described later, to serve to move the fourth coupler B2. Further, the second extension 1222 may have the same radius as the first extension 1212 such that the first and second extension 1212, 1222 protrude from the first and second bases 1211, 1221 by the same amount and thus push or move the couplers B1, B2 by the same distance as will be described later. Additionally, the second base 1221 may be spaced apart from the second hinge shaft 1024, as shown in FIG. 26. However, as shown in FIG. 25, the second base 1221 may be configured to be in contact with the second hinge shaft 1024, in which case both the second base 1221 and the second extension 1222, i.e., the entire second cam 1220, may be continuously in contact with the second hinge shaft 1024 to stably guide movement of the shaft 1024. Meanwhile, the second hinge shaft 1024 may also be configured to be moved by the second cam 1210. For example, the second link 1002 may include a groove 1002c extending along its body, and the end of the second hinge shaft 1024 may be inserted into the groove 1002c. Furthermore, the end of such a hinge shaft 1024 may include a bracket or flange that engages an inner wall of the groove 1002c so as not to be separated from the groove 1002c. Thus, when an external force is applied to the hinge shaft 1024 by the second cam 1220, the hinge shaft 1024 may stably move along the groove 1002c while being guided by the groove 1002c.

Additionally, the second adjustment module 1200 may include a second driver 1230 configured to rotate the first and second cams 1210, 1220. Such second driver 1230 may be configured substantially the same as the first driver 1130 and components 1131, 1132, 1133 thereof previously described with reference to FIGS. 21-24C. Accordingly, the same descriptions of the first driver 1130 of FIGS. 21-24C apply, and further descriptions are omitted. Like the first adjustment module 1100, the second driver 1230 may also utilize a second synchronizer 1240, which will be described later, to rotate either of the first and second cams 1210, 1220 so that the other may also be rotated.

Meanwhile, as previously described with respect to the first synchronizer 1140 of the first adjustment module 1100, for stable movement of the lower limb assist robot, i.e., movement of the second link 1002, the changes in the magnitudes of the forces exerted by the first and second actuators 1010, 1020 need to be performed simultaneously by the same amount. Further, as described with reference to FIG. 27, the changes in the magnitudes of the force on the actuators 1010, 1020 are determined by the changes in the first and second distances L1, L2, which may be determined by the traveling or moving distances of the couplers B1, B2. Accordingly, the second adjustment module 1200 may include the second synchronizer 1240 configured to simultaneously move the second and fourth couplers B1, B2 by the same distance. As previously described, since the extensions 1212, 1222 perform the movement of the couplers B1, B2, the second synchronizer 1240 may be configured to cause the extensions 1212, 1222 to contact or engage with the couplers B1, B2 at least simultaneously. Various mechanisms may be employed for such a second synchronizer 1240, and similar to the first synchronizer 1140, a belt may be used to synchronize the rotations of the cams 1210, 1220 as shown. Such a belt as the second synchronizer 1240 may couple or link the first and second cams 1210, 1220 to transmit power to each other, thereby enabling synchronized rotations of the cams 1210, 1220. Alternatively, like the first synchronizer 1140, a gear train T may be disposed between and engaging with the first and second cams 1210, 1220 in lieu of the belt, and other transmission mechanisms may be used as the second synchronizer 1240. When one of cams, for example, the second cam 1220 is rotated by the second driver 1230 as shown, such a second synchronizer 1240 may be capable of simultaneously rotating the first cam 1210. Further, such rotations of the first and second cams 1210, 1220 may be performed in the same direction and at the same angle (i.e., by the same distance). By such simultaneous same direction and same angle (or same distance) rotation, the extensions 1212, 1222 of the cams 1210, 1220 may simultaneously engage with the second and fourth couplers B1, B2 and simultaneously move or push these couplers B1, B2 (i.e., the first and second hinge shafts 1014, 1024) by the same distance due to the same radius (i.e., the same amount of protrusion from the base 1211, 1221) thereof. Therefore, the same changes in the first and second distances L1, L2 may occur simultaneously, and accordingly, the forces exerted by the actuators 1010, 1020 may also change simultaneously by the same magnitude or amount.

More specifically, in such a second adjustment module 1200, when the second driver 1230 along with the second synchronizer 1240 simultaneously rotates the first and second cams 1210, 1220 in the same direction and at the same angle, the extensions 1212, 1222 may simultaneously engage with the first and second hinge shafts 1014, 1024 and exert the forces on the shafts 1014, 1024. Thus, the first and second hinge shafts 1014, 1024 may travel or move in the same distance along the grooves 1001c, 1002c, and the first and second distances L1, L2 may be varied. For example, in the case of the first actuator 1010, the first coupler A1 may form a portion of the connecting rod 1012 and the second coupler B1 may correspond to a portion of the hinge shaft 1014 and the cylinder 1011 coupled thereto, and thus the change in the first distance L1 between the first and second couplers A1, B1 may in practice result in the change in the relative positions of the connecting rod 1012 and the cylinder 1011 and a corresponding change in the distance therebetween. Thus, the first spring 1013 constrained to the rod and cylinder 1012, 1011 may be further deformed by this change in the distance between the rod and cylinder 1012, 1011 and may exert the force of changed magnitude through the rod 1012 to the first coupler A1, i.e., the first joint J1′. In the same process, the second spring 1023 of the second actuator 1020 may be further deformed by the distance change and may apply the force of the changed magnitude through the second connecting rod 1022 to the third coupler A2, i.e., the second joint J2′. Therefore, the second adjustment module 1200 may be configured to change the magnitudes of the forces applied to the first and third couplers A1, A2 (i.e., the first and second joints J1′, J2′) by the first and second actuators 1010, 1020, and the operation of the lower limb assist robot may be performed stably based on the changed magnitudes of the forces. That is, the second adjustment module 1200 may compensate for the forces generated to be slightly different by the actuators 1010, 1020 depending on the operating modes, and may further adjust the forces to match the forces required by the lower limb assist robot depending on the operating modes.

In view of the configuration of the second adjustment module 1200 as described above, the second adjustment module 1200 is an independent driving system that is configured to drive the actuators 1010, 1020, particularly the couplers B1, B2 thereof, independently of the links 1001, 1002. Therefore, the second adjustment module 1200 is configured to adjust or change the magnitudes of the forces provided by the actuators 1010, 1020, independent of the orientations of the links 1001, 1002. More specifically, for the adjustment or change of the magnitudes, the second adjustment module 1200 is configured to change the position of the couplers B1, B2, independent of the positions of the links 1001, 1002, and for such repositioning, to move the couplers B1, B2, independent of the movements of the links 1001, 1002.

Further, by employing the second synchronizer 1240, the second adjustment module 1200 is configured to simultaneously move the couplers B1, B2 in the same direction by the same distance and thereby to dispose the couplers B1, B2 in the same position. For this reason, the second adjustment module 1200 is configured to simultaneously change the magnitudes of the forces by the same amount.

Consequently, in view of the all these functionalities, the second adjustment module 1200 is configured to simultaneously change the magnitudes of the forces, independent of the links 1001, 1002. That is, the second adjustment module 1200 is configured to simultaneously adjust the magnitudes of the forces in an active and independent manner to be responsive to the user's intention for movement.

In addition, the second adjustment module 1200 may implement various modes of the lower limb assist robot in coordination with the first adjustment module 1100. These modes will be described in detail below with reference to FIGS. 28A-28C.

Firstly, FIG. 28A illustrates a zero-gravity mode or a gravity compensation mode of the lower limb assist robot. Since the operation of the first adjustment module 1100 in such a zero-gravity mode according to FIG. 28A is the same as previously described with reference to FIG. 24A, detailed descriptions thereof will be omitted hereinafter. In this zero-gravity mode, as shown, the second adjustment module 1200 may move the second and fourth couplers B1, B2 to change the first and second distances L1, L2. The actuators 1010, 1020 may generate additional forces due to the changed distances L1, L2 and the resulting additional deformation of the springs 1013, 1023. Since the directions of the forces of the actuators 1010, 1020 by the first adjustment module 1100 are preset to be in the directions opposite to gravity along the vertical axes y in the zero-gravity mode, the additional forces generated by the second adjustment module 1200 may likewise act in the directions opposite to gravity. For this reason, even when the additional load and thus the additional gravitational force g is acting on the lower limb assist robot, the additional forces generated on the actuators 1010, 1020 by the second adjustment module 1200 may still make the lower limb assist robot weightless or gravity-free as intended.

Further, FIG. 28B illustrates a swing mode of the lower limb assist robot. Since the operation of the first adjustment module 1100 in such a swing mode is the same as previously described with reference to FIG. 24B, detailed descriptions thereof will be omitted hereinafter. In this swing mode, as shown, the second adjustment module 1200 may move the second and fourth couplers B1, B2, thereby changing the first and second distances L1, L2. The actuators 1010,1020 may generate the additional forces due to the changed distances L1, L2 and the resulting additional deformations of the springs 1013, 1023. Since the directions of the forces of the actuators 1010, 1020, precisely the horizontal component forces, are oriented in advance by the first adjustment module 1100 in the direction of the progression of the lower limb movement, i.e., in the forward direction, the horizontal component forces fr of these additional forces may be likewise acted in the forward direction. For this reason, the user may utilize these additional forces to walk smoothly even when the operating conditions change.

Moreover, FIG. 28C illustrates a standing mode of the lower limb assist robot. Since the operation of the first adjustment module 1100 in such a standing mode is the same as previously described with reference to FIG. 24C, detailed descriptions thereof will be omitted hereinafter. Meanwhile, in this standing mode, as shown, the second adjustment module 1200 may move the second and fourth couplers B1, B2 to change the first and second distances L1, L2. The actuators 1010, 1020 may generate additional forces due to the changed distances L1, L2 and the resulting additional deformation of the springs 1013, 1023. Since the directions of the forces of the actuators 1010, 1020 are preset in the same direction as gravity along the vertical axes y in the standing mode, these additional forces may be likewise exerted in the same direction as gravity. Thus, the user may stably maintain his/her upright position despite changes in the operating conditions.

Meanwhile, the first and second adjustment modules 1100, 1200 utilize mechanical elements, namely pulleys 1110, 1120 and cams 1210, 1220, that rotate similarly to each other in order to adjust the directions and magnitudes of the forces of the actuators 1010, 1020. Accordingly, these first and second adjustment modules 1100, 1200 may be integrated into a single mechanism, whereby the adjustment of the directions and magnitudes of the forces may be performed by the single mechanism. For this reason, the lower limb assist robot of the present invention may be configured to include a single, integrated adjustment mechanism, and such a modification will be described below with reference to the accompanying drawings.

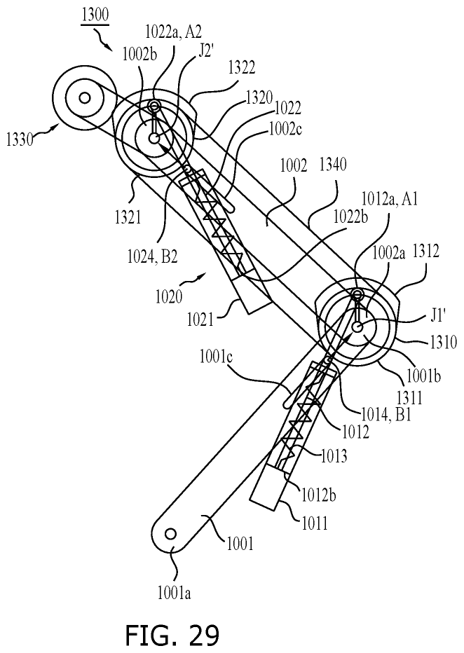

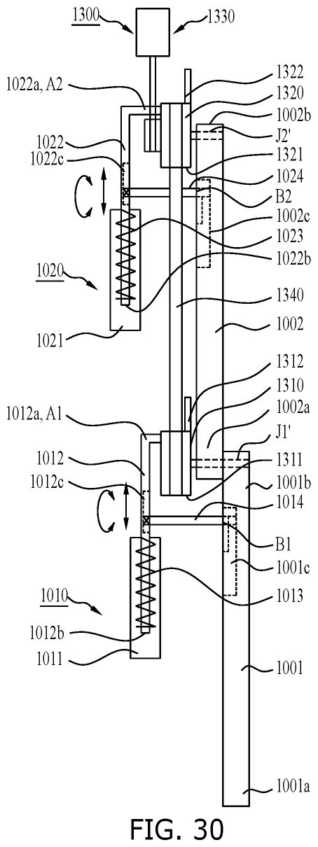

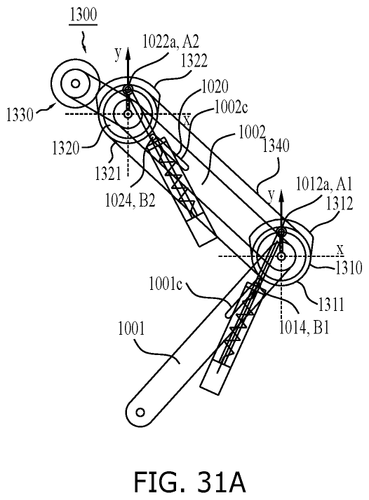

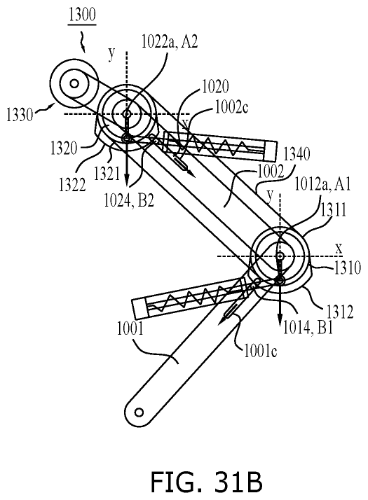

FIG. 29 is a side view illustrating a further modification of the lower limb assist robot according to the present invention, and FIG. 30 is a front view illustrating the lower limb assist robot of FIG. 29. Further, FIGS. 31A and 31B illustrate side views of operation modes of the lower limb assist robot of FIG. 29.

Referring to FIGS. 29 and 30, the modification of the lower limb assist robot of the present invention may essentially include a link assembly 1001, 1002, and first and second actuators 1010, 1020. Because these devices 1001, 1002, 1010, 1020 have the same configuration and perform the same operations as those previously described with reference to FIGS. 21-28C, the same descriptions of FIGS. 21-28C apply to these devices 1001, 1002, 1010, 1020, and further descriptions are omitted herein. Instead, only configurations that differ from the examples of FIGS. 21-28C may be further described in the following.

As discussed above, the first and second adjustment modules 1100, 1200 may be integrable with each other due to similarities in basic configurations and operating principles, and their integrated mechanism may be provided to the lower limb assist robot as a third adjustment module 1300, in place of the first and second adjustment modules 1100, 1200 described above. Such a third adjustment module 1300 may fulfill the functions of the first and second adjustment modules 1100, 1200 while making the structure of the lower limb assistive robot lighter and more compact. Such a third adjustment module 1300 will be described in detail below with reference to FIGS. 29 and 30.

Firstly, the third adjustment module 1300 may include a first rotor 1310 rotatably installed at the first joint J1′. The basic configuration and functionality of such a first rotor 1310 are identical to the first pulley 1110 previously described referring to FIGS. 21-24C, and therefore, those descriptions apply and further descriptions are omitted herein. Further, the first rotor 1310 comprises a disk member or a body having a predetermined thickness, and the body may include a first cylinder 1311 having a predetermined radius and a first protrusion 1312 having a radius greater than the first cylinder 1311. Since such first cylinder 1311 and first protrusion 1312 are substantially the same as the first base 1211 and first extension 1212 of the first cam 1210 described in FIGS. 25-28C, the descriptions of the first base 1211 and first extension 1212 applies, and further description are omitted herein. Meanwhile, as previously described, since the position of the first coupler A1 connected to the first rotor 1310 determines the direction of the force given by the first actuator 1010, the first protrusion 1312 for moving the second coupler B1 may be disposed on the first rotor 1310 to be adjacent to the first coupler A1 as shown, such that the magnitude of the force may be adjusted together with the direction of the force. More specifically, the first protrusion 1312 may be provided over a portion of the outer periphery or circumference of the body of the first rotor 1310 where the first coupler A1 is disposed, at least.

In addition, the third adjustment module 1300 may include a second rotor 1320 rotatably installed at the second joint J2′. The basic configuration and functionality of such second rotor 1320 are identical to the second pulley 1120 previously described in FIGS. 21-24C, and therefore, those descriptions apply and further description are omitted herein. Further, the second rotor 1320 may comprise a disk member or a body having a predetermined thickness, and the body may include a second cylinder 1321 having a predetermined radius and a second protrusion 1322 having a radius greater than the second cylinder 1321. Since such second cylinder 1321 and second protrusion 1322 are substantially the same as the second base 1221 and second extension 1222 of the second cam 1220 as described in FIGS. 25-28C, the descriptions of the second base 1221 and second extension 1222 apply, and further descriptions are omitted herein. Meanwhile, as previously described, since the position of the third coupler A2 connected to the second rotor 1320 determines the direction of the force given by the second actuator 1020, the second protrusion 1322 for moving the fourth coupler B2 may be disposed on the second rotor 1320 to be adjacent to the third coupler A2 as shown, such that the magnitude of the force may be adjusted together with the direction of the force. More specifically, the second protrusion 1322 may be provided over a portion of the outer periphery or circumference of the body of the second rotor 1320 where the third coupler A2 is disposed, at least.

Further, the third adjustment module 1300 may include a third driver 1330 configured to rotate the first and second rotors 1310, 1320. Such a third driver 1330 may be configured substantially the same as the first driver 1130 previously described with reference to FIGS. 21-24C and the second driver 1230 previously described with reference to FIGS. 25-28C. Accordingly, the same descriptions of these first and second drivers 1130, 1230 apply as such, and further descriptions are omitted herein.

Moreover, the third adjustment module 1300 may include a third synchronizer 1340 configured to simultaneously move the first and third couplers A1, A3, as well as the second and fourth couplers B1, B2. As such a third synchronizer 1340 has substantially the same configuration as the first and second synchronizers 1140, 1240 described above and is configured to perform a combination of their functions, the same descriptions of those synchronizers 1140, 1240 apply and further descriptions are omitted herein.

The third adjustment module 1300 may perform a combination of the functions of the first and third adjustment modules 1100, 1200 and implement various modes of the lower limb assist robot. These modes will be described in detail below with reference to FIGS. 31A and 31B.

Firstly, FIG. 31A illustrates a zero-gravity mode of the lower limb assist robot, and FIG. 31B illustrates a standing mode. In these zero-gravity mode and standing mode, the third adjustment module 1300 basically performs the same operations as the first adjustment module 1100 performs in FIG. 24A/FIG. 28A and FIG. 24C/FIG. 28C, and therefore, the descriptions associated with these figures apply, and further descriptions are omitted.

In the zero-gravity mode of FIG. 31A, the third adjustment module 1300 may dispose couplers A1, A2 on portions of the vertical axes (y-axes) above the horizontal axes (x-axes) of the first and second joints J1′, J2′ to exert the forces of the actuators 10, 20 opposite to the direction of gravity. As previously described, the first and second protrusions 1312, 1322 of the first and second rotors 1310, 1320 may be adjacent to these first and third couplers A1, A2, and therefore may be disposed above the horizontal axes (x-axes) likewise. Accordingly, these protrusions 1312, 1322 do not engage with the second and fourth couplers B1, B2, and no additional forces are generated from the actuators 1010,1020. As described above, the forces fs of the actuators 1010, 1020, or the vertical component forces fg thereof, may be designed to be at least greater than the gravitational force g acting on the lower limb assist robot, by default, such that even without the additional force from the actuators 1010, 1020, the gravitational force g is completely canceled out, and the user is still able to move the leg with only a small amount of strength while still being supported by the lower limb assist robot.

In contrast, in the standing mode of FIG. 31B, the third adjustment module 1300 may dispose couplers A1, A2 on portions of the vertical axes (y-axes) below the horizontal axes (x-axes) of the first and second joints J1′, J2′ to exert the forces of the actuators 1010, 1020 in the same direction as the direction of gravity. First and second protrusions 1312, 1322 of the first and second rotors 1310, 1320 may be adjacent to these first and third couplers A1, A2, and thus may be disposed below the horizontal axes (x-axes) likewise. Thus, these protrusions 1312, 1322 may engage with the second and fourth couplers B1, B2, and additional forces may be generated from the actuators 1010, 1020. Since the user of the lower limb assist robot typically does not have the strength to stand independently, generating additional forces in the standing mode instead of the zero-gravity mode may be more effective and advantageous in achieving the intended movement of the user (i.e., remaining standing).

The robot for assisting the limbs according to the present invention has the technical advantages as follows.

The limb assist robot according to the present invention utilizes an actuator that generates a mechanical force, such as an elastic force, instead of an electric-powered actuator that generates an electromotive force. This mechanical actuator may be directly interlocked with a link assembly, or exoskeleton, which supports upper and lower limbs of a user and may generate the appropriate force for movements of the limbs. Further, the limb assist robot of the present invention includes an adjustment module configured to mechanically control the force of the actuator, and a direction and a magnitude of the force may be appropriately changed according to operating modes of the limb assist robot using the adjustment module. Thus, the limb assist robot of the present invention may be configured to provide a required force without delay while coordinating with the movements of the user. For these reasons, the limb assist robot of the present invention may assist the upper limb and lower limb movements in response to the user's movements in real time in accordance with the user's intention. In other words, by a configuration of the present invention, unlike the conventional electric-powered actuator, a control may be minimized in assisting the user's movements, and in particular, a user intention recognition control such as an impedance control of the electric-powered actuator may not be required. As a result, the limb assist robot of the present invention may be used conveniently by the user without resistance and may have high reliability and stability.

Further, the limb assist robot of the present invention is equipped with the actuator that generates the mechanical force and the adjustment module that also mechanically controls such an actuator as described above. Therefore, compared to a conventional assist robot equipped with the expensive and heavy electric powered actuator and a complex control device for the electric-powered actuator, the limb assist robot of the present invention may have a simple and reliable structure. For this reason, the present invention may provide the user with an inexpensive and lightweight limb assist robot.

Although a number of examples have been described, it should be understood that other modifications and implementations can be devised by those skilled in the art that will fall within the spirit and scope of the principles of the present invention. More particularly, various variations and modifications in the structure or the configuration are possible within the scope of the disclosure, the drawings, and the appended claims. In addition to variations and modifications in the configuration, alternative uses will also be apparent to those skilled in the art.

What is claimed is:

1. An upper limb assist robot comprising:
a first link extending from a shoulder of an upper limb toward an elbow and including a first joint pivotably connected to a predetermined accessory;
a second link including a second joint pivotably connected to the first link, the second link being configured to support an upper arm of the upper limb along with the first link by extending from the first link to the elbow of the upper limb;
a first actuator including a first coupler connected to the first link, and configured to apply a predetermined magnitude of a force to the first joint via the first coupler;
a second actuator including a second coupler connected to the second link, and configured to apply a predetermined magnitude of a force to the second joint via the second coupler; and
an adjustment module including third and fourth couplers connected to the first and second actuators, respectively, the adjustment module being configured to change directions of the forces applied to the first and second joints by the first and second actuators to generate a force in an intended direction while canceling an applied gravitational force.

2. The upper limb assist robot of claim 1, wherein the adjustment module is configured to change positions of the third and fourth couplers in order to change the directions of the forces applied to the first and second joints by the first and second actuators.

3. The upper limb assist robot of claim 2, wherein the adjustment module is configured to offset or space the third and fourth couplers by a predetermined distance apart from a vertical axis extending in a direction of gravity through the first joint in order to change the positions of the third and fourth couplers, such that a component force acting opposed to the direction of gravity and a component force acting in the intended direction are generated from the forces of the first and second actuators applied to the first and second joints.

4. The upper limb assist robot of claim 3, wherein the adjustment module is configured to move the third and fourth couplers in a horizontal direction to offset the third and fourth couplers from the vertical axis.

5. The upper limb assist robot of claim 1, wherein the adjustment module is further configured to change the magnitudes of the forces applied to the first and second joints by the first and second actuators.

6. The upper limb assist robot of claim 5, wherein the adjustment module is configured to change a first distance between the first and third couplers and a second distance between the second and fourth couplers in order to change the magnitudes of the forces applied to the first and third joints.

7. The upper limb assist robot of claim 6, wherein the adjustment module is configured to move the third and fourth couplers in a vertical direction to change the first and second distances.

8. The upper limb assist robot of claim 1 wherein the adjustment module includes:
a housing configured to accommodate components of the first and second actuators;
a first driver provided to the housing and configured to move the housing in a horizontal direction; and
a second driver provided to the housing and configured to move the housing in a vertical direction.

9. An upper limb assist robot comprising:
a first link extending from a shoulder of an upper limb toward an elbow and including a first joint pivotably connected to a predetermined accessory;
a second link including a second joint pivotably connected to the first link, the second link being configured to support an upper arm of the upper limb along with the first link by extending from the first link to the elbow of the upper limb;
a first actuator including a first coupler pivotably connected to the first joint and a second coupler pivotably connected to a body of the first link, the first actuator being configured to apply a predetermined magnitude of a force to the first coupler;
a second actuator including a third coupler pivotably connected to the second joint and a fourth coupler pivotably connected to a body of the second link, the second actuator being configured to apply a predetermined magnitude of a force to the third coupler; and
a first adjustment module configured to be connected to the first and second actuators, the first adjustment module being configured to change directions of the forces applied to the first and third couplers by the first and second actuators to generate a force in an intended direction while canceling an applied gravitational force.

10. The upper limb assist robot of claim 9, wherein the first adjustment module is configured to change positions of the first and third couplers in order to change the directions of the forces applied by the first and second actuators.

11. The upper limb assist robot of claim 10, wherein the first adjustment module is configured to offset or space the first and third couplers apart from vertical axes passing through the first and second joints, respectively in order to change the positions of the first and third couplers, such that a component force acting opposed to the direction of gravity and a component force acting in the intended direction are generated from the forces of the first and second actuators.

12. The upper limb assist robot of claim 11, wherein the first adjustment module is configured to revolve the first and third couplers around the first and second joints, respectively to offset the first and third couplers from the vertical axes.

13. The upper limb assist robot of claim 9, wherein the first adjustment module includes:
a first pulley configured to be rotatably installed at the first joint and pivotably coupled to the first coupler of the first actuator;
a second pulley configured to be rotatably installed at the second joint, and pivotably coupled to the third coupler of the second actuator; and
a first driver configured to provide power to the first and second pulleys to revolve the first and third couplers by rotating the first and second pulleys.

14. The upper limb assist robot of claim 13, wherein the first adjustment module further includes a first synchronizer configured to move the first and third couplers simultaneously in the same direction and by the same distance.

15. A lower limb assist robot comprising:
a first link configured to support a lower leg of a lower limb;
a second link configured to support an upper leg of the lower limb, the second link including a first joint pivotably coupled to the first link and a second joint disposed opposite to the first joint;
a first actuator including a first coupler pivotably connected to the first joint and a second coupler pivotably connected to a body of the first link, the first actuator being configured to apply a predetermined magnitude of a force to the first coupler;
a second actuator including a third coupler pivotably connected to the second joint and a fourth coupler pivotably connected to a body of the second link, the second actuator being configured to apply a predetermined magnitude of a force to the third coupler; and
a first adjustment module configured to be connected to the first and second actuators, the first adjustment module being configured to change directions of the forces applied to the first and third couplers by the first and second actuators to generate a force in an intended direction while canceling an applied gravitational force.

16. The lower limb assist robot of claim 15, wherein the first adjustment module is configured to change positions of the first and third couplers in order to change the directions of the forces applied by the first and second actuators.

17. The lower limb assist robot of claim 16, wherein the first adjustment module is configured to revolve the first and third couplers around the first and second joints, respectively to generate a component force acting opposed to the direction of gravity and a component force acting in the intended direction from the forces of the first and second actuators.

18. The lower limb assist robot of claim 15, wherein the first adjustment module includes:
a first pulley configured to be rotatably installed at the first joint and pivotably coupled to the first coupler of the first actuator;
a second pulley configured to be rotatably installed at the second joint, and pivotably coupled to the third coupler of the second actuator; and
a first driver configured to provide power to the first and second pulleys to revolve the first and third couplers by rotating the first and second pulleys.

19. The lower limb assist robot of claim 18, wherein the first adjustment module further includes a first synchronizer configured to move the first and third couplers simultaneously in the same direction and by the same distance.

20. The lower limb assist robot of claim 15, further comprising a second adjustment module configured to selectively engage with the first and second actuators and change the magnitudes of the forces applied to the first and third couplers by the first and second actuators.
